(19) United States
(12) Patent Application Publication
(10) Pub. No.: US 2026/0084827 A1
(43) Pub. Date: Mar. 26, 2026

(54) AIRCRAFT WITH AN UNDUCTED FAN PROPULSOR

(71) Applicant: General Electric Company, Evendale, OH (US)

(72) Inventors: Sara Elizabeth Carle, Columbus, OH (US); Daniel L. Tweedt, West Chester, OH (US); Syed Arif Khalid, West Chester, OH (US); Andrew Breeze-Stringfellow, Montgomery, OH (US); William Bowden, Cleves, OH (US)

(21) Appl. No.: 19/404,921

(22) Filed: Dec. 1, 2025

Related U.S. Application Data
(63) Continuation-in-part of application No. PCT/US2024/040754, filed on Aug. 2, 2024.
Application No. PCT/US2024/040754 is a continuation-in-part of application No. 18/652,052, filed on May 1, 2024, now Pat. No. 12,384,522.
Application No. 18/652,052 is a continuation-in-part of application No. 18/230,609, filed on Aug. 4, 2023, now Pat. No. 12,365,471.

(51) Int. Cl. B64D 27/12; B64C 11/48; B64D 27/40; F02C 6/00

(52) U.S. Cl. CPC B64D 27/12; B64C 11/48; B64D 27/40; F02C 6/00; F05D 2220/36

(57) ABSTRACT

The present disclosure is generally related to aircraft having one or more unducted fan propulsors at locations within specific regions relative to an airfoil, such as a wing or horizontal stabilizer. More specifically, the specific regions are located where there is a relatively higher pressure air flow beneath the wings or above a horizontal stabilizer. That higher pressure air flow can be utilized to provide increased thrust from the unducted fan propulsor.

### CROSS-REFERENCE TO RELATED APPLICATION

This application is a continuation-in-part of International Appl. No. PCT/US2024/040754, filed Aug. 2, 2024, which claims priority to U.S. patent application Ser. No. 18/230,609, filed on Aug. 4, 2023, and Ser. No. 18/652,052, filed May 1, 2024, the latter of which is a continuation-in-part of the former, the disclosures of which are hereby incorporated by reference in their entireties.

### FIELD

The present disclosure relates generally to an aircraft with a fan propulsor.

### BACKGROUND

Winged aircraft have undermounted propulsors in the form of a turboprop engine. The addition of a propulsor to a wing can lead to installation penalties, including increased drag. As the size of the undermounted propulsor increases, installation penalties can also increase, such as increased weight.

### BRIEF DESCRIPTION OF THE DRAWINGS

A full and enabling disclosure of the aspects of the present description, including the best mode thereof, directed to one of ordinary skill in the art, is set forth in the specification, which refers to the appended figures, in which:

FIG. 1 comprises a top plan view of an aircraft as configured in accordance with various embodiments of these teachings, with undermounted, unducted fan propulsors mounted on forward wings of the aircraft;

FIG. 2 comprises a top plan view of an aircraft as configured in accordance with various embodiments of these teachings, with unducted fan propulsors mounted on top of horizontal stabilizers of the aircraft;

FIG. 3 comprises an elevational cross-sectional view of an exemplary unducted fan propulsor having a plurality of blades arranged in a forward array and a rearward array;

FIG. 4 comprises a schematic side elevation view showing the location of the unducted fan propulsor of FIG. 3 relative to an airfoil section;

FIG. 5A is a schematic side elevation view similar to FIG. 4 and showing the unducted fan propulsor pitched downward relative to the airfoil section;

FIG. 5B defines a pitch angle (D for the unducted fan propulsor relative to a chord line of the airfoil section in FIG. 4;

FIG. 6A comprises a top plan view of the propulsor of FIG. 4 and inboard and outboard locations of the wing relative to an unducted fan propulsor centerline, with the inboard and outboard locations in FIG. 6A used to determine a chord length (C) of the airfoil section in FIG. 4;

FIG. 6B comprises a schematic side elevation view of a first section and a second section of the aircraft wing, which sections are used to determine an effective quarter chord point (QC) of the airfoil section in FIG. 4;

FIG. 6C comprises a schematic top plan view of a portion of an aircraft having a pair of wings extending from the fuselage with the propulsor of FIG. 3 mounted relative to each of the wings;

FIG. 6D comprises a schematic front elevation view of the aircraft portion of FIG. 6C;

FIG. 6E comprises a schematic top plan view of a portion of an aircraft having a pair of wings extending from the fuselage with the propulsor of FIG. 3 mounted relative to each of the wings, similar to FIG. 6C but showing the propulsors toed inwardly toward the fuselage;

FIG. 7 comprises a schematic side elevation view similar to that of FIG. 4, but showing a first ellipse, a second ellipse, a third ellipse, and a fourth ellipse to illustrate various embodiments of mounting locations of one of the unducted fan propulsors relative to one of the wings;

FIG. 8 comprises a schematic side elevation view similar to that of FIG. 7, but showing a first ellipse, a second ellipse, a third ellipse, and a fourth ellipse to illustrate various embodiments of mounting locations of one of the unducted fan propulsors relative to one of the horizontal stabilizers;

FIG. 9 comprises a schematic side elevation view similar to that of FIG. 7, showing the first ellipse, the second ellipse, the third ellipse, and the fourth ellipse to illustrate various embodiments of mounting locations of one of the unducted fan propulsors relative to one of the wings;

FIG. 10 comprises a schematic side elevation view similar to that of FIG. 8, showing the first ellipse, the second ellipse, the third ellipse, and the fourth ellipse to illustrate various embodiments of mounting locations of one of the unducted fan propulsors relative to one of the horizontal stabilizers; and

FIG. 11 comprises a schematic representation showing exemplary locations of a point P of one of the unducted fan propulsors, as defined herein, within the first ellipse, the second ellipse, the third ellipse, and the fourth ellipse.

FIG. 12 is a schematic cross-sectional view of a three-stream engine in accordance with an exemplary embodiment of the present disclosure.

FIG. 13 is a close-up, schematic view of the exemplary three-stream engine of FIG. 12.

FIG. 14 is a close-up view of an area surrounding a leading edge of a core cowl of the exemplary three-stream engine of FIG. 13.

FIGS. 15A through 15H are tables depicting numerical values showing the relationships between various parameters in accordance with various example embodiments of the present disclosure.

FIGS. 16A through 16C are graphs depicting a range of thrust to power airflow ratios and core bypass ratios in accordance with various example embodiments of the present disclosure.

FIG. 17 is a schematic view of a turboprop engine in accordance with an exemplary aspect of the present disclosure.

FIG. 18 is a schematic view of an unducted gas turbine engine in accordance with another exemplary aspect of the present disclosure.

FIG. 19 is a schematic, cross-sectional view of a gas turbine engine with a booster.

FIG. 20 is a schematic, cross-sectional view of a gas turbine engine with a booster and a flow blocker.

FIG. 21 is a schematic, cross-sectional view of a gas turbine engine with a booster and another flow blocker.

FIG. 22 is a schematic, cross-sectional view of a gas turbine engine with a booster and another flow blocker.

FIGS. 23A through 23C are schematic, cross-sectional views of a gas turbine engine with a booster defining a fourth stream.

FIG. 24 is a schematic, cross-sectional view of a gas turbine engine with a booster including a stem separated from a strut.

FIG. 25 is a schematic, cross-sectional view of a gas turbine engine with a booster including a stem integrated with a strut.

FIG. 26 is a schematic, cross-sectional view of a gas turbine engine with a booster including a stem enclosed within a strut.

FIGS. 27A through 27C are schematic, cross-sectional views of a gas turbine engine with a booster including an outlet guide vane integrated with an inlet guide vane.

FIG. 28 is a schematic, cross-sectional view of a gas turbine engine with a booster including an outlet guide vane spaced from an inlet guide vane.

FIG. 29 is a schematic, cross-sectional view of a gas turbine engine with a booster including an outlet guide vane coaxially disposed with an inlet guide vane.

FIG. 30 is a schematic, cross-sectional view of a gas turbine engine with a booster supported by a strut.

FIG. 31 is a schematic, cross-sectional view of a gas turbine engine with a booster including an outlet guide vane.

FIG. 32 is a schematic, cross-sectional view of a gas turbine engine with a booster supported by a strut and defining a fourth stream.

FIG. 33 is a schematic, cross-sectional view of a gas turbine engine with a booster including an outlet guide vane and defining a fourth stream.

FIG. 34 is a schematic, cross-sectional view of a gas turbine engine with a booster.

FIGS. 35A, 35B, and 35C are schematic, cross-sectional views of gas turbine engines with a booster defining a fourth stream.

FIG. 36 is a simplified, schematic view is provided of a section of a gas turbine engine in accordance with an exemplary aspect of the present disclosure.

FIG. 37 is a table including numerical values corresponding to several of the plotted gas turbine engines in FIG. 38.

FIG. 38 is a plot of gas turbine engines in accordance with one or more exemplary embodiments of the present disclosure, showing the TPAR (Y-Axis) and the BBR (X-axis).

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required.

### DETAILED DESCRIPTION

Aspects and advantages of the present disclosure will be set forth in part in the following description or may be learned through practice of the present disclosure.

The word “or” when used herein shall be interpreted as having a disjunctive construction rather than a conjunctive construction unless otherwise specifically indicated.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The term “leading edge” refers to components and/or surfaces which are oriented predominately upstream relative to the fluid flow of the system, and the term “trailing edge” refers to components and/or surfaces which are oriented predominately downstream relative to the fluid flow of the system.

“Airfoil section” and “effective quarter chord point (QC)” are defined as follows.

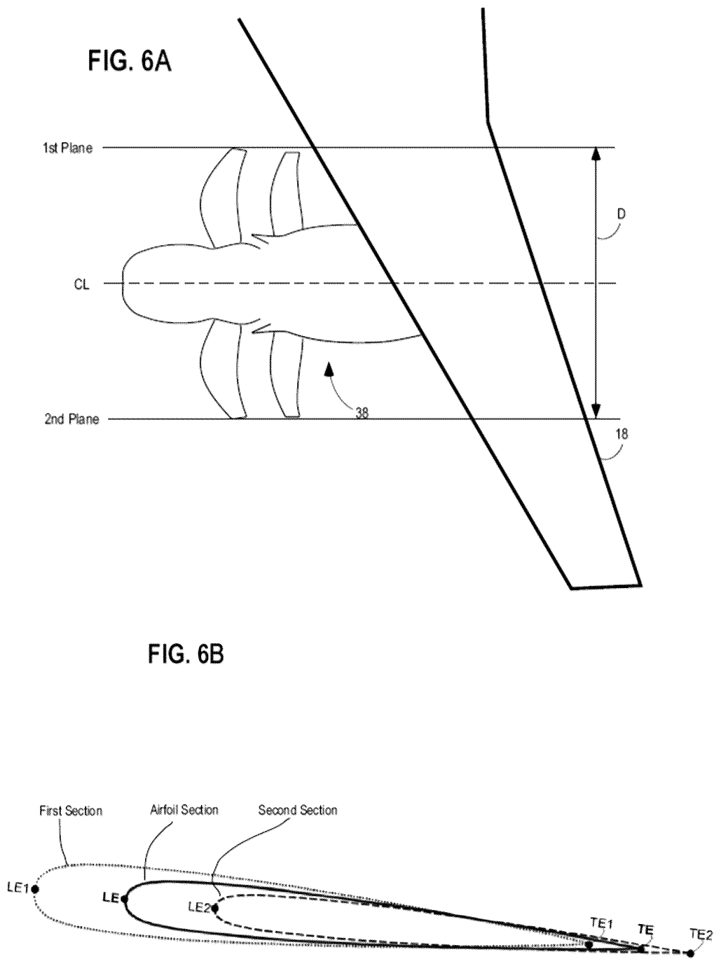

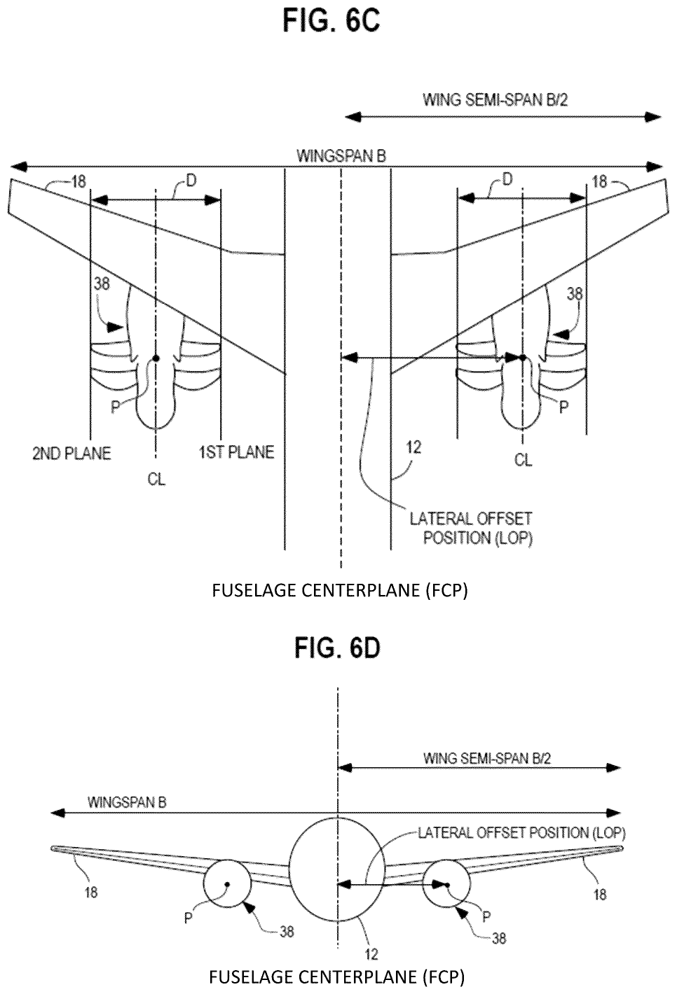

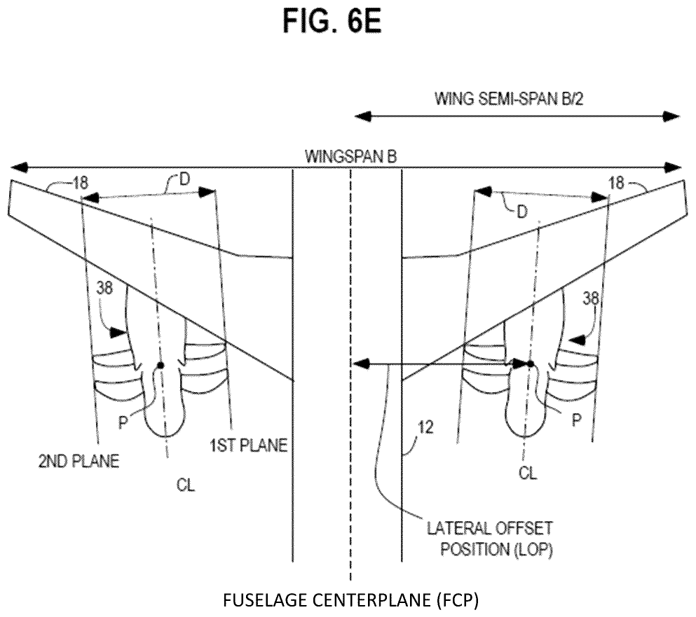

“Airfoil section” is defined as the average of a first offset plane section and a second offset plane section of an airfoil (e.g., an airfoil associated with a horizontal stabilizer or wing of an aircraft), where the first offset plane section is the section of the airfoil taken at a first plane and the second offset plane section is the section of the airfoil taken at a second plane, the first and second planes each being offset in a direction perpendicular to, and equidistant from a central plane by a distance of ½ of a fan diameter (D) of rotating blades of a propulsor mounted to the portion of the aircraft body associated with the airfoil section (wing or horizontal stabilizer). The first plane is inboard of the central plane (towards the fuselage) and the second plane is outboard of the central plane. When the aircraft is on the ground, both the gravity vector and axis of rotation of the rotating blades lie in the central plane. The intersection of the first offset plane with the airfoil defines a first section having a first section leading edge (LE1) and a first section trailing edge (TE1), with the LE1 at the forward-most point of the first section and the TE1 at the aft-most point of the first section. The intersection of the second offset plane with the airfoil defines a second section having a second section leading edge (LE2) and a second section trailing edge (TE2), with the LE2 at the forward-most point of the section and the TE2 at the aft-most point of the second section. Averaging the coordinates of LE1 and LE2 yields a representative LE location for the airfoil section. Averaging the coordinates of TE1 and TE2 yields a representative TE location for the airfoil section. The LE and TE points obtained this way are indicated in FIGS. 6 and 6B. An “Airfoil Section” defined herein has its leading and trailing edges TE, LE determined in this manner. “Effective Quarter-chord point” (“QC”) is defined as ¼ of the distance from the leading edge LE of the airfoil section determined in the foregoing manner, measured along the chord of this airfoil section. QC is dependent on the fan diameter (D) because the airfoil section LE and TE values change if D for the unducted fan propulsor changes.

“Cruise Speed” refers to aircraft speed and applies to a vehicle with a cruising altitude up to approximately 65,000 ft. In certain embodiments, cruise altitude is between approximately 28,000 ft. and approximately 45,000 ft. In still certain embodiments, cruise altitude is expressed in flight levels based on a standard air pressure at sea level, in which a cruise flight condition is between FL280 and FL650. In another embodiment, cruise flight condition is between FL280 and FL450. In still certain embodiments, cruise altitude is defined based at least on a barometric pressure, in which cruise altitude is between approximately 4.85 psia and approximately 0.82 psia based on a sea level pressure of approximately 14.70 psia and sea level temperature at approximately 59 degrees Fahrenheit. In another embodiment, cruise altitude is between approximately 4.85 psia and approximately 2.14 psia. It should be appreciated that in certain embodiments, the ranges of cruise altitude defined by pressure may be adjusted based on a different reference sea level pressure and/or sea level temperature.

It is understood that the plurality blades, whether forward or rearward, may have a variation of root forward-most points and root rearward-most points. This can be due to both installed position as well as orientation in the case of variable pitch blades. For purposes of defining the distances TRL, RTL, and VTL it is understood that a rotating blade or rotating array of blades are orientated such that the respective leading edges of the blades are in their most forward position, e.g., a feathered position. The respective trailing edge position is also obtained when the leading edge is in the most forward position. For purposes of defining the distances TRL, RTL, and VTL it is understood that the forward or leading edge or rearward or trailing edge of a stationary blade (or vane) or array of stationary blades (or vanes) is the most forward or leading edge position across the array of vanes or the most rearward or trailing edge position across the array of vanes.

“Blade” can refer to a stationary or rotating blade. “Stationary blade(s)” has the same meaning as “vane(s)”.

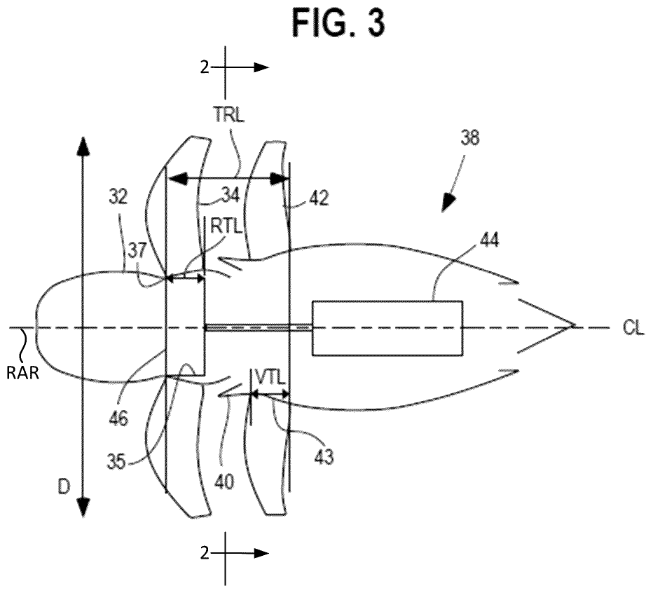

“Unducted fan propulsor” as used herein means an aircraft engine characterized by an array of rotating fan blades and static (or non-rotating), outlet guide vanes (OGV) aft of the array of rotating fan blades, or an array of rotating fan blades and static, unducted inlet guide vanes (IGV) forward of the rotating fan blades. In either case, neither the fan blades nor the IGV or OGV is surrounded by a duct or fan nacelle. FIG. 3 depicts an unducted fan propulsor. Additionally, the term unducted fan propulsor means an unducted, fan driven aircraft engine capable of providing thrust to an aircraft to enable cruise flight speeds between 0.7 Mach and 0.90 Mach, or 0.75 to 0.85 Mach.

“Aircraft” means a vehicle having a wing (and/or horizontal stabilizer), an airfoil defined by the wing (and/or horizontal stabilizer), and one or two unducted fan propulsors mounted to the wing, and the aircraft is operable at cruise flight speeds between 0.7 Mach and 0.90 Mach, or 0.75 to 0.85 Mach.

“Fuselage centerplane” (“FCP”) is defined as a plane that is located equidistant from the wingtips, intersecting the fuselage, and containing the gravity vector when the aircraft is on the ground.

Approximating language, as used herein throughout the specification and claims, is applied to modify any quantitative representation that could permissibly vary without resulting in a change in the basic function to which it is related. Accordingly, a value modified by a term or terms such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

As used herein, the term “proximate” refers to being closer to one side or end than an opposite side or end.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first”, “second”, and “third” may be used interchangeably to distinguish one component from another and are not intended to signify location or importance of the individual components.

The phrases “from X to Y” and “between X and Y” each refers to a range of values inclusive of the endpoints (i.e., refers to a range of values that includes both X and Y).

A “third stream” as used herein means a non-primary air stream capable of increasing fluid energy to produce a minority of total propulsion system thrust. A pressure ratio of the third stream may be higher than that of the primary propulsion stream (e.g., a bypass or propeller driven propulsion stream). The thrust may be produced through a dedicated nozzle or through mixing of an airflow through the third stream with a primary propulsion stream or a core air stream, e.g., into a common nozzle.

As used herein, the terms “integral”, “unitary”, or “monolithic” as used to describe a structure refers to the structure being formed integrally of a continuous material or group of materials with no seams, connections joints, or the like. The integral, unitary structures described herein may be formed through additive manufacturing to have the described structure, or alternatively through a casting process, etc.

The term “unitary” as used herein denotes that the final component has a construction in which the integrated portions are inseparable and is different from a component comprising a plurality of separate component pieces that have been joined together but remain distinct and the single component is not inseparable (i.e., the pieces may be re-separated). Thus, unitary components may comprise generally substantially continuous pieces of material or may comprise a plurality of portions that are permanently bonded to one another. In any event, the various portions forming a unitary component are integrated with one another such that the unitary component is a single piece with inseparable portions.

The inventors were faced with a problem of how to improve thrust delivered to an aircraft by an unducted fan propulsor without increasing the required engine power delivered to the unducted fan of the unducted fan propulsor.

It was surprisingly found that the solution to this problem is heavily dependent on the location of the unducted fan propulsor relative to the aircraft wing.

The inventors found that installing an unducted fan propulsor presents the challenge of addressing penalties that can result due to the interaction with the rest of the aircraft. The manner in which these penalties are addressed according to the claimed subject matter is unique for this type of engine.

An unducted fan propulsor is particularly challenged due to the scrubbing and interference drags relative to a ducted turbofan. That additional drag then results in a higher thrust needed from the propulsor. Generally, higher thrust for a ducted turbofan comes with a larger power requirement and thus more fuel flow. For the unducted fan propulsor it was surprisingly found by placing the engine so that it can take advantage of the high pressure flow induced by the wing (and/or a horizontal stabilizer), engine thrust may increase without increasing the power requirement on the engine. This placement of the engine relative to the wing then acts to offset the scrubbing and interference drag, thus not increasing the required fuel (or reducing the increased fuel flow required for a non-optimum engine placement). The inventors found that increased drag effects associated with an unducted fan propulsor, rather than addressed directly, may instead be offset by placing the engine at a more optimal location relative to the wing.

Additionally, the inventors found that the installed engine's improved position also positively influences the noise produced by the wing-engine interaction during flight at cruise conditions.

It was surprisingly found that by adapting a particular location on an unducted fan propulsor relative to an aircraft wing's effective quarter chord point (QC), the desired result of offsetting interference and scrubbing drag without increasing the power delivered to the fan could be achieved for an unducted fan propulsor.

It was also found that the improved position is dependent on the fan blade size of the unducted fan propulsor.

As explained below, after recognizing the novel flow characteristics associated with an unducted fan propulsor installed on an aircraft, taking into account the limitations on where to place this propulsor, the inventors were surprisingly able to establish criteria for positioning the propulsor relative to an aircraft wing to offset interference and scrubbing effects by defining a midpoint (P) location between external output guide vanes (OGV) or input guide vanes (IGV) and a forward or aft rotating array of fan blades, respectively, and additionally defining the distance from the effective quarter chord point (QC) to P. The position of P relative to QC and QC itself were found dependent on the rotating fan diameter. The correlation of these parameters to offset interference and scrubbing effects was not used before and was the surprising finding of the inventors for an unducted fan propulsor. Thus, mounting unducted fan propulsors relative to the effective quarter-chord point (QC) and fan blade size as described in embodiments provided herein offsets interference and scrubbing effects associated with an unducted fan propulsor and is an improvement over other mounting locations, including conventional mounting locations that are more forward of, and more in line with, a wing chord line.

Various aspects of the present disclosure describe aspects of an aircraft characterized in part by a specific relation between an effective quarter chord point (QC) of an airfoil section associated with a wing (or horizontal stabilizer) and the unducted fan propulsor, which is believed to result in improved aircraft performance and/or fuel efficiency. According to the disclosure, an aircraft includes a fuselage and an unducted fan propulsor installed relative to a section of the wing or the horizontal stabilizer.

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

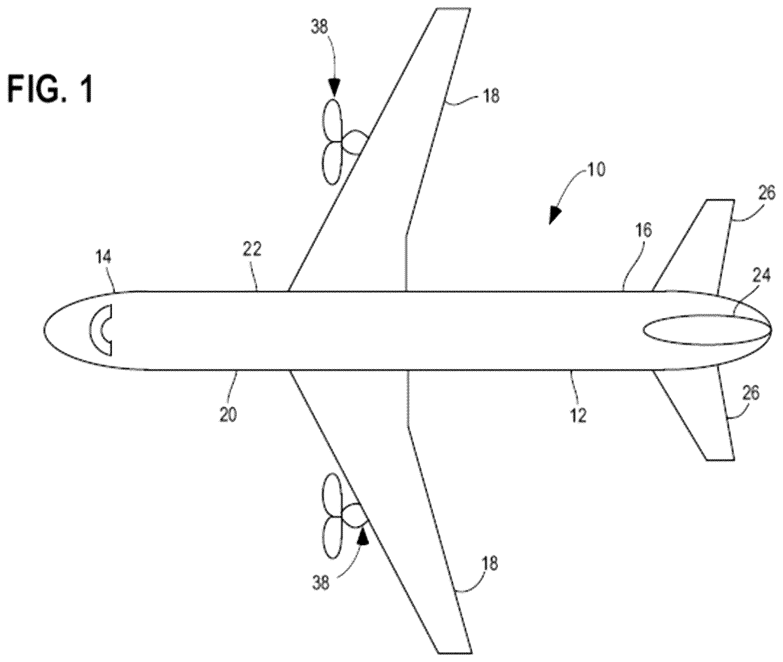

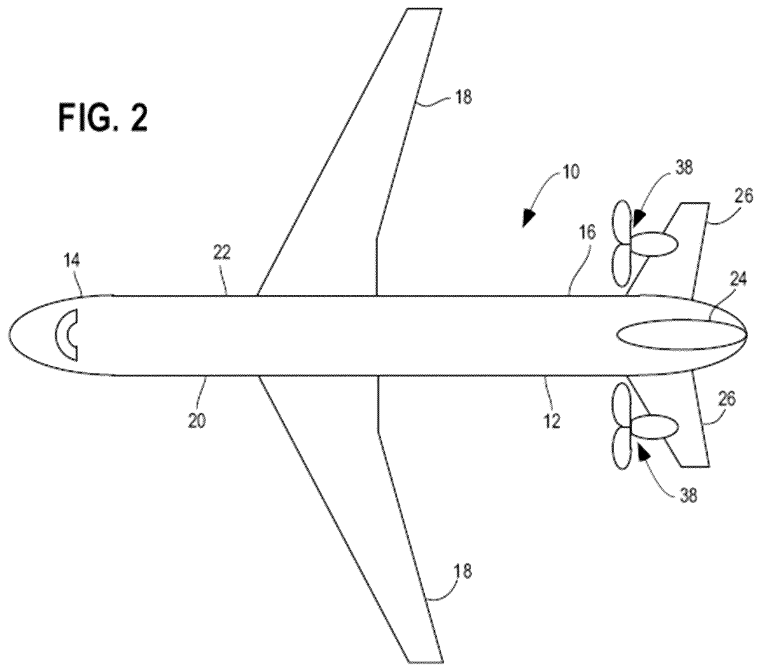

As shown in FIGS. 1 and 2, the aircraft 10 includes a fuselage 12 that extends longitudinally from a forward or nose section 14 and an aft or tail section 16 of the aircraft 10. The aircraft 10 further includes airfoils including a first wing 18 that extends laterally outwardly from a port side 20 and a second wing 18 that extends laterally outwardly from a starboard side 22 of the fuselage 12. The tail section 16 of the aircraft 10 includes a vertical stabilizer 24, a first airfoil of the horizontal stabilizer 26 that extends laterally outwardly from the port side 20, and a second airfoil of the horizontal stabilizer 26 that extends laterally outward from the starboard side 22 of the fuselage 12. An unducted fan propulsor 38 is undermounted relative to each of the wings 18, as shown in the embodiment of FIG. 1. Alternatively, the unducted fan propulsor 38 is mounted relative to the top of each of the horizontal stabilizers 26, as shown in FIG. 2. In some embodiments, more than one of the unducted fan propulsors 30 or 38 may be mounted to each of the wings 18 or each of the horizontal stabilizers 26.

FIG. 3 shows an elevational cross-sectional view of an embodiment of one of the unducted fan propulsors 38. As is seen from FIG. 3, the unducted fan propulsor 38 takes the form of an open fan propulsion system and has a rotating element in the form of rotatable propeller assembly 32 on which is mounted a first array of blades 34 around a centerline (CL) of the unducted fan propulsor 38. The first array of blades 34 defines a diameter D representing the tip-to-tip diameter of the blades and a maximum radial extent from CL. This diameter D is measured along a radial direction perpendicular to CL. The unducted fan propulsor 38 of FIG. 3 includes a second array of blades or vanes, which are non-rotating or static. In some embodiments, a non-rotating stationary element in the form of vane assembly 40 includes an array of vanes 42 disposed around CL.

Each of the blades 34 has a root 35 where the blade 34 is attached to the rotatable propeller assembly 32, and each blade 34 defines a root length (RTL). The root length (RTL) is defined as the axial extent (in a direction parallel to CL) from the radially innermost leading edge (LE) of the blade 34 airfoil, e.g., closest to CL, to the axial location of the radially innermost trailing edge (TE) of the blade 34 airfoil.

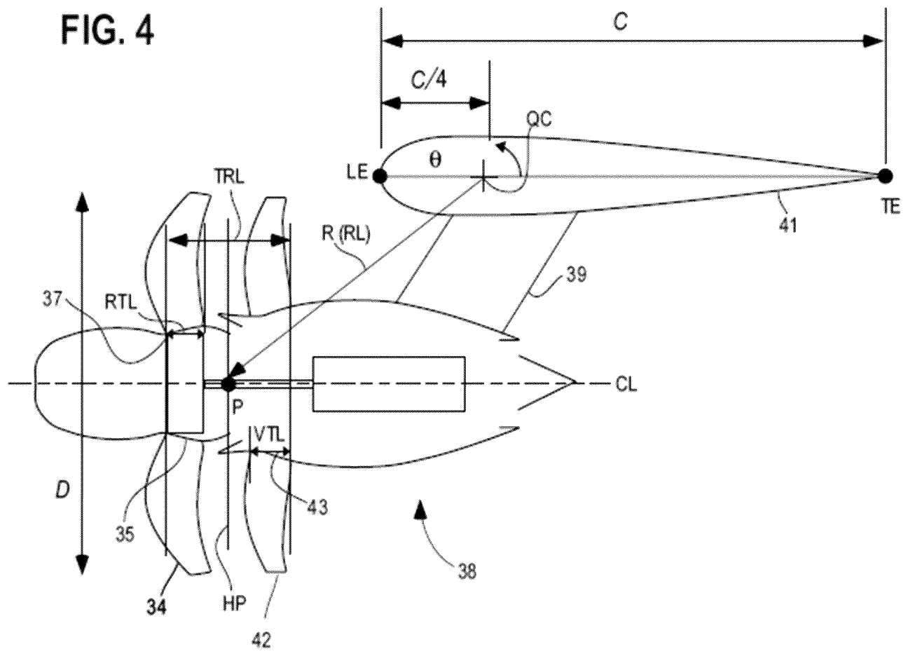

Each of the vanes 42 also has a root 43 with a vane root distance VTL where the vane 42 is attached to the non-rotating vane assembly 40. The total root length (TRL) is the distance between the leading edge (LE) of the blade 34 airfoil (radially nearest to CL) of the blades 34 and the trailing edge (LE) of the root 43 of the vanes 42, as shown in FIGS. 3 and 4. TRL is a measured axial distance from the radial innermost LE of the foremost row of blades/vanes and the trailing edge (TE) of the vanes 42. In some embodiments, the second array may instead be a second rotating elements and the TRL is the measured axial distance from the radially innermost LE of the blades 34 of the first rotating element and the TE of the root of the blades of the second rotating elements. In some embodiments, the vanes 42 may be forward of the rotating blades, and the TRL is the distance between the LE edge of the root of the vanes and the TE of the root of the rotating blades. In some embodiments, an unducted fan propulsor having rotating elements (e.g., rotating blades) and stationary elements (e.g. vanes) may be mounted according to the relationship described in the present disclosure. In unducted fan propulsors having multiple rows of blade and/or vanes, the TRL of an unducted fan propulsor is defined as the distance between the LE of the root of the foremost row of blades/vanes and the rearward edge of the root of the aftmost row of blades/vanes of the unducted fan propulsor.

Referring to FIG. 4, for purposes explained more later, the unducted fan propulsor 38 has a point P. For the unducted fan propulsor 38 with a first array of blades or vanes 34 and a second array of blades or vanes 42, as shown in FIGS. 3 and 4, the point P is located at the intersection of CL and a line HP perpendicular to CL and that passes through an axial midpoint of the total root length TRL between a forward end at the root of one of the blades 34 of the forward array and a rearward end at the root of one of the blades 42 of the rearward array when aligned with the one of the blades 34 of the forward array, as shown in FIG. 6. Either the forward or rearward array can be vanes or blades. In other words, the line HP is located equidistant from a forward end of the root of one of the forward vanes or blades 34 and a rearward end of the root of one of the rearward blades or vanes 42. The TRL of an unducted fan propulsor is defined as the distance between the LE of the root of the forward row of blades/vanes and the rearward edge of the root of the aftmost blade/vane.

Referring again to FIG. 3, the exemplary unducted fan propulsor 38 includes a drive mechanism 44 that provides torque and power to the propeller assembly 32 through a transmission 46. The drive mechanism 44 may be a gas turbine engine and associated transmission 46. Transmission 46 delivers torque from the drive mechanism 44 to the propeller assembly 32. The transmission system can be configured as a direct drive engine, transferring power from a power turbine or low pressure turbine (LPT) to the propeller assembly, or an indirect drive system where torque from the LPT is transferred to the propeller assembly 32 through a gearbox. The gearbox reduces a rotation speed of the drive shaft to match a desired rotational speed for the propeller assembly 32. The gas turbine engine includes in serial order a compressor, combustor, high pressure turbine and the LPT. In other embodiments the drive mechanism may generate power partially or fully by an electric motor. In the former case the drive mechanism is a hybrid electric drive mechanism including a gas turbine engine where a drive shaft includes an electric motor-generator for generating torque. In the latter case the drive mechanism is an electric motor.

The unducted fan propulsor 38 is attached relative to the wings 18 or horizontal stabilizer 26 through one or more intermediate components or features, e.g., a pylon 39, as shown in FIG. 4.

Each of the wings 18 shown in FIG. 1, and horizontal stabilizers 26 shown in FIG. 2, has an airfoil section 41 associated with it, where the airfoil section 41 is defined above.

As depicted in FIG. 4, a chord line C of the airfoil section, length C as shown, is a straight line extending from LE to TE of the airfoil section (it will be understood that the airfoil section as shown and defined herein is not meant to indicate any particular camber associated with an aircraft wing). The effective quarter-chord point (QC) of the airfoil section is located on the chord line. QC is located at a distance of C/4 from the LE of the airfoil section 41.

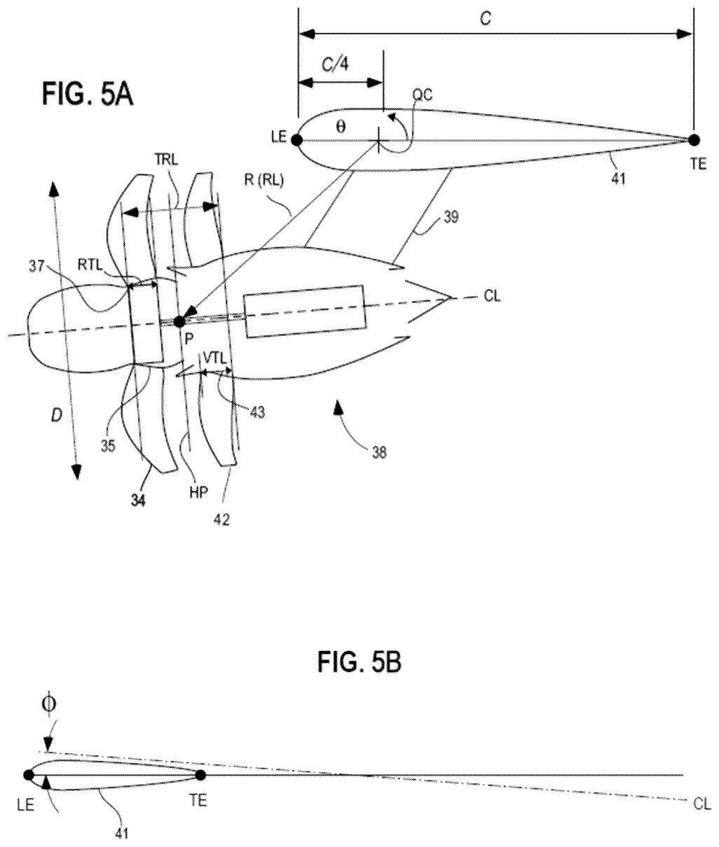

As shown in FIG. 4, the CL of the propulsor 38 and the chord line C are parallel to each other, corresponding to a zero pitch of the propulsor relative to the chord line C. The propulsor 38 can be pitched at different angles relative to the chord line, such as pitched downward as shown in FIG. 5A. FIG. 5B defines a pitch angle Φ for the propulsor 38, which is the angle spanned between the propulsor centerline CL and chord line C. Positive pitch corresponds to a clockwise rotation of CL relative to C. The pitch angle Φ can be fixed or variable during flight. For underwing installations, the pitch angle Φ can vary between −5 and +2 degrees, or it can vary between −3 and 0 degrees. During cruise conditions, propulsor pitch and toe angle (FIG. 6E, defined below) provide for an improved installed aerodynamic performance for the unducted fan propulsor in terms of reduced cabin noise and reduced off-axis loading of the unducted fan propulsor's drive shaft. For aft horizontal stabilizer or aft fuselage installations, the angle (can vary between −2 and +5 degrees to more align with downwash created by the wing.

The position of the open fan propulsor 38 is defined relative to QC. The airfoil section, as defined above, is the average of a first offset plane section and a second offset plane section of the airfoil (of the wing), where the first offset plane section is the section of the airfoil taken at a first plane and the second offset plane section is the section of the airfoil taken at a second plane, the first and second planes being offset in a direction perpendicular to, and equidistant from a central plane by a distance of ½ the maximum fan diameter (D) for the rotating blades, as shown in FIG. 6A. Both the gravity vector and axis of rotation of the rotating blades of the propulsor lie in this central plane when the aircraft is on the ground.

Referring to FIG. 6C, the propulsor 38—specifically, point P of the propulsor 38—has a spanwise location laterally offset from the fuselage centerplane (FCP) relative to the aircraft's wingspan B. P has a laterally offset position (LOP) between 10% and 80%, 20% and 40%, or between 25% and 35% of B/2 measured from the fuselage centerplane (FCP), as defined above. The location of P is also chosen to avoid interference with the fuselage or an adjacent propulsor if more than one propulsor is mounted relative to the wing. For an aft fuselage installation, the LOP of the propulsor will be closer to the fuselage, but far enough away from the fuselage's boundary layer to reduce or avoid undue interaction with the fuselage boundary layer.

As shown in FIG. 6C, the propulsor centerline CL and the fuselage centerplane (FCP) can be orientated parallel to each other. Referring to FIG. 6D, other angles between propulsor centerline CL and the fuselage centerplane (FCP) are contemplated. For an underwing mounted propulsor, the toe angle can provide added benefit when positive (i.e., the rotor toed-in towards the fuselage with the forward end of the propulsor 38 being more inboard than the aft end). The propulsor can have an inward toe angle of between 0 and 5 degrees, or between 1 and 3 degrees.

There are specific locations that the inventors have found to be advantageous to position the unducted fan propulsor 38 to generate increased thrust using higher pressure air flow, in order to offset the scrubbing and interference drag. The higher pressure air flow can be beneath the wings 18. In the case of a horizontal stabilizer 26, the higher pressure air flow is above the horizontal stabilizer 26. Accordingly, the high-pressure side of an airfoil may refer to the underside of a wing 18 or the top side of a horizontal stabilizer 26.

The aircraft described herein has a fuselage, wings and/or stabilizers, and two or more unducted fan propulsor systems (or propulsors). The unducted fan propulsor system, which is mounted on the pressure side of a wing or horizontal stabilizer, provides thrust to the aircraft. To improve upon what the propulsor system can deliver, there often is a need to make compromises to other parts of aircraft design (trade-offs). Stated another way, the benefits of an unducted fan propulsor cannot be viewed without consideration of the effect of placement of the propulsor on the aircraft. For example, placement can affect loads on and size of the pylon, wing loads, landing gear length and associated forces, weight, and cost.

The teachings described below enable improved balancing of the tradeoffs required in the aircraft design while positioning the unducted fan propulsor relative to the airfoil section's effective quarter chord point QC to offset scrubbing and interference drag loses.

Referring to FIG. 4, the location of an unducted fan propulsor relative to an airfoil section 41 is defined herein using a polar coordinate system having an angular (θ) coordinate and a radial (R) component, with origin located at the effective quarter chord point (QC) of the airfoil section having a chord length (C) as shown. The radial component is referred to herein as a “positioning line (R)”. The location of the point P of the unducted fan propulsor 38 relative to the origin (QC) of the polar coordinate system (the origin of the coordinate system is the same as the effective quarter chord point for airfoil section 41) is expressed in terms of a vector having radial component R with magnitude RL and angular component θ. The vector magnitude RL is called a “positioning line length (RL)”.

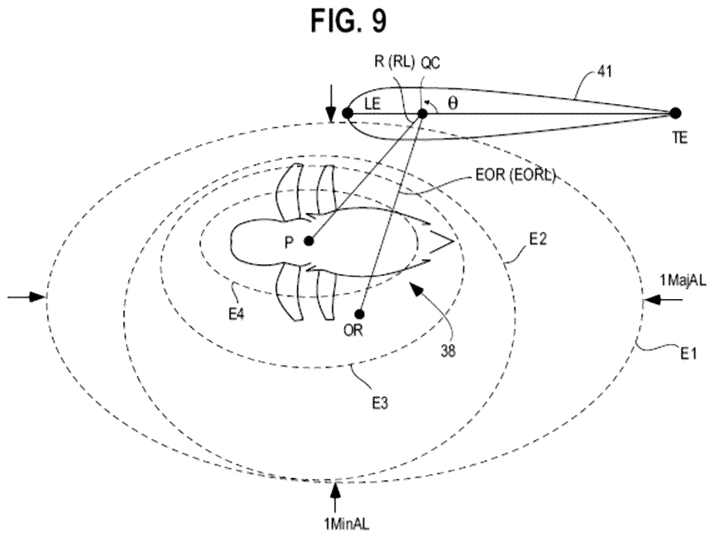

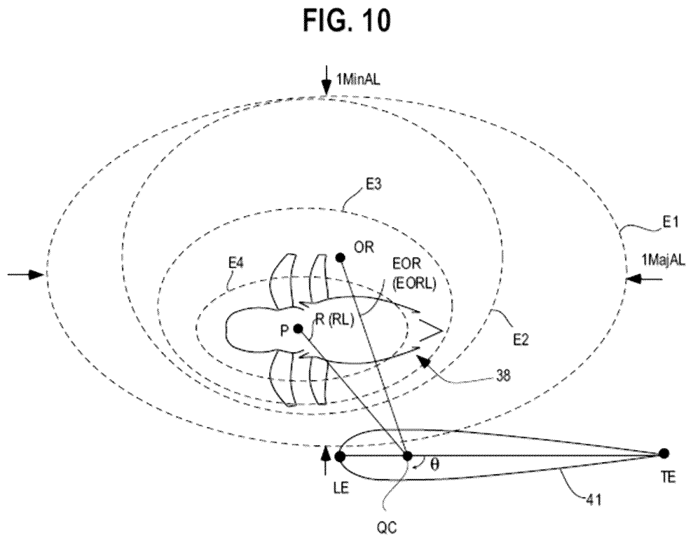

The angle θ is measured relative to a datum that is the airfoil section chord line (e.g., in FIG. 6 the vector R is located by an angle that is between 180 and 270 degrees measured counterclockwise about origin QC relative to the chord line). When viewed looking from an outboard position towards an inboard position (e.g., the fuselage), θ is positive in a counter-clockwise direction when the propulsor is below the airfoil section 41 (wing, FIG. 9), and θ is positive in a clockwise direction when the propulsor is above the airfoil section (horizontal stabilizer, FIG. 10) as indicated in the drawings, respectively, by the direction of the arrow from the origin.

The inventors found that for an unducted fan propulsor system the ratio of RL over D (i.e., RL/D) is desirably less than or equal to 2, less than or equal to 2 and greater than or equal to 0.15, or less than or equal to 2 and greater than or equal to 0.35. Additionally, for the undermounted unducted fan propulsor systems (pressure side of the airfoil section) of FIGS. 5 and 6 the angular component θ associated with these ranges for RL/D and locating the unducted fan propulsor system (i.e., the location of P relative to the airfoil section) are desirably between 187° and 342°, between 198° and 310°, or between 205° and 285°. These regions of RL and θ locating the unducted fan propulsor system relative to the airfoil section tend to offset scrubbing and interference drag for an unducted fan propulsor.

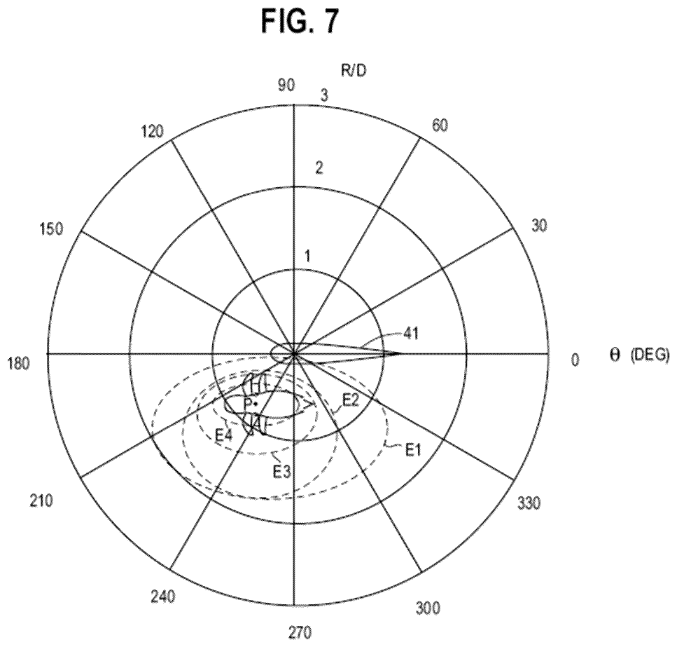

Alternatively, the point P for the unducted fan propulsor can be located within a defined ellipse defining a region relative to QC where scrubbing and interference drag tends to offset. FIGS. 7-10 each illustrate such ellipses according to several embodiments. Each of the ellipses has an origin OR, a major axis length (MajAL), and a minor axis length (MinAL), as shown in FIGS. 9 and 10 with respect to one of several ellipses and as will be explained further below. The location of OR is expressed relative to QC using the polar coordinate system frame of reference defined earlier. The propulsor system is mounted such that the point P of the unducted fan propulsors 38 is located within an ellipse as defined herein.

Referring to FIG. 9, the radial ellipse origin positioning line (EOR) extends from the ellipse origin OR, e.g., ellipse E1, to QC. The ellipse origin position line EOR has a length EORL. The origin of each of the ellipses is defined in the adopted polar coordinates with a radial coordinate defined as the ratio of EORL to the array of blades diameter (D), i.e., the quantity EORL/D. The angle θ is measured relative to the chord line (as defined earlier) and positive in a clockwise direction when the propulsor is above the airfoil section (horizontal stabilizer, FIG. 10) as indicated in the drawings, respectively, by the direction of the arrow from the origin.

An angle θ for the ellipse origin positioning line EOR is measured from a datum that is the chord line to an ellipse positioning line EOR (e.g., in FIG. 9 the vector EOR is located by an angle that is between 180 and 270 degrees measured counterclockwise about origin QC). A positive θ (1) increases in a counter-clockwise direction when the high pressure side of the airfoil section is below the airfoil section, and (2) increases in a clockwise direction when the high pressure side of the airfoil section is above the airfoil section.

In a first embodiment, the point P of the unducted fan propulsor 38 is located in a first ellipse E1 with a first ellipse origin defined by EORL/D of 0.938 and θ of 253.6°. The first ellipse E1 also has a first major axis length (1MajAL) and a first minor axis length (1MinAL), where 1MajAL/D is 2.8 and 1MinAL/D is 1.7. A unducted fan propulsor located within E1 tends to offset scrubbing and interference drag.

In a second embodiment, the point P of the unducted fan propulsor 38 is located in a second ellipse E2 having a second ellipse origin defined by EORL/D of 1.051 and θ of 248.8°. The second ellipse E2 has a second major axis length (2MajAL) and a second minor axis length (2MinAL), where 2MajAL/D is 1.86 and 2MinAL/D is 1.56. A unducted fan propulsor located within E2 tends to offset scrubbing and interference drag.

In a third embodiment, the point P of the unducted fan propulsor 38 is located in a third ellipse E3 having a third ellipse origin defined by EORL/D of 0.870 and θ of 239.6°. The third ellipse E3 has a third major axis length (3MajAL) and a third minor axis length (3MinAL), where 3MajAL/D is 1.4 and 3MinAL/D is 0.9. A unducted fan propulsor located within E3 tends to offset scrubbing and interference drag.

In a fourth embodiment, the point P of the unducted fan propulsor 38 is located in a fourth ellipse E4 having a fourth ellipse origin defined by EORL/D of 0.763 and θ of 235.7°. The fourth ellipse E4 has a fourth major axis length (4MajAL) and a fourth minor axis length (4MinAL), where 4MajAL/D is 0.94 and 4MinAL/D is 0.44. A unducted fan propulsor located within E4 tends to offset scrubbing and interference drag.

The location of the unducted fan propulsor system (i.e., point P) relative to the airfoil section may also be expressed in terms of the following expressions:

$$\frac{R L}{D} + \frac{( \sqrt{a * [ b * {sin}^{2} ( θ ) - c * {cos}^{2} ( θ ) + d * sin ( θ ) * cos ( θ ) ]} + e * sin ( θ ) + f * cos ( θ ) )}{g * {sin}^{2} ( θ ) + h * {cos}^{2} ( θ )} > 0$$

$$and$$

$$\frac{R L}{D} + \frac{( - \sqrt{a * [ b * {sin}^{2} ( θ ) - c * {cos}^{2} ( θ ) + d * sin ( θ ) * cos ( θ ) ]} + e * sin ( θ ) + f * cos ( θ ) )}{g * {sin}^{2} ( θ ) + h * {cos}^{2} ( θ )} < 0$$

where 0.07<RL/D<1.98 and 0 is between 187° and 340°, and where a, b, c, d, e, f g and h have the values set forth in the following table under the heading “Fifth Emb.”:

| | Fifth | Sixth | Seventh | Eighth |
|---|---|---|---|---|
| Variable | Emb. | Emb. | Emb. | Emb. |
| a | 1.4161 | 0.52621 | 0.09923 | 0.01069156 |
| b | 1.88978 | 0.7205 | 0.2964 | 0.036 |
| c | 0.0875 | 0.352 | 0.36 | 0.3485 |
| d | 0.477 | 0.7448 | 0.66 | 0.5418 |
| e | 1.764 | 0.8476 | 0.3675 | 0.139167 |
| f | 0.19146 | 0.23119 | 0.0891 | 0.020812 |
| g | 1.96 | 0.8649 | 0.49 | 0.2209 |
| h | 0.7225 | 0.6084 | 0.2025 | 0.0484 |

In a sixth embodiment, the point P of the unducted fan propulsor 38 can be defined by the above expression, but where 0.254<RL/D<1.86 and 0 is between 199° and 306°, and where a, b, c, d, e, f g and h have the values set forth in the above table under the heading “Sixth Emb.”

In a seventh embodiment, the point P of the unducted fan propulsor 38 can be defined by the above expression, but where 0.369<RL/D<1.43 and 0 is between 204° and 291°, and where a, b, c, d, e, f g and h have the values set forth in the above table under the heading “Seventh Emb.”.

In an eighth embodiment, the point P of the unducted fan propulsor 38 can be defined by the above expression, but where 0.477<RL/D<0.9455 and 0 is between 211° and 274°, And where a, b, c, d, e, f g and h have the values set forth in the above table under the heading “Eighth Emb.”

The unducted fan propulsor locations illustrated in FIG. 7 are made relative to an airfoil section of an aircraft wing and refer to an undermounted unducted fan propulsor system.

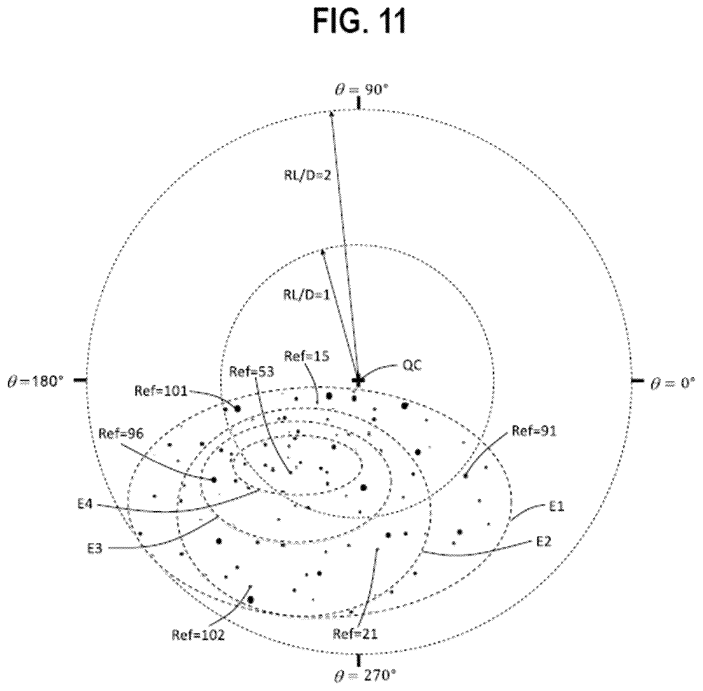

TABLES 1 and 3-6 set forth examples of embodiments of invention. TABLE 1 shows each maximum outer diameter (D) and the location of point P of the unducted fan propulsor relative to the effective quarter chord point, QC, contemplated, where the point P is defined by RL and θ. The term “Ref” refers to the row in Table 1 for reference. The exemplary types of aircraft indicated with reference letters A through I in TABLE 1 are identified in TABLE 2. The point P of the unducted fan propulsor locations from TABLE 1 are shown in FIG. 11 for an under-wing mounted propulsor (for a propulsor mounted above a horizontal stabilizer the maximum outer diameter (D) and the point P of the unducted fan propulsor locations would be mirrored about the chord line of the airfoil section, which, for purposes of explanation, may be thought of as an axis passing through θ=0 deg and θ=180 deg in FIG. 11) relative to the first ellipse (E1), second ellipse (E2), third ellipse (E3), and the fourth ellipse (E4). The size of the points in FIG. 11 represent the relative size of D for the range provided in TABLE 1 (not to scale). The rotating blades diameter (D) may be between 2-50, 8-16, 10-15, 12-14, or 14-16 feet.

TABLE 1
P-location relative to the effective quarter chord point (QC)

| | Type of | | | | |
|---|---|---|---|---|---|
| Ref. | aircraft | RL (ft) | D (ft) | θ (deg) | RL/D |
| 1 | C I | 2.60 | 2.0 | 220.00 | 1.30 |
| 2 | F I | 1.07 | 2.0 | 189.00 | 0.54 |
| 3 | I | 3.13 | 2.0 | 199.73 | 1.57 |
| 4 | C F I | 2.18 | 3.0 | 319.20 | 0.73 |
| 5 | F I | 2.82 | 3.0 | 242.40 | 0.94 |
| 6 | C I | 1.47 | 4.0 | 293.60 | 0.37 |
| 7 | C I | 2.43 | 4.0 | 217.87 | 0.61 |
| 8 | I | 6.64 | 4.0 | 259.47 | 1.66 |
| 9 | C F I | 4.23 | 5.0 | 265.87 | 0.85 |
| 10 | C H I | 6.57 | 5.0 | 194.40 | 1.31 |
| 11 | F I | 2.03 | 5.0 | 250.93 | 0.41 |
| 12 | C F H I | 8.03 | 5.0 | 275.47 | 1.61 |
| 13 | C | 2.52 | 6.0 | 337.33 | 0.42 |
| 14 | H | 4.44 | 6.0 | 228.53 | 0.74 |
| 15 | C I | 1.88 | 6.0 | 208.27 | 0.31 |
| 16 | C F | 7.14 | 7.0 | 244.53 | 1.02 |
| 17 | B F H | 4.15 | 7.0 | 332.00 | 0.59 |
| 18 | B C I | 6.49 | 7.0 | 292.53 | 0.93 |
| 19 | C G | 8.05 | 8.0 | 216.80 | 1.01 |
| 20 | B F I | 11.89 | 8.0 | 256.27 | 1.49 |
| 21 | C G H | 10.08 | 8.0 | 277.60 | 1.26 |
| 22 | B C G I | 7.31 | 8.0 | 330.93 | 0.91 |
| 23 | C H | 9.97 | 8.0 | 294.67 | 1.25 |
| 24 | G I | 11.57 | 8.0 | 312.80 | 1.45 |
| 25 | B F I | 11.58 | 9.0 | 260.53 | 1.29 |
| 26 | C H | 6.06 | 9.0 | 224.27 | 0.67 |
| 27 | F G H | 3.06 | 9.0 | 233.87 | 0.34 |
| 28 | C I | 12.78 | 9.0 | 204.00 | 1.42 |
| 29 | B H | 10.47 | 10.0 | 210.40 | 1.05 |
| 30 | B I | 5.53 | 10.0 | 221.07 | 0.55 |
| 31 | A B C F G H | 7.00 | 10.0 | 253.07 | 0.70 |
| 32 | I | 2.47 | 10.0 | 306.40 | 0.25 |
| 33 | A C | 15.27 | 10.0 | 222.13 | 1.53 |
| 34 | G | 11.67 | 10.0 | 241.33 | 1.17 |
| 35 | A C F H | 17.13 | 10.0 | 243.47 | 1.71 |
| 36 | A B G I | 18.70 | 11.0 | 210.00 | 1.70 |
| 37 | G | 10.93 | 11.0 | 249.87 | 0.99 |
| 38 | A H | 4.33 | 11.0 | 285.07 | 0.39 |
| 39 | F I | 6.82 | 11.0 | 206.13 | 0.62 |
| 40 | A F H | 11.60 | 12.0 | 272.27 | 0.97 |
| 41 | A B F I | 10.64 | 12.0 | 227.47 | 0.89 |
| 42 | A H | 21.84 | 12.0 | 232.80 | 1.82 |
| 43 | A G | 8.56 | 12.0 | 236.00 | 0.71 |
| 44 | B F H | 0.78 | 12.0 | 263.50 | 0.07 |
| 45 | A F | 10.00 | 12.5 | 200.00 | 0.80 |
| 46 | A B G H I | 15.25 | 12.5 | 268.00 | 1.22 |
| 47 | B | 19.92 | 12.5 | 279.73 | 1.59 |
| 48 | A B F | 15.92 | 12.5 | 316.00 | 1.27 |
| 49 | A B | 6.25 | 12.5 | 270.13 | 0.50 |
| 50 | A F H | 18.42 | 12.5 | 211.47 | 1.47 |
| 51 | F G | 24.25 | 12.5 | 215.73 | 1.94 |
| 52 | A B H | 19.50 | 13.0 | 287.20 | 1.50 |
| 53 | H | 10.66 | 13.0 | 234.93 | 0.82 |
| 54 | B | 14.99 | 13.0 | 326.67 | 1.15 |
| 55 | I | 18.11 | 13.0 | 239.20 | 1.39 |
| 56 | A B F H | 23.49 | 13.0 | 225.33 | 1.81 |
| 57 | A F G H | 10.49 | 13.0 | 302.13 | 0.81 |
| 58 | B I | 3.38 | 13.0 | 231.73 | 0.26 |
| 59 | A B G | 13.95 | 13.0 | 212.53 | 1.07 |
| 60 | A B H | 10.14 | 13.0 | 255.20 | 0.78 |
| 61 | F | 10.80 | 13.5 | 215.00 | 0.80 |
| 62 | A H I | 19.35 | 13.5 | 198.67 | 1.43 |
| 63 | B F | 15.39 | 13.5 | 220.00 | 1.14 |
| 64 | A G H I | 7.83 | 13.5 | 207.20 | 0.58 |
| 65 | B H | 10.30 | 13.5 | 235.70 | 0.76 |
| 66 | A B | 23.49 | 13.5 | 237.07 | 1.74 |
| 67 | A H | 22.05 | 13.5 | 238.13 | 1.63 |
| 68 | F G | 13.08 | 13.5 | 192.00 | 0.97 |
| 69 | A B F | 6.03 | 13.5 | 195.47 | 0.45 |
| 70 | A F | 13.23 | 13.5 | 200.80 | 0.98 |
| 71 | B H | 16.89 | 14.0 | 201.87 | 1.21 |
| 72 | B I | 22.68 | 14.0 | 254.13 | 1.62 |
| 73 | A B F H | 24.17 | 14.0 | 269.07 | 1.73 |
| 74 | B E G | 19.69 | 14.0 | 301.07 | 1.41 |
| 75 | A | 12.60 | 14.0 | 223.20 | 0.90 |
| 76 | H I | 23.30 | 15.0 | 214.67 | 1.55 |
| 77 | A B E G H | 10.30 | 15.0 | 248.80 | 0.69 |
| 78 | A B E H | 17.90 | 15.0 | 288.27 | 1.19 |
| 79 | F G | 21.23 | 16.0 | 246.67 | 1.33 |
| 80 | A E | 8.64 | 16.0 | 290.40 | 0.54 |
| 81 | E G | 17.60 | 16.0 | 207.00 | 1.10 |
| 82 | A E | 25.20 | 18.0 | 230.00 | 1.40 |
| 83 | F | 19.80 | 18.0 | 225.00 | 1.10 |
| 84 | A G | 6.84 | 18.0 | 263.73 | 0.38 |
| 85 | A E | 35.64 | 18.0 | 221.00 | 1.98 |
| 86 | A E | 6.17 | 20.0 | 297.03 | 0.31 |
| 87 | F | 30.55 | 21.0 | 259.78 | 1.45 |
| 88 | A D | 10.99 | 22.0 | 252.33 | 0.50 |
| 89 | A E | 21.50 | 22.0 | 237.43 | 0.98 |
| 90 | D | 14.29 | 24.0 | 222.53 | 0.60 |
| 91 | D E | 25.75 | 24.0 | 319.38 | 1.07 |
| 92 | D E | 3.41 | 29.0 | 267.23 | 0.12 |
| 93 | D | 39.42 | 29.0 | 304.48 | 1.36 |
| 94 | E | 38.55 | 33.0 | 282.13 | 1.17 |
| 95 | D | 51.16 | 33.0 | 229.98 | 1.55 |
| 96 | D E | 44.23 | 35.0 | 215.08 | 1.26 |
| 97 | E | 24.18 | 35.0 | 311.93 | 0.69 |
| 98 | D | 8.53 | 40.0 | 207.63 | 0.21 |
| 99 | D | 31.45 | 40.0 | 274.68 | 0.79 |
| 100 | D | 18.19 | 45.0 | 334.28 | 0.40 |
| 101 | D | 42.32 | 48.0 | 192.73 | 0.88 |
| 102 | D | 90.00 | 50.0 | 244.88 | 1.80 |

TABLE 2

| Designator for | |
|---|---|
| TABLE 1 | Aircraft Type |
| A | Narrow Body, twin engine |
| B | Narrow Body, 4 engines |
| C | Narrow Body, distributed propulsors (>4 engines) |
| D | Wide Body, twin engine |
| E | Wide Body, 4 engines |
| F | Wide Body, distributed propulsors (>4 engines) |
| G | Regional Jet |
| H | Business Jet |
| I | UAV |

For Aircraft Type A, B, C and G having a Mach flight speed at cruise conditions of between 0.70 and 0.85 the fan diameter (D) is between 8 and 16 feet, or more preferably between 12 feet and 16 feet.

TABLES 3-6 provide exemplary embodiments for EORL and D for each of the first ellipse E1, second ellipse E2, third ellipse E3 and fourth ellipse E4, respectively, relative to the quarter chord point (QC).

TABLE 3
First Ellipse E1 Embodiments

| | | EORL | 1MajAL | 1MinAL | | | |
|---|---|---|---|---|---|---|---|
| D (ft) | θ (deg) | (ft) | (ft) | (ft) | EORL/D | 1MajAL/D | 1MinAL/D |
| 2 | 253.6 | 1.876 | 5.6 | 3.4 | 0.938 | 2.8 | 1.7 |
| 3 | 253.6 | 2.814 | 8.4 | 5.1 | 0.938 | 2.8 | 1.7 |
| 4 | 253.6 | 3.752 | 11.2 | 6.8 | 0.938 | 2.8 | 1.7 |
| 5 | 253.6 | 4.69 | 14 | 8.5 | 0.938 | 2.8 | 1.7 |
| 6 | 253.6 | 5.628 | 16.8 | 10.2 | 0.938 | 2.8 | 1.7 |
| 7 | 253.6 | 6.566 | 19.6 | 11.9 | 0.938 | 2.8 | 1.7 |
| 8 | 253.6 | 7.504 | 22.4 | 13.6 | 0.938 | 2.8 | 1.7 |
| 9 | 253.6 | 8.442 | 25.2 | 15.3 | 0.938 | 2.8 | 1.7 |
| 10 | 253.6 | 9.38 | 28 | 17 | 0.938 | 2.8 | 1.7 |
| 11 | 253.6 | 10.318 | 30.8 | 18.7 | 0.938 | 2.8 | 1.7 |
| 12 | 253.6 | 11.256 | 33.6 | 20.4 | 0.938 | 2.8 | 1.7 |
| 12.5 | 253.6 | 11.725 | 35 | 21.25 | 0.938 | 2.8 | 1.7 |
| 13 | 253.6 | 12.194 | 36.4 | 22.1 | 0.938 | 2.8 | 1.7 |
| 13.5 | 253.6 | 12.663 | 37.8 | 22.95 | 0.938 | 2.8 | 1.7 |
| 14 | 253.6 | 13.132 | 39.2 | 23.8 | 0.938 | 2.8 | 1.7 |
| 15 | 253.6 | 14.07 | 42 | 25.5 | 0.938 | 2.8 | 1.7 |
| 16 | 253.6 | 15.008 | 44.8 | 27.2 | 0.938 | 2.8 | 1.7 |
| 18 | 253.6 | 16.884 | 50.4 | 30.6 | 0.938 | 2.8 | 1.7 |
| 20 | 253.6 | 18.76 | 56 | 34 | 0.938 | 2.8 | 1.7 |
| 21 | 253.6 | 19.698 | 58.8 | 35.7 | 0.938 | 2.8 | 1.7 |
| 22 | 253.6 | 20.636 | 61.6 | 37.4 | 0.938 | 2.8 | 1.7 |
| 24 | 253.6 | 22.512 | 67.2 | 40.8 | 0.938 | 2.8 | 1.7 |
| 29 | 253.6 | 27.202 | 81.2 | 49.3 | 0.938 | 2.8 | 1.7 |
| 33 | 253.6 | 30.954 | 92.4 | 56.1 | 0.938 | 2.8 | 1.7 |
| 35 | 253.6 | 32.83 | 98 | 59.5 | 0.938 | 2.8 | 1.7 |
| 40 | 253.6 | 37.52 | 112 | 68 | 0.938 | 2.8 | 1.7 |
| 45 | 253.6 | 42.21 | 126 | 76.5 | 0.938 | 2.8 | 1.7 |
| 48 | 253.6 | 45.024 | 134.4 | 81.6 | 0.938 | 2.8 | 1.7 |
| 50 | 253.6 | 46.9 | 140 | 85 | 0.938 | 2.8 | 1.7 |

TABLE 4
Second Ellipse E2 Embodiments

| | | EORL | 2MajAL | 2MinAL | | | |
|---|---|---|---|---|---|---|---|
| D (ft) | θ (deg) | (ft) | (ft) | (ft) | EORL/D | 2MajAL/D | 2MinAL/D |
| 2 | 248.8 | 2.102 | 3.72 | 3.12 | 1.051 | 1.86 | 1.56 |
| 3 | 248.8 | 3.153 | 5.58 | 4.68 | 1.051 | 1.86 | 1.56 |
| 4 | 248.8 | 4.204 | 7.44 | 6.24 | 1.051 | 1.86 | 1.56 |
| 5 | 248.8 | 5.255 | 9.3 | 7.8 | 1.051 | 1.86 | 1.56 |
| 6 | 248.8 | 6.306 | 11.16 | 9.36 | 1.051 | 1.86 | 1.56 |
| 7 | 248.8 | 7.357 | 13.02 | 10.92 | 1.051 | 1.86 | 1.56 |
| 8 | 248.8 | 8.408 | 14.88 | 12.48 | 1.051 | 1.86 | 1.56 |
| 9 | 248.8 | 9.459 | 16.74 | 14.04 | 1.051 | 1.86 | 1.56 |
| 10 | 248.8 | 10.51 | 18.6 | 15.6 | 1.051 | 1.86 | 1.56 |
| 11 | 248.8 | 11.561 | 20.46 | 17.16 | 1.051 | 1.86 | 1.56 |
| 12 | 248.8 | 12.612 | 22.32 | 18.72 | 1.051 | 1.86 | 1.56 |
| 12.5 | 248.8 | 13.1375 | 23.25 | 19.5 | 1.051 | 1.86 | 1.56 |
| 13 | 248.8 | 13.663 | 24.18 | 20.28 | 1.051 | 1.86 | 1.56 |
| 13.5 | 248.8 | 14.1885 | 25.11 | 21.06 | 1.051 | 1.86 | 1.56 |
| 14 | 248.8 | 14.714 | 26.04 | 21.84 | 1.051 | 1.86 | 1.56 |
| 15 | 248.8 | 15.765 | 27.9 | 23.4 | 1.051 | 1.86 | 1.56 |
| 16 | 248.8 | 16.816 | 29.76 | 24.96 | 1.051 | 1.86 | 1.56 |
| 18 | 248.8 | 18.918 | 33.48 | 28.08 | 1.051 | 1.86 | 1.56 |
| 20 | 248.8 | 21.02 | 37.2 | 31.2 | 1.051 | 1.86 | 1.56 |
| 21 | 248.8 | 22.071 | 39.06 | 32.76 | 1.051 | 1.86 | 1.56 |
| 22 | 248.8 | 23.122 | 40.92 | 34.32 | 1.051 | 1.86 | 1.56 |
| 24 | 248.8 | 25.224 | 44.64 | 37.44 | 1.051 | 1.86 | 1.56 |
| 29 | 248.8 | 30.479 | 53.94 | 45.24 | 1.051 | 1.86 | 1.56 |
| 33 | 248.8 | 34.683 | 61.38 | 51.48 | 1.051 | 1.86 | 1.56 |
| 35 | 248.8 | 36.785 | 65.1 | 54.6 | 1.051 | 1.86 | 1.56 |
| 40 | 248.8 | 42.04 | 74.4 | 62.4 | 1.051 | 1.86 | 1.56 |
| 45 | 248.8 | 47.295 | 83.7 | 70.2 | 1.051 | 1.86 | 1.56 |
| 48 | 248.8 | 50.448 | 89.28 | 74.88 | 1.051 | 1.86 | 1.56 |
| 50 | 248.8 | 52.55 | 93 | 78 | 1.051 | 1.86 | 1.56 |

TABLE 5
Third Ellipse E3 Embodiments

| | | | 3MajAL | 3MinAL | | | |
|---|---|---|---|---|---|---|---|
| D (ft) | θ (deg) | EORL (ft) | (ft) | (ft) | EORL/D | 3MajAL/D | 3MinAL/D |
| 2 | 239.6 | 1.74 | 2.8 | 1.8 | 0.87 | 1.4 | 0.9 |
| 3 | 239.6 | 2.61 | 4.2 | 2.7 | 0.87 | 1.4 | 0.9 |
| 4 | 239.6 | 3.48 | 5.6 | 3.6 | 0.87 | 1.4 | 0.9 |
| 5 | 239.6 | 4.35 | 7 | 4.5 | 0.87 | 1.4 | 0.9 |
| 6 | 239.6 | 5.22 | 8.4 | 5.4 | 0.87 | 1.4 | 0.9 |
| 7 | 239.6 | 6.09 | 9.8 | 6.3 | 0.87 | 1.4 | 0.9 |
| 8 | 239.6 | 6.96 | 11.2 | 7.2 | 0.87 | 1.4 | 0.9 |
| 9 | 239.6 | 7.83 | 12.6 | 8.1 | 0.87 | 1.4 | 0.9 |
| 10 | 239.6 | 8.7 | 14 | 9 | 0.87 | 1.4 | 0.9 |
| 11 | 239.6 | 9.57 | 15.4 | 9.9 | 0.87 | 1.4 | 0.9 |
| 12 | 239.6 | 10.44 | 16.8 | 10.8 | 0.87 | 1.4 | 0.9 |
| 12.5 | 239.6 | 10.875 | 17.5 | 11.25 | 0.87 | 1.4 | 0.9 |
| 13 | 239.6 | 11.31 | 18.2 | 11.7 | 0.87 | 1.4 | 0.9 |
| 13.5 | 239.6 | 11.745 | 18.9 | 12.15 | 0.87 | 1.4 | 0.9 |
| 14 | 239.6 | 12.18 | 19.6 | 12.6 | 0.87 | 1.4 | 0.9 |
| 15 | 239.6 | 13.05 | 21 | 13.5 | 0.87 | 1.4 | 0.9 |
| 16 | 239.6 | 13.92 | 22.4 | 14.4 | 0.87 | 1.4 | 0.9 |
| 18 | 239.6 | 15.66 | 25.2 | 16.2 | 0.87 | 1.4 | 0.9 |
| 20 | 239.6 | 17.4 | 28 | 18 | 0.87 | 1.4 | 0.9 |
| 21 | 239.6 | 18.27 | 29.4 | 18.9 | 0.87 | 1.4 | 0.9 |
| 22 | 239.6 | 19.14 | 30.8 | 19.8 | 0.87 | 1.4 | 0.9 |
| 24 | 239.6 | 20.88 | 33.6 | 21.6 | 0.87 | 1.4 | 0.9 |
| 29 | 239.6 | 25.23 | 40.6 | 26.1 | 0.87 | 1.4 | 0.9 |
| 33 | 239.6 | 28.71 | 46.2 | 29.7 | 0.87 | 1.4 | 0.9 |
| 35 | 239.6 | 30.45 | 49 | 31.5 | 0.87 | 1.4 | 0.9 |
| 40 | 239.6 | 34.8 | 56 | 36 | 0.87 | 1.4 | 0.9 |
| 45 | 239.6 | 39.15 | 63 | 40.5 | 0.87 | 1.4 | 0.9 |
| 48 | 239.6 | 41.76 | 67.2 | 43.2 | 0.87 | 1.4 | 0.9 |
| 50 | 239.6 | 43.5 | 70 | 45 | 0.87 | 1.4 | 0.9 |

TABLE 6
Fourth Ellipse E4 Embodiments

| | | EORL | 4MajAL | 4MinAL | | | |
|---|---|---|---|---|---|---|---|
| D (ft) | θ (deg) | (ft) | (ft) | (ft) | EORL/D | 4MajAL/D | 4MinAL/D |
| 2 | 235.7 | 1.526 | 1.88 | 0.88 | 0.763 | 0.94 | 0.44 |
| 3 | 235.7 | 2.289 | 2.82 | 1.32 | 0.763 | 0.94 | 0.44 |
| 4 | 235.7 | 3.052 | 3.76 | 1.76 | 0.763 | 0.94 | 0.44 |
| 5 | 235.7 | 3.815 | 4.7 | 2.2 | 0.763 | 0.94 | 0.44 |
| 6 | 235.7 | 4.578 | 5.64 | 2.64 | 0.763 | 0.94 | 0.44 |
| 7 | 235.7 | 5.341 | 6.58 | 3.08 | 0.763 | 0.94 | 0.44 |
| 8 | 235.7 | 6.104 | 7.52 | 3.52 | 0.763 | 0.94 | 0.44 |
| 9 | 235.7 | 6.867 | 8.46 | 3.96 | 0.763 | 0.94 | 0.44 |
| 10 | 235.7 | 7.63 | 9.4 | 4.4 | 0.763 | 0.94 | 0.44 |
| 11 | 235.7 | 8.393 | 10.34 | 4.84 | 0.763 | 0.94 | 0.44 |
| 12 | 235.7 | 9.156 | 11.28 | 5.28 | 0.763 | 0.94 | 0.44 |
| 12.5 | 235.7 | 9.5375 | 11.75 | 5.5 | 0.763 | 0.94 | 0.44 |
| 13 | 235.7 | 9.919 | 12.22 | 5.72 | 0.763 | 0.94 | 0.44 |
| 13.5 | 235.7 | 10.3005 | 12.69 | 5.94 | 0.763 | 0.94 | 0.44 |
| 14 | 235.7 | 10.682 | 13.16 | 6.16 | 0.763 | 0.94 | 0.44 |
| 15 | 235.7 | 11.445 | 14.1 | 6.6 | 0.763 | 0.94 | 0.44 |
| 16 | 235.7 | 12.208 | 15.04 | 7.04 | 0.763 | 0.94 | 0.44 |
| 18 | 235.7 | 13.734 | 16.92 | 7.92 | 0.763 | 0.94 | 0.44 |
| 20 | 235.7 | 15.26 | 18.8 | 8.8 | 0.763 | 0.94 | 0.44 |
| 21 | 235.7 | 16.023 | 19.74 | 9.24 | 0.763 | 0.94 | 0.44 |
| 22 | 235.7 | 16.786 | 20.68 | 9.68 | 0.763 | 0.94 | 0.44 |
| 24 | 235.7 | 18.312 | 22.56 | 10.56 | 0.763 | 0.94 | 0.44 |
| 29 | 235.7 | 22.127 | 27.26 | 12.76 | 0.763 | 0.94 | 0.44 |
| 33 | 235.7 | 25.179 | 31.02 | 14.52 | 0.763 | 0.94 | 0.44 |
| 35 | 235.7 | 26.705 | 32.9 | 15.4 | 0.763 | 0.94 | 0.44 |
| 40 | 235.7 | 30.52 | 37.6 | 17.6 | 0.763 | 0.94 | 0.44 |
| 45 | 235.7 | 34.335 | 42.3 | 19.8 | 0.763 | 0.94 | 0.44 |
| 48 | 235.7 | 36.624 | 45.12 | 21.12 | 0.763 | 0.94 | 0.44 |
| 50 | 235.7 | 38.15 | 47 | 22 | 0.763 | 0.94 | 0.44 |

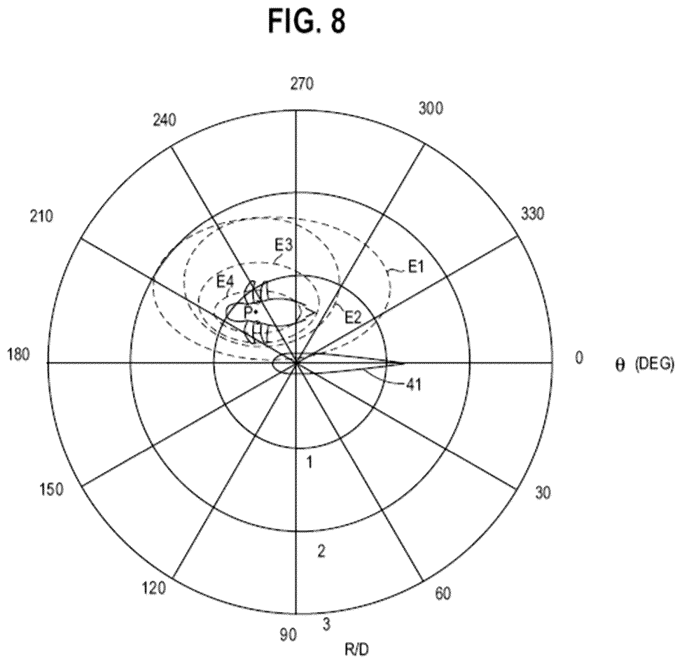

Referring to FIG. 8, the locations for P relative to the airfoil section and advantages therefrom described above can also be realized for an unducted fan propulsor system mounted above a horizontal stabilizer. For an unducted fan propulsor mounted to horizontal stabilizers, the foregoing examples and embodiments would be mirrored about the chord line of the airfoil section (again, for purposes of explanation, this chord line may be thought of as an axis passing through θ=0 deg and θ=180 deg in FIG. 11) for the case where the airfoil section 41 produces a lift in the downward direction, such as a horizontal stabilizer, as compared to a wing which produces a lift in the upward direction. The above descriptions for an undermount propulsor can apply, with the location being shifted as shown in FIG. 8 as compared to FIG. 7.

According to the foregoing examples or embodiments, the unducted fan propulsor 38, incorporating the vane assembly described herein, can be incorporated into an airplane or other aircraft having a cruise flight Mach M₀ of between 0.70 and 0.85, between 0.75 and 0.85, between 0.75 and 0.79, between 0.5 and 0.9, between 0.7 and 0.9, or between 0.75 and 0.9. A propulsor that is part of an airplane that operates at a high cruise flight Mach number (e.g., greater than 0.7) encounters velocities near the surfaces of the rotor, vanes, and nacelle that approach or exceed the speed of sound, or Mach 1.0. In general, friction drag increases roughly in proportion to the square of the air velocity. However, as the Mach number increases, a significant contributor to the increase in drag can come from wave drag. Wave drag is a drag resulting from shock waves that form as the flow of air near a surface becomes supersonic (e.g., Mach >1.0).

In addition to the cruise flight Mach number, another factor contributing to increased drag on propulsor surfaces is high non-dimensional cruise fan net thrust based on fan annular area and flight speed. The same acceleration of the air stream by the fan that produces thrust also tends to increase the drag force on the rotor, vanes, and nacelle.

Expressing thrust non-dimensionally in a way that accounts for flight speed, ambient conditions, and fan annular area yields a thrust parameter as follows:

$$\frac{{F}_{net}}{{ρ}_{0} {A}_{an} {V}_{0}^{2}}$$

In the above thrust parameter, Fₙₑₜ is cruise fan net thrust, po is ambient air density, Vₒ is cruise flight velocity, and Aₐₙ is fan stream tube cross-sectional area at the fan inlet. Fan annular area, Aₐₙ, is computed using a maximum radius as the tip radius of the forward-most rotor blades and a minimum radius as the minimum radius of the fan stream tube entering the fan.

A propulsor that operates at a high cruise fan net thrust parameter (e.g., greater than 0.06) tends to have higher propulsor velocities with risk of higher drag on propulsor surfaces.

According to any of the foregoing examples or embodiments, there may be a particularly beneficial range of a dimensionless cruise fan net thrust parameter normalized by ambient density, cruise flight speed squared, and fan stream tube annular area at fan inlet defined by the following expression:

$$0.15 > \frac{{F}_{net}}{{ρ}_{0} {A}_{an} {V}_{0}^{2}} > 0.06$$

Both a high cruise flight Mach and high dimensionless cruise fan net thrust parameter contribute to higher drag levels on the propulsor surfaces. Advantageously, the specific unducted fan propulsor positions relative to the wing airfoil section, as described herein, can increase unducted fan propulsor net thrust for a given power input when there is a high cruise flight Mach and a high dimensionless cruise fan net thrust parameter.

Using the conditions described herein, the specific regions for placing the unducted fan propulsor system can be located where there is a relatively higher pressure on the high pressure side of the airfoil, beneath the wings or above the horizontal stabilizers. The higher pressure provides increased thrust from the unducted fan propulsor to thereby offset drag penalties resulting from the installation of unducted fan propulsors.

The foregoing conditions for the placement of the propulsors relative to the wing airfoils can be present for any mounting configuration of the propulsors wing. While the mounting configuration can be fixed, it is contemplated that the mounting configuration could be variable. For example, the mounting configuration of an unducted fan propulsor relative to a wing could be different for takeoff as compared to cruise operating conditions. In such a scenario, the foregoing conditions for placement of the propulsors relative to the wing airfoils can be present in either or both operating conditions, or any other operating condition.

The features described above for positioning an unducted fan propulsor relative to the aircraft wing by defining a point P location between external OGV or IGV and a forward or aft rotating array of fan blades, respectively, defining the distance from the effective quarter chord point QC to P, defining a positioning line R having a length RL from QC to P, and setting constraints on the angle of R and RL/D, where D is the fan diameter, results in improved installed performance of the unducted fan propulsor by increasing thrust due to higher pressure air on the pressure side of the wing airfoil. Positioning an unducted fan propulsor at such a location opens up the design space for the open fan, enabling the use of larger fans that generate more thrust.

The use of a larger fan in turn enables the use of smaller thrust generating turbomachinery, resulting in weight savings for the unducted fan propulsor and more efficient thrust generation. However, the turbomachinery still needs to be able to generate sufficient thrust. A measure of the ability of a gas turbine engine to maintain or improve upon propulsive efficiency via a third stream is a ratio of an airflow through a lower fan duct inlet to the airflow through the core duct in a gas turbine engine. When a gas turbine engine includes a booster located downstream of a secondary fan, with a booster cowl that separates an upstream portion of a fan duct into an upper fan duct and a lower fan duct, the ratio of an airflow through a lower fan duct inlet to the airflow through the core duct in a gas turbine engine may be referred to as a booster bleed ratio. Maintaining the booster bleed ratio within a particular range ensures that the turbomachinery efficiently generates thrust.

Combining the installation location for an unducted fan propulsor, as described above, with a booster bleed ratio, as described below, results in an overall more efficient thrust that combines the advantages of a larger fan with smaller turbomachinery. Furthermore, such a combination may help to ensure that an unducted fan propulsor with a large fan does not stall during takeoff conditions by ensuring a turbomachine compressor is receiving an appropriate amount of airflow at the high fan speeds experienced during takeoff conditions.

In certain exemplary embodiments an operating temperature of the airflow through the third stream may be less than a maximum compressor discharge temperature for the engine, and more specifically may be less than 350 degrees Fahrenheit (such as less than 300 degrees Fahrenheit, such as less than 250 degrees Fahrenheit, such as less than 200 degrees Fahrenheit, and at least as great as an ambient temperature). In certain exemplary embodiments these operating temperatures may facilitate heat transfer to or from the airflow through the third stream and a separate fluid stream. Further, in certain exemplary embodiments, the airflow through the third stream may contribute less than 50% of the total engine thrust (and at least, e.g., 2% of the total engine thrust) at a takeoff condition, or more particularly while operating at a rated takeoff power at sea level, static flight speed, 86 degrees Fahrenheit ambient temperature operating conditions.

Furthermore in certain exemplary embodiments, aspects of the airflow through the third stream (e.g., airstream, mixing, or exhaust properties), and thereby the aforementioned exemplary percent contribution to total thrust, may passively adjust during engine operation or be modified purposefully through use of engine control features (such as fuel flow, electric machine power, variable stators, variable inlet guide vanes, valves, variable exhaust geometry, or fluidic features) to adjust or optimize overall system performance across a broad range of potential operating conditions.

The term “disk loading” refers to an average pressure change across a plurality of rotor blades of a rotor assembly, such as the average pressure change across a plurality of fan blades of a fan.

The term “rated speed” refers to an operating condition of an engine at which the engine is operating in the maximum, full load operating condition that is rated by the manufacturer.

The term “standard day operating condition” refers to ambient conditions of sea level altitude, 59 degrees Fahrenheit, and 60 percent relative humidity.

The term “propulsive efficiency” refers to an efficiency with which the energy contained in an engine's fuel is converted into kinetic energy for the vehicle incorporating the engine, to accelerate it, or to replace losses due to aerodynamic drag or gravity.

Generally, an aeronautical gas turbine engine includes a fan to provide a desired amount of thrust without overloading the fan blades (i.e., without increasing a disk loading of the fan blades of the fan beyond a certain threshold), and therefore to maintain a desired overall propulsive efficiency for the gas turbine engine. Conventional gas turbine engine design practice has been to provide an outer nacelle surrounding the fan to provide relatively efficient thrust for the gas turbine engine. Such a configuration, sometimes referred to as a turbofan engine configuration, may generally limit a permissible size of the fan (i.e., a diameter of the fan). However, the inventors of the present disclosure have found that gas turbine engine design is now driving the diameter of the fan higher to provide as much thrust for the gas turbine engine as possible from the fan to improve an overall propulsive efficiency of the gas turbine engine.

By increasing the fan diameter, an installation of the gas turbine engine becomes more difficult. In addition, if an outer nacelle is maintained, the outer nacelle may become weight prohibitive with some larger diameter fans. Further, as the need for gas turbine engines to provide more thrust continues, the thermal demands on the gas turbine engines correspondingly increases.

The inventors of the present disclosure found that for a three stream gas turbine engine having a primary fan and a secondary fan, with the secondary fan being a ducted fan providing an airflow to a third stream of the gas turbine engine, an overall propulsive efficiency of the gas turbine engine that results from providing a high diameter fan may be maintained at a high level, while reducing the size of the primary fan. Such a configuration may maintain a desired overall propulsive efficiently for the gas turbine engine, or unexpectedly may in fact increase the overall propulsive efficiency of the gas turbine engine.

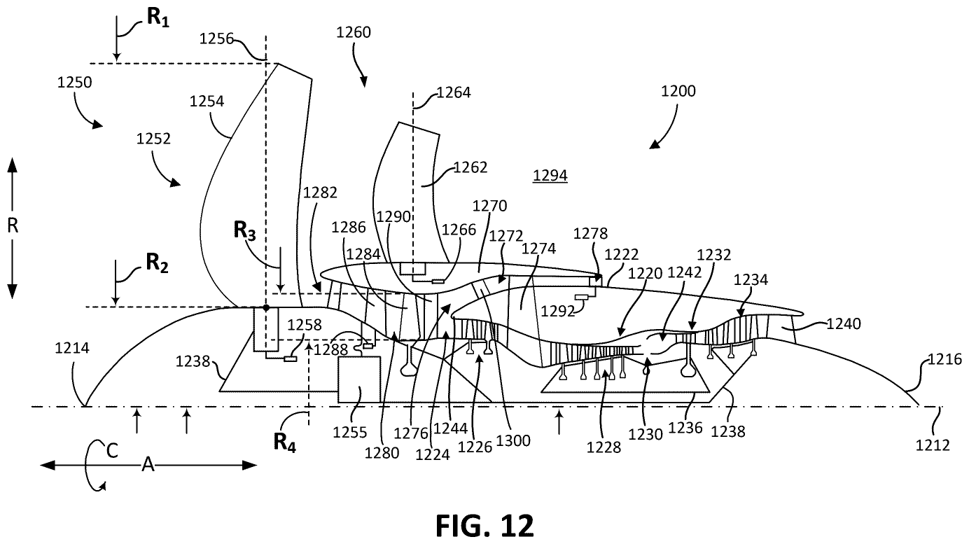

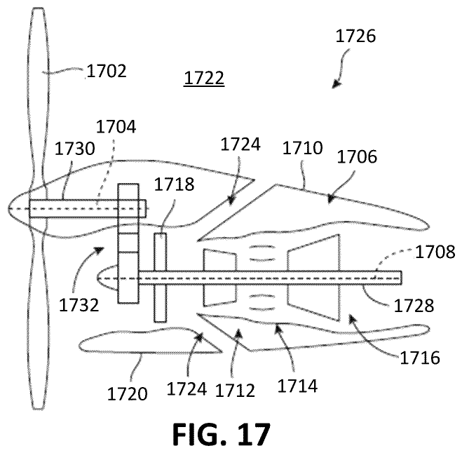

The inventors proceeded in the manner of designing a gas turbine engine with given primary fan characteristics, secondary fan characteristics, and turbomachine characteristics; checking the propulsive efficiency of the designed gas turbine engine; redesigning the gas turbine engine with varying primary fan, secondary fan, and turbomachine characteristics; rechecking the propulsive efficiency of the redesigned gas turbine engine; etc. during the design of several different types of gas turbine engines, including the gas turbine engines described below with reference to FIGS. 12, 17, through 18. During the course of this practice of studying/evaluating various primary fan characteristics, secondary fan characteristics, and turbomachine characteristics considered feasible for best satisfying mission requirements, it was discovered that certain relationships exist between a ratio of an airflow through the bypass passage and the third stream to an airflow through a core duct (referred to hereinbelow as a thrust to power airflow ratio), as well as between a ratio of an airflow through the third steam to the airflow through the core duct (referred to hereinbelow as a core bypass ratio). In particular, the inventors of the present disclosure have found that these ratios can be thought of as an indicator of the ability of a gas turbine engine to maintain or even improve upon a desired propulsive efficiency via the third stream and, additionally, indicating an improvement in the gas turbine engine's packaging concerns and weight concerns, and thermal management capabilities.

Referring now to FIG. 12, a schematic cross-sectional view of a gas turbine engine 1200 is provided according to an example embodiment of the present disclosure. Particularly, FIG. 12 provides a gas turbine engine having a rotor assembly with a single stage of unducted rotor blades. In such a manner, the rotor assembly may be referred to herein as an “unducted fan,” or the entire engine 1200 may be referred to as an “unducted gas turbine engine.” In addition, the engine 1200 of FIG. 12 includes a third stream extending from the compressor section to a rotor assembly flowpath over the turbomachine, as will be explained in more detail below.

For reference, the engine 1200 defines an axial direction A, a radial direction R, and a circumferential direction C. Moreover, the engine 1200 defines an axial centerline or longitudinal axis 1212 that extends along the axial direction A. In general, the axial direction A extends parallel to the longitudinal axis 1212, the radial direction R extends outward from and inward to the longitudinal axis 1212 in a direction orthogonal to the axial direction A, and the circumferential direction extends three hundred sixty degrees (360°) around the longitudinal axis 1212. The engine 1200 extends between a forward end 1214 and an aft end 1216, e.g., along the axial direction A.

The engine 1200 includes a turbomachine 1220 and a rotor assembly, also referred to a fan section 1250, positioned upstream thereof. Generally, the turbomachine 1220 includes, in serial flow order, a compressor section, a combustion section, a turbine section, and an exhaust section. Particularly, as shown in FIG. 12, the turbomachine 1220 includes a core cowl 1222 that defines an annular core inlet 1224. The core cowl 1222 further encloses at least in part a low pressure system and a high pressure system. For example, the depicted core cowl 1222 encloses and supports at least in part a booster or low pressure (“LP”) compressor 1226 for pressurizing the air that enters the turbomachine 1220 through core inlet 1224. A high pressure (“HP”), multi-stage, axial-flow compressor 1228 receives pressurized air from the LP compressor 1226 and further increases the pressure of the air. The pressurized air stream flows downstream to a combustor 1230 of the combustion section where fuel is injected into the pressurized air stream and ignited to raise the temperature and energy level of the pressurized air.

It will be appreciated that as used herein, the terms “high/low speed” and “high/low pressure” are used with respect to the high pressure/high speed system and low pressure/low speed system interchangeably. Further, it will be appreciated that the terms “high” and “low” are used in this same context to distinguish the two systems, and are not meant to imply any absolute speed and/or pressure values.

The high energy combustion products flow from the combustor 1230 downstream to a high pressure turbine 1232. The high pressure turbine 1232 drives the high pressure compressor 1228 through a high pressure shaft 1236. In this regard, the high pressure turbine 1232 is drivingly coupled with the high pressure compressor 1228. As will be appreciated, the high pressure compressor 1228, the combustor 1230, and the high pressure turbine 1232 may collectively be referred to as the “core” of the engine 1200. The high energy combustion products then flow to a low pressure turbine 1234. The low pressure turbine 1234 drives the low pressure compressor 1226 and components of the fan section 1250 through a low pressure shaft 1238. In this regard, the low pressure turbine 1234 is drivingly coupled with the low pressure compressor 1226 and components of the fan section 1250. The LP shaft 1238 is coaxial with the HP shaft 1236 in this example embodiment. After driving each of the turbines 1232, 1234, the combustion products exit the turbomachine 1220 through a turbomachine exhaust nozzle 1240.

Accordingly, the turbomachine 1220 defines a working gas flowpath or core duct 1242 that extends between the core inlet 1224 and the turbomachine exhaust nozzle 1240. The core duct 1242 is an annular duct positioned generally inward of the core cowl 1222 along the radial direction R. The core duct 1242 (e.g., the working gas flowpath through the turbomachine 1220) may be referred to as a second stream.

The fan section 1250 includes a fan 1252, which is the primary fan in this example embodiment. For the depicted embodiment of FIG. 12, the fan 1252 is an open rotor or unducted fan 1252. In such a manner, the engine 1200 may be referred to as an open rotor engine.

As depicted, the fan 1252 includes an array of fan blades 1254 (only one shown in FIG. 12). The fan blades 1254 are rotatable, e.g., about the longitudinal axis 1212. As noted above, the fan 1252 is drivingly coupled with the low pressure turbine 1234 via the LP shaft 1238. For the embodiments shown in FIG. 12, the fan 1252 is coupled with the LP shaft 1238 via a speed reduction gearbox 1255, e.g., in an indirect-drive or geared-drive configuration.

Moreover, the array of fan blades 1254 can be arranged in equal spacing around the longitudinal axis 1212. Each fan blade 1254 has a root and a tip and a span defined therebetween. Further, each fan blade 1254 defines a fan blade tip radius R₁ along the radial direction R from the longitudinal axis 1212 to the tip, and a hub radius (or inner radius) R₂ along the radial direction R from the longitudinal axis 1212 to the base of each fan blade 1254 (i.e., from the longitudinal axis 1212 to a radial location where each fan blade 1254 meets a front hub of the gas turbine engine 1200 at a leading edge of the respective fan blade 1254). As will be appreciated, a distance from the base of each fan blade 1254 to a tip of the respective fan blade 1254 is referred to as a span of the respective fan blade 1254. Further, the fan 1252, or rather each fan blade 1254 of the fan 1252, defines a fan radius ratio, RqR, equal to R₁ divided by R₂. As the fan 1252 is the primary fan of the engine 1200, the fan radius ratio, RqR, of the fan 1252 may be referred to as the primary fan radius ratio, RqR_{Prim.-Fan}.

Moreover, each fan blade 1254 defines a central blade axis 1256. For this embodiment, each fan blade 1254 of the fan 1252 is rotatable about their respective central blade axis 1256, e.g., in unison with one another. One or more actuators 1258 are provided to facilitate such rotation and therefore may be used to change a pitch of the fan blades 1254 about their respective central blades' axes 1256.

The fan section 1250 further includes a fan guide vane array 1260 that includes fan guide vanes 1262 (only one shown in FIG. 12) disposed around the longitudinal axis 1212. For this embodiment, the fan guide vanes 1262 are not rotatable about the longitudinal axis 1212. Each fan guide vane 1262 has a root and a tip and a span defined therebetween. The fan guide vanes 1262 may be unshrouded as shown in FIG. 12 or, alternatively, may be shrouded, e.g., by an annular shroud spaced outward from the tips of the fan guide vanes 1262 along the radial direction R or attached to the fan guide vanes 1262.

Each fan guide vane 1262 defines a central blade axis 1264. For this embodiment, each fan guide vane 1262 of the fan guide vane array 1260 is rotatable about its respective central blade axis 1264, e.g., in unison with one another. One or more actuators 1266 are provided to facilitate such rotation and therefore may be used to change a pitch of the fan guide vane 1262 about its respective central blade axis 1264. However, in other embodiments, each fan guide vane 1262 may be fixed or unable to be pitched about its central blade axis 1264. The fan guide vanes 1262 are mounted to a fan cowl 1270.

As shown in FIG. 12, in addition to the fan 1252, which is unducted, a ducted fan 1284 is included aft of the fan 1252, such that the engine 1200 includes both a ducted and an unducted fan which both serve to generate thrust through the movement of air without passage through at least a portion of the turbomachine 1220 (e.g., without passage through the HP compressor 1228 and combustion section for the embodiment depicted). The ducted fan 1284 is rotatable about the same axis (e.g., the longitudinal axis 1212) as the fan blade 1254. The ducted fan 1284 is, for the embodiment depicted, driven by the low pressure turbine 1234 (e.g. coupled to the LP shaft 1238). In the embodiment depicted, as noted above, the fan 1252 may be referred to as the primary fan, and the ducted fan 1284 may be referred to as a secondary fan. It will be appreciated that these terms “primary” and “secondary” are terms of convenience, and do not imply any particular importance, power, or the like.

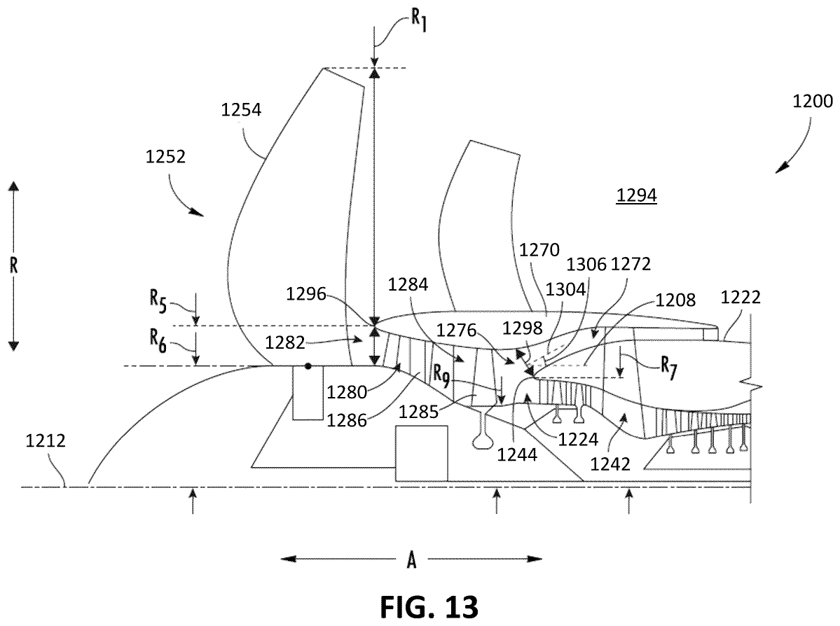

The ducted fan 1284 includes a plurality of fan blades (not separately labeled in FIG. 12; see fan blades 1285 labeled in FIG. 13) arranged in a single stage, such that the ducted fan 1284 may be referred to as a single stage fan. The fan blades of the ducted fan 1284 can be arranged in equal spacing around the longitudinal axis 1212. Each blade of the ducted fan 1284 has a root and a tip and a span defined therebetween. Further, each fan blade of the ducted fan 1284 defines a fan blade tip radius R₃ along the radial direction R from the longitudinal axis 1212 to the tip, and a hub radius (or inner radius) R₄ along the radial direction R from the longitudinal axis 1212 to the base of the respective fan blades of the ducted fan 1284 (i.e., a location where the respective fan blades of the ducted fan 1284 meet an inner flowpath liner at a leading edge of the respective fan blades of the ducted fan 1284). As will be appreciated, a distance from the base of each fan blade of the ducted fan 1284 to a tip of the respective fan blade is referred to as a span of the respective fan blade. Further, the ducted fan 1284, or rather each fan blade of the ducted fan 1284, defines a fan radius ratio, RqR, equal to R₃ divided by R₄. As the ducted fan 1284 is the secondary fan of the engine 1200, the fan radius ratio, RqR, of the ducted fan 1284 may be referred to as the secondary fan radius ratio, RqR_{Sec.-Fan}.

The fan cowl 1270 annularly encases at least a portion of the core cowl 1222 and is generally positioned outward of at least a portion of the core cowl 1222 along the radial direction R. Particularly, a downstream section of the fan cowl 1270 extends over a forward portion of the core cowl 1222 to define a fan duct flowpath, or simply a fan duct 1272. According to this embodiment, the fan flowpath or fan duct 1272 may be understood as forming at least a portion of the third stream of the engine 1200.

Incoming air may enter through the fan duct 1272 through a fan duct inlet 1276 and may exit through a fan exhaust nozzle 1278 to produce propulsive thrust. The fan duct 1272 is an annular duct positioned generally outward of the core duct 1242 along the radial direction R. The fan cowl 1270 and the core cowl 1222 are connected together and supported by a plurality of substantially radially-extending, circumferentially-spaced stationary struts 1274 (only one shown in FIG. 12). The stationary struts 1274 may each be aerodynamically contoured to direct air flowing thereby. Other struts in addition to the stationary struts 1274 may be used to connect and support the fan cowl 1270 and/or core cowl 1222. In many embodiments, the fan duct 1272 and the core duct 1242 may at least partially co-extend (generally axially) on opposite sides (e.g., opposite radial sides) of the core cowl 1222. For example, the fan duct 1272 and the core duct 1242 may each extend directly from a leading edge 1244 of the core cowl 1222 and may partially co-extend generally axially on opposite radial sides of the core cowl 1222.

The engine 1200 also defines or includes an inlet duct 1280. The inlet duct 1280 extends between an engine inlet 1282 and the core inlet 1224/fan duct inlet 1276. The engine inlet 1282 is defined generally at the forward end of the fan cowl 1270 and is positioned between the fan 1252 and the fan guide vane array 1260 along the axial direction A. The inlet duct 1280 is an annular duct that is positioned inward of the fan cowl 1270 along the radial direction R. Air flowing downstream along the inlet duct 1280 is split, not necessarily evenly, into the core duct 1242 and the fan duct 1272 by a fan duct splitter or leading edge 1244 of the core cowl 1222. The inlet duct 1280 is wider than the core duct 1242 along the radial direction R. The inlet duct 1280 is also wider than the fan duct 1272 along the radial direction R. The secondary fan 1284 is positioned at least partially in the inlet duct 1280.

Notably, for the embodiment depicted, the engine 1200 includes one or more features to increase an efficiency of a third stream thrust, Fn_{3S} (e.g., a thrust generated by an airflow through the fan duct 1272 exiting through the fan exhaust nozzle 1278, generated at least in part by the ducted fan 1284). In particular, the engine 1200 further includes an array of inlet guide vanes 1286 positioned in the inlet duct 1280 upstream of the ducted fan 1284 and downstream of the engine inlet 1282. The array of inlet guide vanes 1286 are arranged around the longitudinal axis 1212. For this embodiment, the inlet guide vanes 1286 are not rotatable about the longitudinal axis 1212. Each inlet guide vanes 1286 defines a central blade axis (not labeled for clarity), and is rotatable about its respective central blade axis, e.g., in unison with one another. In such a manner, the inlet guide vanes 1286 may be considered a variable geometry component. One or more actuators 1288 are provided to facilitate such rotation and therefore may be used to change a pitch of the inlet guide vanes 1286 about their respective central blade axes. However, in other embodiments, each inlet guide vanes 1286 may be fixed or unable to be pitched about its central blade axis.

Further, located downstream of the ducted fan 1284 and upstream of the fan duct inlet 1276, the engine 1200 includes an array of outlet guide vanes 1290. As with the array of inlet guide vanes 1286, the array of outlet guide vanes 1290 are not rotatable about the longitudinal axis 1212. However, for the embodiment depicted, unlike the array of inlet guide vanes 1286, the array of outlet guide vanes 1290 are configured as fixed-pitch outlet guide vanes.

Further, it will be appreciated that for the embodiment depicted, the fan exhaust nozzle 1278 of the fan duct 1272 is further configured as a variable geometry exhaust nozzle. In such a manner, the engine 1200 includes one or more actuators 1292 for modulating the variable geometry exhaust nozzle. For example, the variable geometry exhaust nozzle may be configured to vary a total cross-sectional area (e.g., an area of the nozzle in a plane perpendicular to the longitudinal axis 1212) to modulate an amount of thrust generated based on one or more engine operating conditions (e.g., temperature, pressure, mass flowrate, etc. of an airflow through the fan duct 1272). A fixed geometry exhaust nozzle may also be adopted.

The combination of the array of inlet guide vanes 1286 located upstream of the ducted fan 1284, the array of outlet guide vanes 1290 located downstream of the ducted fan 1284, and the fan exhaust nozzle 1278 may result in a more efficient generation of third stream thrust, Fn_{3S}, during one or more engine operating conditions. Further, by introducing a variability in the geometry of the inlet guide vanes 1286 and the fan exhaust nozzle 1278, the engine 1200 may be capable of generating more efficient third stream thrust, Fn_{3S}, across a relatively wide array of engine operating conditions, including takeoff and climb (where a maximum total engine thrust Fn_{Total}, is generally needed) as well as cruise (where a lesser amount of total engine thrust, Fn_{Total}, is generally needed).

Moreover, referring still to FIG. 12, in exemplary embodiments, air passing through the fan duct 1272 may be relatively cooler (e.g., lower temperature) than one or more fluids utilized in the turbomachine 1220. In this way, one or more heat exchangers 1300 may be positioned in thermal communication with the fan duct 1272. For example, one or more heat exchangers 1300 may be disposed within the fan duct 1272 and utilized to cool one or more fluids from the core engine with the air passing through the fan duct 1272, as a resource for removing heat from a fluid, e.g., compressor bleed air, oil or fuel.

Although not depicted, the heat exchanger 1300 may be an annular heat exchanger extending substantially 360 degrees in the fan duct 1272 (e.g., at least 300 degrees, such as at least 330 degrees). In such a manner, the heat exchanger 1300 may effectively utilize the air passing through the fan duct 1272 to cool one or more systems of the engine 1200 (e.g., lubrication oil systems, compressor bleed air, electrical components, etc.). The heat exchanger 1300 uses the air passing through duct 1272 as a heat sink and correspondingly increases the temperature of the air downstream of the heat exchanger 1300 and exiting the fan exhaust nozzle 1278.

Referring now to FIG. 13, a close-up, simplified, schematic view of the gas turbine engine 1200 of FIG. 12 is provided. The gas turbine engine 1200, as noted above, includes a primary fan, or rather fan 1252 having fan blades 1254, and a secondary fan, or rather ducted fan 1284 having fan blades 1285. Airflow from the fan 1252 is split between a bypass region 1294 and the inlet duct 1280 by an inlet splitter 1296. Airflow from the ducted fan 1284 is split between the fan duct 1272 and the core duct 1242 by the leading edge 1244 (sometimes also referred to as a fan duct splitter).

The exemplary gas turbine engine 1200 depicted in FIG. 13 further defines a primary fan outer fan area, A_{P_Out}, a primary fan inner fan area, A_{P_In}, a secondary fan outer fan area, A_{S_Out}, and a secondary fan inner fan area, A_{S_In}.

The primary fan outer fan area, A_{P_Out}, refers to an area defined by an annulus representing a portion of the fan 1252 located outward of the inlet splitter 1296 of the fan cowl 1270. In particular, the gas turbine engine 1200 further defines a fan cowl splitter radius, R₅. The fan cowl splitter radius, R₅, is defined along the radial direction R from the longitudinal axis 1212 to the inlet splitter 1296. The primary fan outer fan area, A_{P_Out}, refers to an area defined by the formula:

$$π {R}_{1}^{2} - π {R}_{5}^{2} .$$

The primary fan inner fan area, A_{P_In}, refers to an area defined by an annulus representing a portion of the fan 1252 located inward of the inlet splitter 1296 of the fan cowl 1270. In particular, the gas turbine engine 1200 further defines an engine inlet inner radius, R₆. The engine inlet inner radius, R₆, is defined along the radial direction R from the longitudinal axis 1212 to an inner casing defining the engine inlet 1282 directly inward along the radial direction R from the inlet splitter 1296. The primary fan inner fan area, A_{P_In}, refers to an area defined by the formula:

$$π {R}_{5}^{2} - π {R}_{6}^{2} .$$

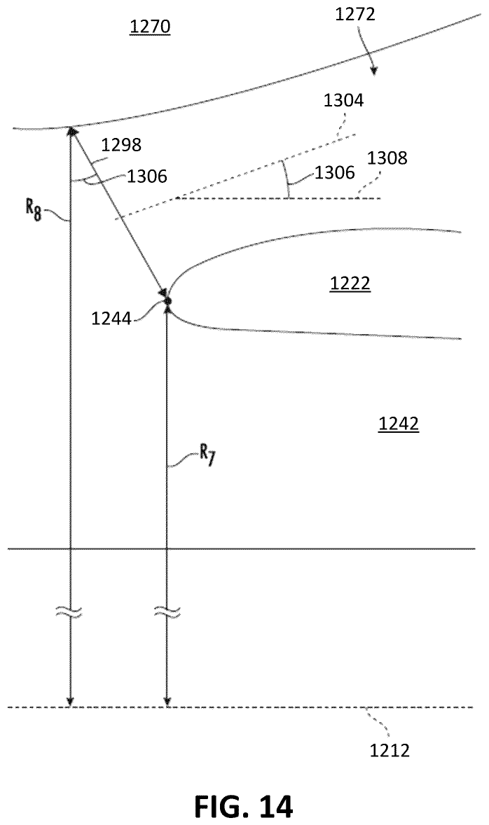

The secondary fan outer fan area, A_{S_out}, refers to an area representing a portion of an airflow from the ducted fan 1284 that is provided to the fan duct 1272. In particular, the leading edge 1244 defines a leading edge radius, R₇, and the gas turbine engine 1200 defines an effective fan duct inlet outer radius, R₈ (see FIG. 14). The leading edge radius, R₇, is defined along the radial direction R from the longitudinal axis 1212 to the leading edge 1244.

Referring briefly to FIG. 14, providing a close-up view of an area surrounding the leading edge 1244, the fan duct 1272 defines a cross-wise height 1298 measured from the leading edge 1244 to the fan cowl 1270 in a direction perpendicular to a mean flow direction 204 of an airflow through a forward 10% of the fan duct 1272. An angle 206 is defined by the mean flow direction 204 relative to a reference line 208 extending parallel to the longitudinal axis 1212. The angle 206 is referred to as θ. In certain embodiments, the angle 206 may be between 5 degrees and 80 degrees, such as between 10 degrees and 60 degrees (an increased angle is a counterclockwise rotation in FIG. 14). The effective fan duct inlet outer radius, R₈, is defined along the radial direction R from the longitudinal axis 1212 to where the cross-wise height 1298 meets the fan cowl 1270. The secondary fan outer fan area, A_{S_Out}, refers to an area defined by the formula:

$$\frac{π ( {R}_{8}^{2} - {R}_{7}^{2} )}{cos ( θ )} .$$

Referring back to FIG. 13, the secondary fan inner fan area, A_{S_In}, refers to an area defined by an annulus representing a portion of the ducted fan 1284 located inward of the leading edge 1244 of the core cowl 1222. In particular, the gas turbine engine 1200 further defines a core inlet inner radius, R₉. The core inlet inner radius, R₉, is defined along the radial direction R from the longitudinal axis 1212 to an inner casing defining the core inlet 1224 directly inward along the radial direction R from the leading edge 1244. The secondary fan inner fan area, A_{S_In}, refers to an area defined by the formula:

$$π {R}_{7}^{2} - π {R}_{9}^{2} .$$

The primary fan outer fan area, A_{P_Out}, the primary fan inner fan area, A_{P_In}, the secondary fan outer fan area, A_{S_Out}, and the secondary fan inner fan area, A_{S_In}, may be used in defining various airflow ratios for the engine 1200. In particular, it will be appreciated that the exemplary engine 1200 of FIGS. 12 through 3 further defines a thrust to power airflow ratio and a core bypass ratio, which as discussed herein are used to define an engine in accordance with the present disclosure. The thrust to power airflow ratio is a ratio of an airflow through the bypass passage of the engine 1200 (a passage within the bypass region 1294, as defined below) and through the fan duct 1272 to an airflow through the core duct 1242. Further, the core bypass ratio is a ratio of an airflow through the fan duct 1272 to the airflow through the core duct 1242. These ratios are calculated while the engine 1200 is operating at a rated speed during standard day operating conditions, and the amounts of airflow used to calculate these ratios are each expressed as a mass flowrate in the same units (mass per unit time).

More specifically, the amount of airflow through the engine's bypass passage can be determined using a fan pressure ratio for the fan 1252, a rotational speed of the fan 1252, or both while the engine is operating at the rated speed during standard day operating conditions, and the primary fan outer fan area, A_{P_Out}. The amount of airflow through the inlet duct 1280 can be determined using a fan pressure ratio for the fan 1252, a rotational speed of the fan 1252, or both while operating at a rated speed during standard day operating conditions, and the primary fan inner fan area, A_{P_In}. The amount of airflow through the fan duct 1272 and the amount of airflow through the core duct 1242 can be determined based on the amount of airflow through the inlet duct 1280 while the engine is operating at the rated speed during standard day operating conditions; a fan pressure ratio, a rotational speed, or both of the ducted fan 1284 while the engine is operating at the rated speed during standard day operating conditions; and the secondary fan outer fan area, A_{S_out}, and the secondary fan inner fan area, A_{S_In}.

As alluded to earlier, the inventors discovered, unexpectedly during the course of gas turbine engine design—i.e., designing gas turbine engines (e.g., unducted gas turbine engines and turboprop engines) having a variety of different primary fan and secondary fan characteristics—and evaluating an overall propulsive efficiency, significant relationships exist in a ratio of an airflow through a bypass passage and through a third stream to an airflow through a core duct (referred to herein as a thrust to power airflow ratio), as well as in a ratio of an airflow through the third steam to the airflow through the core duct (referred to herein as a core bypass ratio). These relationships can be thought of as an indicator of the ability of a gas turbine engine to maintain or even improve upon a desired propulsive efficiency via the third stream and, additionally, indicating an improvement in the gas turbine engine's packaging concerns and weight concerns, and thermal management capabilities.

As will be appreciated, it may generally be desirable to increase a fan diameter in order to provide a higher thrust to power airflow ratio, which typically correlates to a higher overall propulsive efficiency. However, increasing the fan diameter too much may actually result in a decrease in propulsive efficiency at higher speeds due to a drag from the fan blades. Further, increasing the fan diameter too much may also create prohibitively heavy fan blades, creating installation problems due to the resulting forces on the supporting structure (e.g., frames, pylons, etc.), exacerbated by a need to space the engine having such fan blades further from a mounting location on the aircraft to allow the engine to fit, e.g., under/over the wing, adjacent to the fuselage, etc.

Similarly, it may generally be desirable to increase an airflow through the fan duct relative to the core duct in order to provide a higher core bypass ratio, as such may also generally correlate to a higher overall propulsive efficiency. Notably, however, the higher the core bypass ratio, the less airflow provided to the core of the gas turbine engine. For a given amount of power needed to drive, e.g., a primary fan and a secondary fan of the gas turbine engine, if less airflow is provided, either a maximum temperature of the core needs to be increased or a size of the primary fan or secondary fan needs to be decreased. Such a result can lead to either premature wear of the core or a reduction in propulsive efficiency of the gas turbine engine.

As noted above, the inventors of the present disclosure discovered bounding the relationships defined by the thrust to power airflow ratio and core bypass ratio can result in a gas turbine engine maintaining or even improving upon a desired propulsive efficiency, while also taking into account the gas turbine engine's packaging concerns and weight concerns, and also providing desired thermal management capabilities. The relationship discovered, infra, can identify an improved engine configuration suited for a particular mission requirement, one that takes into account installation, packaging and loading, thermal sink needs and other factors influencing the optimal choice for an engine configuration.

In addition to yielding an improved gas turbine engine, as explained in detail above, utilizing this relationship, the inventors found that the number of suitable or feasible gas turbine engine designs incorporating a primary fan and a secondary fan, and defining a third stream, capable of meeting both the propulsive efficiency requirements and packaging, weight, and thermal sink requirements could be greatly diminished, which facilitates a more rapid down selection of designs to consider as a gas turbine engine is being developed. Such a benefit provides more insight into the requirements for a given gas turbine engine well before specific technologies, integration and system requirements are developed fully. Such a benefit avoids late-stage redesign.

The desired relationships providing for the improved gas turbine engine, discovered by the inventors, are expressed as:

$$TPAR = ( {A}_{B} + {A}_{3 S} ) / {A}_{C} \qquad ( 1 )$$

$$CBR = {A}_{3 S} / {A}_{C} \qquad ( 2 )$$

where TPAR is a thrust to power airflow ratio, CBR is a core bypass ratio, A_{B} is an airflow through a bypass passage of the gas turbine engine while the engine is operated at a rated speed during standard day operating conditions, A_{3S} is an airflow through a third stream of the gas turbine engine while the engine is operated at the rated speed during standard day operating conditions, and A_{C} is an airflow through a core of the gas turbine engine while the engine is operated at the rated speed during standard day operating conditions. The airflow through the core of the gas turbine engine may refer to an airflow through an upstream end of the core (e.g., an airflow through a first stage of a high pressure compressor of the core). A_{B}, A_{3S}, and A_{C} are each expressed as mass flowrate, with the same units as one another.

Values for various parameters of the influencing characteristics of an engine defined by Expressions (1) and (2) are set forth below in TABLE 1:

TABLE 1

| | | Ranges appropriate for using |
|---|---|---|
| Symbol | Description | Expression (1) |
| R₁/R₃ | Tip radius ratio | 1.35 to 10, such as 2 to 7, such |
| | | as 3 to 5, such as at least 3.5, |
| | | such as at least 3.7, such as at |
| | | least 4, such as up to 10, such as |
| | | up to 7 |
| RqR_{Sec.-Fan} | Secondary fan radius | 0.2 to 0.9, such as 0.2 to 0.7, |
| | ratio | such as 0.57 to 0.67 |
| RqR_{Prim.- Fan} | Primary fan radius ratio | 0.2 to 0.4, such as 0.25 to 0.35 |
| TPAR | Thrust to power airflow | 3.5 to 100, such as 4 to 75 (see |
| | ratio | also, TABLE 2, below) |
| CBR | Core Bypass Ratio | 0.1 to 10, such as 0.3 to 5 (see |
| | | also, TABLE 2, below) |

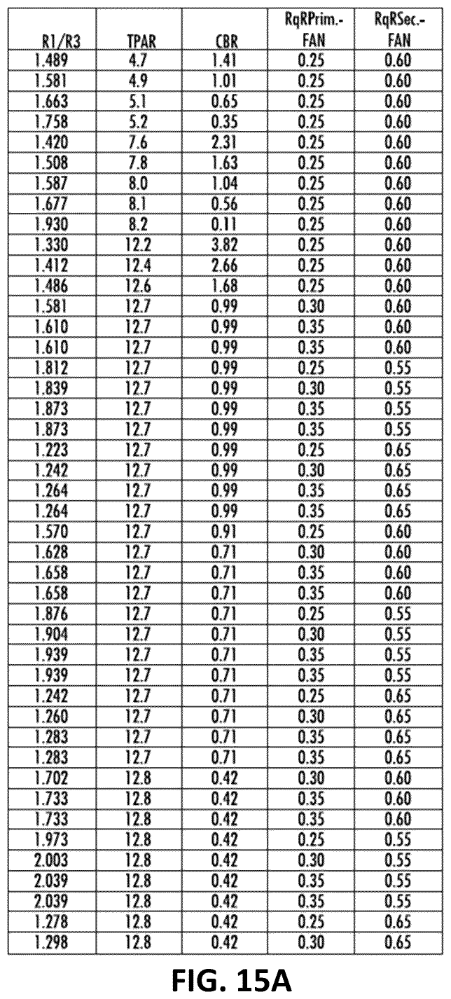

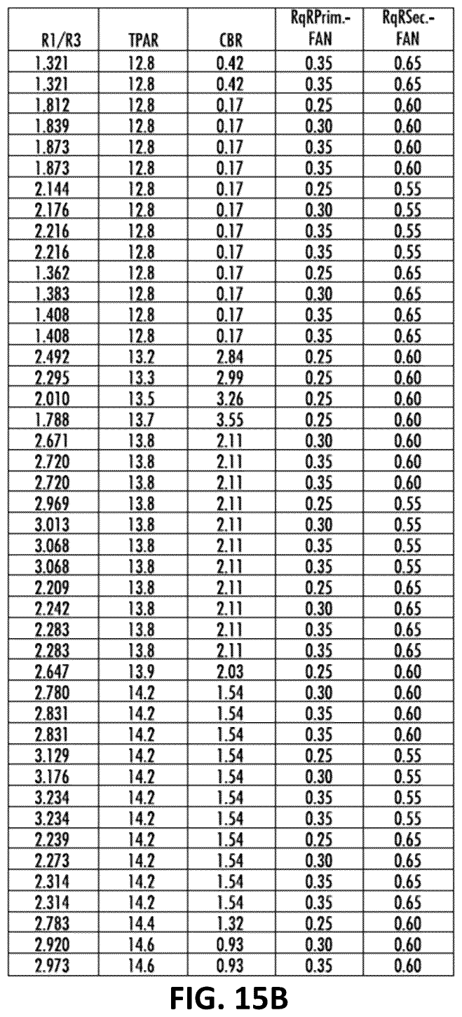

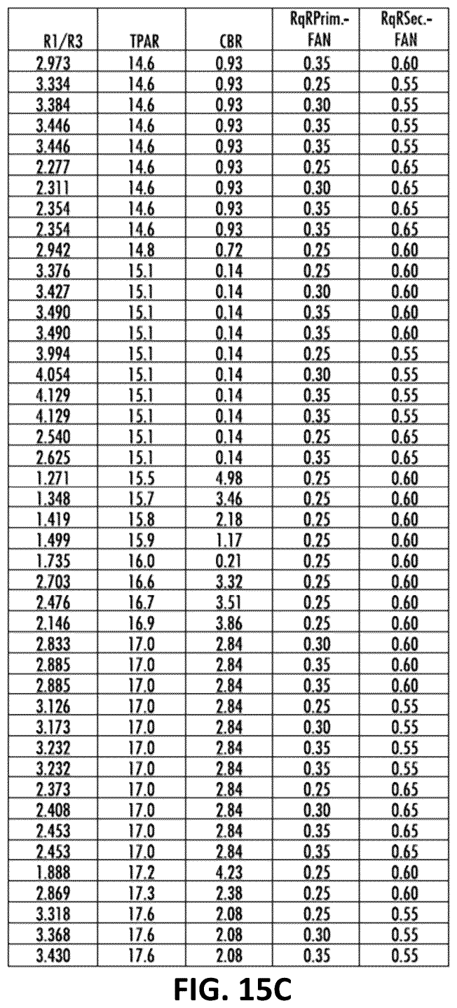

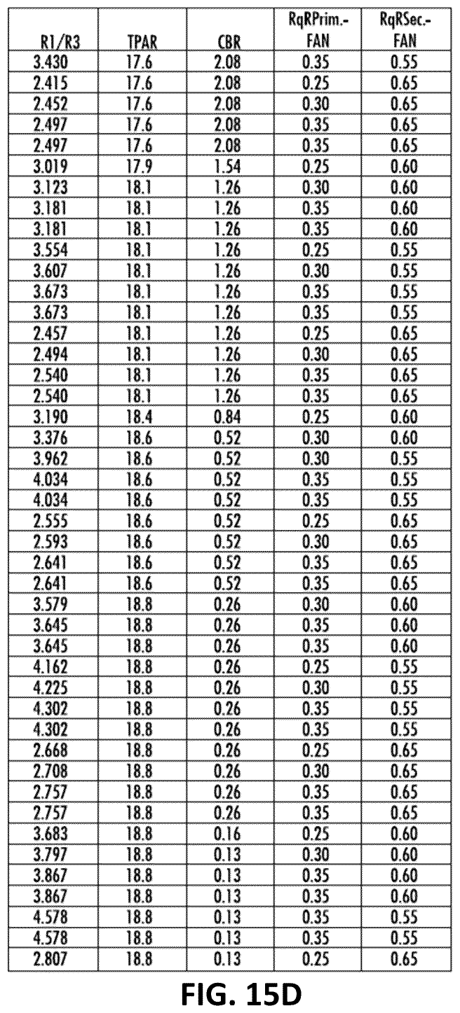

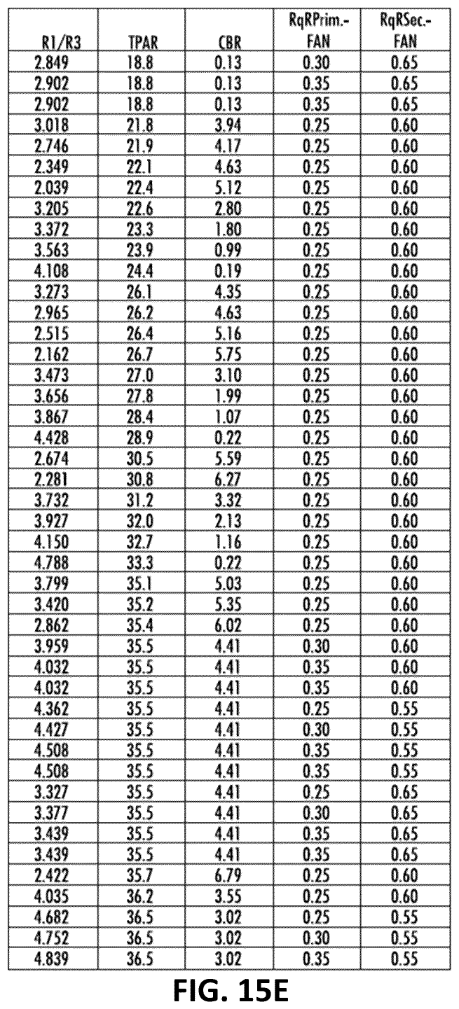

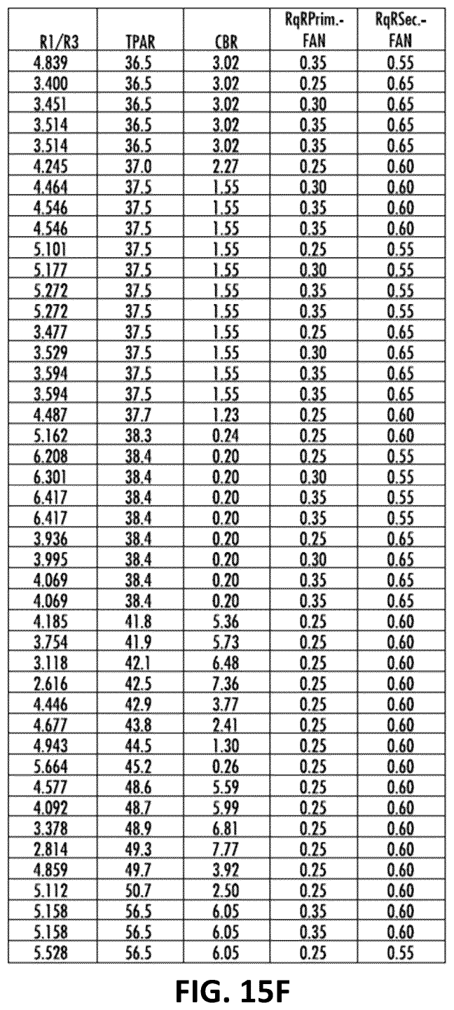

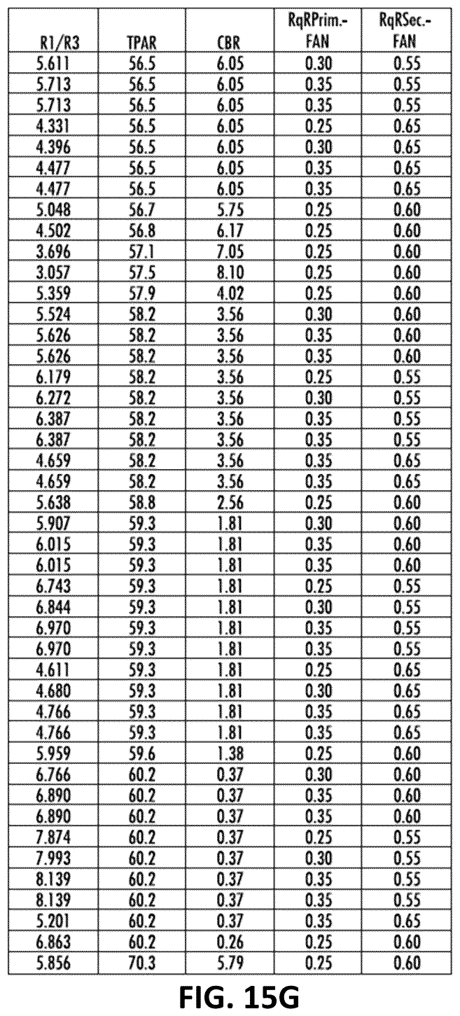

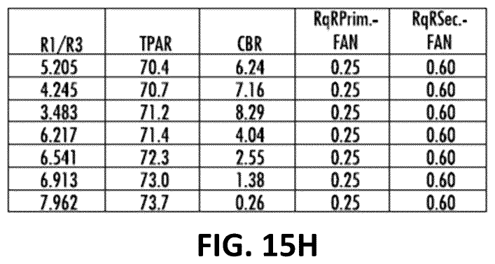

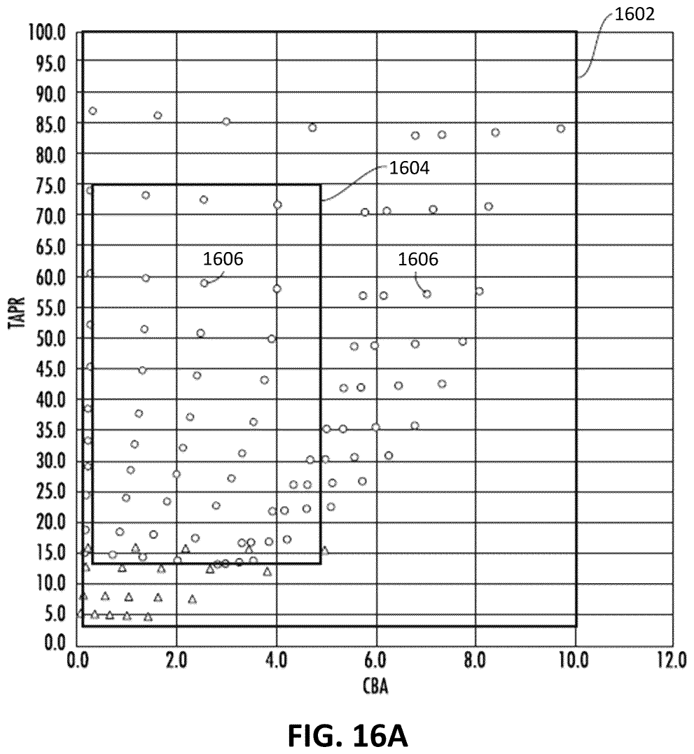

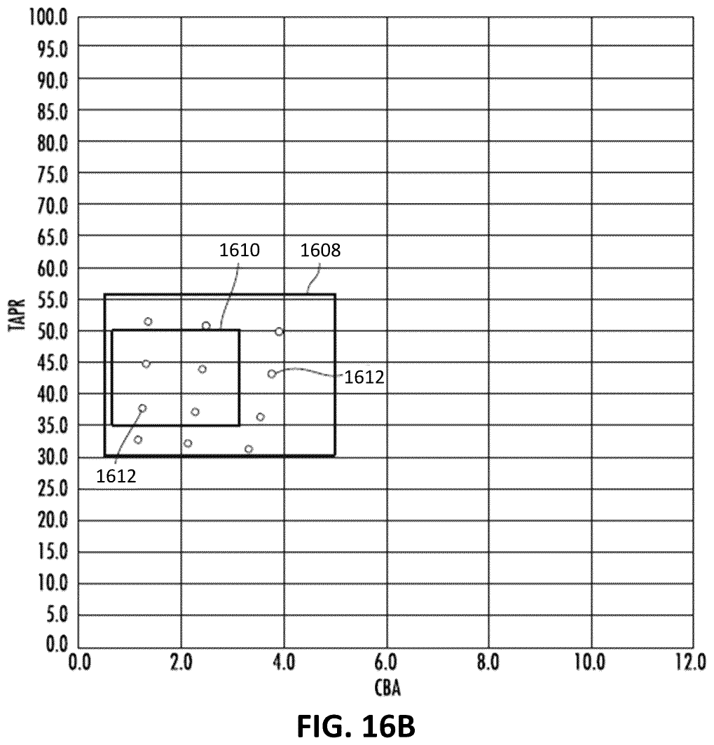

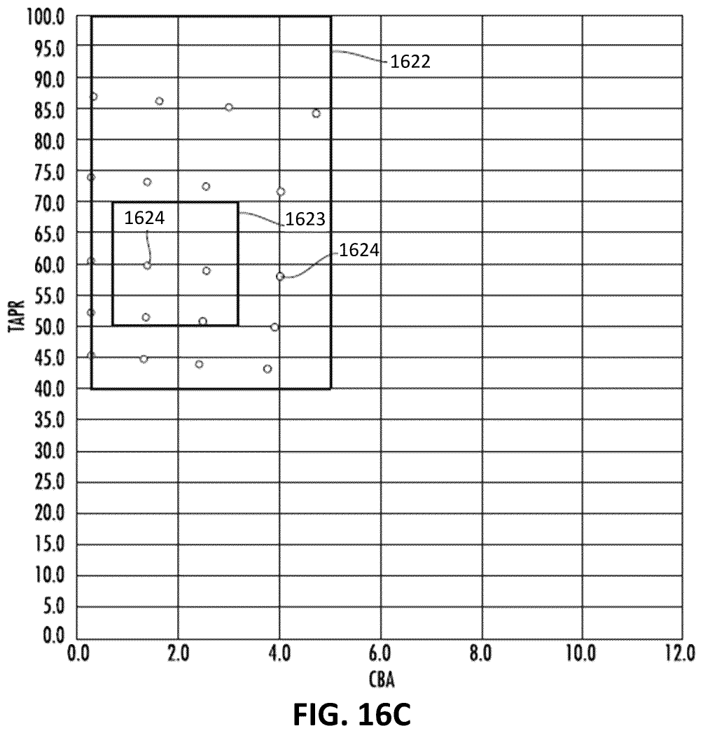

Referring now to FIGS. 15A through 15H and 16A through 16C, the relationships between the various parameters of Expressions (1) and (2) of exemplary gas turbine engines are illustrated in accordance with one or more exemplary embodiments of the present disclosure. In particular, FIGS. 15A through 15H provide a table including numerical values corresponding to several of the plotted gas turbine engines in FIGS. 16A through 16C. FIGS. 16A through 16C are plots of gas turbine engines in accordance with one or more exemplary embodiments of the present disclosure, showing the TPAR (Y-Axis) and the CBR (X-axis). FIGS. 16A through 16C highlight preferred subranges, including subranges for unducted engines and turboprop engines, as discussed hereinbelow.

Referring particularly to FIG. 16A, a first range 1602 and a second range 1604 are provided, and exemplary embodiments 1606 are plotted. The exemplary embodiments 1606 include a variety of gas turbine engine types in accordance with aspects of the present disclosure, including unducted gas turbine engines and turboprop engines. The first range 1602 corresponds to a TPAR between 3.5 and 100 and a CBR between 0.1 and 10. The first range 1602 captures the benefits of the present disclosure across the variety of engine types. The second range 1604 corresponds to a TPAR between 14 and 75 and a CBR between 0.3 and 5. The second range 1604 may provide more desirable TPAR and CBR relationships across the variety of engine types to achieve propulsive efficiency, while still providing packaging and weight benefits, thermal benefits, etc.

Referring particularly to FIG. 5B, a third range 1608 and a fourth range 1610 are provided, and exemplary embodiments 1612 are plotted. The exemplary embodiments 1612 include a variety of unducted gas turbine engines in accordance with aspects of the present disclosure. In particular, the exemplary embodiments 1612 include a variety of gas turbine engines having an unducted primary fan, similar to the exemplary embodiments described herein with reference to FIGS. 12 and 10. The third range 1608 corresponds to a TPAR between 30 and 56 and a CBR between 0.3 and 5. The third range 1608 captures the benefits of the present disclosure for unducted gas turbine engines. The fourth range 1610 corresponds to a TPAR between 35 and 50 and a CBR between 0.5 and 3. The fourth range 1610 may provide more desirable TPAR and CBR relationships for the unducted gas turbine engines to achieve propulsive efficiency, while still providing packaging and weight benefits, thermal benefits, etc.

As will be appreciated, the unducted gas turbine engines may have, on the whole, a higher TPAR as compared to the ducted gas turbine engines (see FIG. 5C), enabled by a lack of an outer nacelle or other casing surrounding a primary fan. The range of CBR values in the fourth range 1610 isn't as large as the range of CBR values in the third range 1608, as in the embodiments with a higher TPAR, the CBR needs to be lower to provide a necessary amount of airflow to a core of the engine without exceeding temperature thresholds or requiring an undesired reduction in a size of the primary fan.

The inventors of the present disclosure have found that the TPAR values and CBR values in the third and fourth ranges 1608, 1610 shown may provide a desirable propulsive benefit, while still enabling operation of the core in a reasonable manner, and balancing installation and thermal load considerations.

Referring particularly to FIG. 16C, a fifth range 1622 and a sixth range 1623 are provided, and exemplary embodiments 1624 are plotted. The exemplary embodiments 1624 include a variety of turboprop gas turbine engines in accordance with aspects of the present disclosure. In particular, the exemplary embodiments 1624 include a variety of turboprop gas turbine engine similar to the exemplary embodiment described herein with reference to FIG. 6. The fifth range 1622 corresponds to a TPAR between 40 and 100 and a CBR between 0.3 and 5. The fifth range 1622 captures the benefits of the present disclosure for turboprop gas turbine engines. The sixth range 1623 corresponds to a TPAR between 50 and 70 and a CBR between 0.5 and 3, and may represent a more preferrable range.

As will be appreciated, the turboprop gas turbine engines may have, on the whole, higher TPAR values than turbofan engines, enabled by the lack of an outer nacelle or other casing surrounding a primary fan and a relatively slow operational speed of the primary fan and aircraft incorporating the turboprop gas turbine engine. The range of CBR values in the fifth range 1622 and the sixth range 1623 may be relatively small, as less air may be provided through a third stream with such a high TPAR without compromising operation of a core of the gas turbine engine.

The inventors of the present disclosure have found that the TPAR values and CBR values in the fifth range 1622 and sixth range 1623 shown may provide a desirable propulsive benefit, while still enabling operation of the core in a reasonable manner, and balancing installation and thermal load considerations.

TABLE 2, below provides a summary of TPAR values and CBR values for various gas turbine engines in accordance with one or more exemplary aspects of the present disclosure.

TABLE 2

| Engine Type | TPAR Value | CBR Value |
|---|---|---|
| All Aeronautical Gas Turbine Engines | 3.5 to 100 | 0.1 to 10 |
| (“GTE”) | | |
| All Aeronautical GTE | 4 to 75 | 0.3 to 5 |
| Open Rotor GTE | 30 to 60 | 0.3 to 5 |
| Open Rotor GTE | 35 to 50 | 0.5 to 3 |
| Turboprop GTE | 40 to 100 | 0.3 to 5 |
| Turboprop GTE | 50 to 70 | 0.5 to 3 |

For the purposes of Table 2, “Open Rotor” refers to inclusion of an unducted primary fan (see, e.g., FIGS. 12, 10).

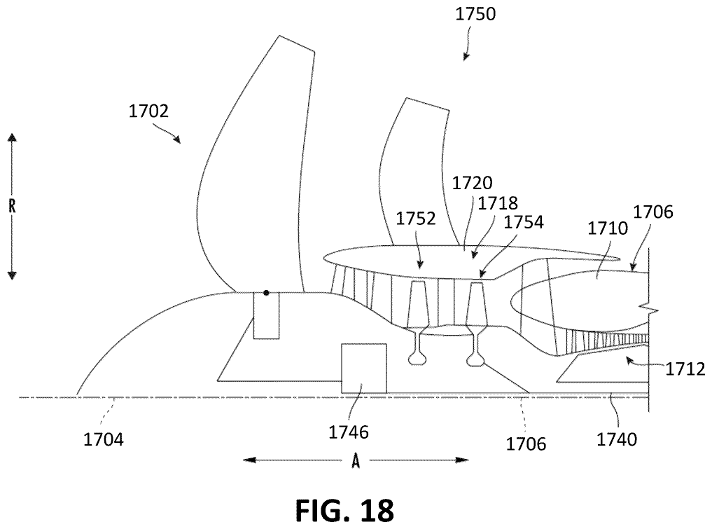

It will be appreciated that although the discussion above is generally relating to the open rotor engine 1200 described above with reference to FIGS. 12 and 13, in various embodiments of the present disclosure, the relationships outlined above with respect to, e.g., Expressions (1) and (2) may be applied to any other suitable engine architecture. For example, reference will now be made to FIGS. 17 and 18, each depicting schematically an engine architecture associated with the present disclosure.

The gas turbine engines of FIG. 6 generally includes a rotor 1702 rotatable about a rotor axis 1704 and a turbomachine 1706 rotatable about a longitudinal axis 1708. The rotor 1702 corresponds to the “primary fan” described herein. The turbomachine 1706 is surrounded at least in part by a core cowl 1710 and includes a compressor section 1712, a combustion section 1714, and a turbine section 1716 in serial flow order. In addition to the rotor 1702, the gas turbine engines of FIG. 6 also includes a ducted mid-fan or secondary fan 1718. The gas turbine engines each include a fan cowl 1720 surrounding the secondary fan 1718.

Referring still to the gas turbine engines of FIGS. 17 and 18, the gas turbine engines each also define a bypass passage 1722 downstream of the respective rotor 1702 and over the respective fan cowl 1720 and core cowl 1710, and further define a third stream 1724 extending from a location downstream of the respective secondary fan 1718 to the respective bypass passage 1722 (at least in the embodiments depicted; in other embodiments, the third stream 1724 may instead extend to a location downstream of the bypass passage 1722).

Referring particularly to FIG. 17, the exemplary gas turbine engine depicted is configured as a turboprop engine 1726. In such a manner, the rotor 1702 (or primary fan) is configured as a propeller, defining a relatively large diameter. Further, the turboprop engine 1726 includes an engine shaft 1728 driven by the turbomachine 1706, a fan shaft 1730 rotatable with the rotor 1702, and a gearbox 1732 mechanically coupling the engine shaft 1728 with the fan shaft 1730. The gearbox 1732 is an offset gearbox such that the rotor axis 1704 is radially offset from the longitudinal axis 1708 of the turboprop engine 1726.

Notably, in other embodiments of the present disclosure, a turboprop engine may be provided with a reverse flow combustor.

Moreover, in other exemplary embodiments, other suitable gas turbine engines may be provided. For example, referring now to FIG. 18, a gas turbine engine in accordance with yet another exemplary embodiment of the present disclosure is provided. The exemplary gas turbine engine of FIG. 18 may be configured in a similar manner as the exemplary gas turbine engine described above with reference to FIG. 17.

For example, the exemplary gas turbine engine of FIG. 18 includes a rotor 1702 rotatable about a rotor axis 1704 and a turbomachine 1706 rotatable about a longitudinal axis 1708. The rotor axis 1704 and the longitudinal axis 1708 are aligned in the embodiment of FIG. 18. The rotor 1702 corresponds to the “primary fan” described herein. The turbomachine 1706 is surrounded at least in part by a core cowl 1710 and includes a compressor section 1712 (and, not shown, a combustion section and a turbine section in serial flow order with the compressor section 1712). In addition to the rotor 1702, the gas turbine engine also includes a ducted mid-fan or secondary fan 1718 and a fan cowl 1720 surrounding the secondary fan 1718.

However, for the embodiment of FIG. 18, the gas turbine engine is configured as an unducted gas turbine engine 1750 (see, e.g., FIG. 12), and the secondary fan 1718 is not configured as a single stage fan (see fan 1284 of FIG. 12). Instead, for the embodiment of FIG. 18, the secondary fan 1718 is configured as a multi-stage secondary fan, and more specifically still as a two-stage secondary fan having a total of two stages of rotating compressor rotor blades, and more specifically having a first stage 1752 of secondary fan rotor blades and a second stage 1754 of secondary fan rotor blades. Notably, with such a configuration, the turbomachine 1706 does not include a separate low pressure compressor.

Further, it will be appreciated that in at least certain exemplary embodiments of the present disclosure, a method of operating a gas turbine engine is provided. The method may be utilized with one or more of the exemplary gas turbine engines discussed herein, such as in FIGS. 12 through 18. The method includes operating the gas turbine engine at a rated speed, wherein operating the gas turbine engine at the rated speed comprises operating the gas turbine engine to define a thrust to power airflow ratio between 3.5 and 100 and a core bypass ratio between 0.1 and 5. For the exemplary method, the thrust to power airflow ratio is a ratio of an airflow through a bypass passage over a turbomachine of the gas turbine engine plus an airflow through a fan duct to an airflow through a core duct, and the core bypass ratio is a ratio of the airflow through the fan duct to the airflow through the core duct.

As will be appreciated from the description herein, various embodiments of a gas turbine engine are provided. Certain of these embodiments may be an unducted, single rotor gas turbine engine (see FIGS. 12 and 2), or a turboprop engine (see FIG. 17. Various additional aspects of one or more of these embodiments are discussed below. These exemplary aspects may be combined with one or more of the exemplary gas turbine engine(s) discussed above with respect to the figures.

For example, in some embodiments of the present disclosure, the engine may include a heat exchanger located in an annular duct, such as in a third stream. The heat exchanger may extend substantially continuously in a circumferential direction of the gas turbine engine (e.g., at least 300 degrees, such as at least 330 degrees).

In one or more of these embodiments, a threshold power or disk loading for a fan (e.g., an unducted single rotor or primary forward fan) may range from 25 horsepower per square foot (hp/ft²) or greater at cruise altitude during a cruise operating mode. In particular embodiments of the engine, structures and methods provided herein generate power loading between 80 hp/ft² and 160 hp/ft² or higher at cruise altitude during a cruise operating mode.

In various embodiments, an engine of the present disclosure is applied to a vehicle with a cruise altitude up to approximately 65,000 ft. In certain embodiments, cruise altitude is between approximately 28,000 ft and approximately 45,000 ft. In still certain embodiments, cruise altitude is expressed in flight levels based on a standard air pressure at sea level, in which a cruise flight condition is between FL280 and FL650. In another embodiment, cruise flight condition is between FL280 and FL450. In still certain embodiments, cruise altitude is defined based at least on a barometric pressure, in which cruise altitude is between approximately 4.85 psia and approximately 0.82 psia based on a sea level pressure of approximately 14.70 psia and sea level temperature at approximately 59 degrees Fahrenheit. In another embodiment, cruise altitude is between approximately 4.85 psia and approximately 2.14 psia. It should be appreciated that in certain embodiments, the ranges of cruise altitude defined by pressure may be adjusted based on a different reference sea level pressure and/or sea level temperature.

As such, it will be appreciated that an engine of such a configuration may be configured to generate at least 25,000 pounds and less than 80,000 of thrust during operation at a rated speed, such as between 25,000 and 50,000 pounds of thrust during operation at a rated speed, such as between 25,000 and 40,000 pounds of thrust during operation at a rated speed. Alternatively, in other exemplary aspects, an engine of the present disclosure may be configured to generate much less power, such as at least 2,000 pounds of thrust during operation at a rated speed.

In various exemplary embodiments, the fan (or rotor) may include twelve (12) fan blades. From a loading standpoint, such a blade count may allow a span of each blade to be reduced such that the overall diameter of the primary fan may also be reduced (e.g., to twelve feet in one exemplary embodiment). That said, in other embodiments, the fan may have any suitable blade count and any suitable diameter. In certain suitable embodiments, the fan includes at least eight (8) blades. In another suitable embodiment, the fan may have at least twelve (12) blades. In yet another suitable embodiment, the fan may have at least fifteen (15) blades. In yet another suitable embodiment, the fan may have at least eighteen (18) blades. In one or more of these embodiments, the fan includes twenty-six (26) or fewer blades, such as twenty (20) or fewer blades. Alternatively, in certain suitable embodiments, the fan may only include at least four (4) blades, such as with a fan of a turboprop engine.

Further, in certain exemplary embodiments, the rotor assembly may define a rotor diameter (or fan diameter) of at least 10 feet, such as at least 11 feet, such as at least 12 feet, such as at least 13 feet, such as at least 15 feet, such as at least 17 feet, such as up to 28 feet, such as up to 26 feet, such as up to 24 feet, such as up to 18 feet.

In various embodiments, it will be appreciated that the engine includes a ratio of a quantity of vanes to a quantity of blades that could be less than, equal to, or greater than 1:1. For example, in particular embodiments, the engine includes twelve (12) fan blades and ten (10) vanes. In other embodiments, the vane assembly includes a greater quantity of vanes to fan blades. For example, in particular embodiments, the engine includes ten (10) fan blades and twenty-three (23) vanes. For example, in certain embodiments, the engine may include a ratio of a quantity of vanes to a quantity of blades between 1:2 and 5:2. The ratio may be tuned based on a variety of factors including a size of the vanes to ensure a desired amount of swirl is removed for an airflow from the primary fan.

Additionally, in certain exemplary embodiments, where the engine includes the third stream and a mid-fan (a ducted fan aft of the primary, forward fan; also referred to herein as a secondary fan), a ratio R1/R2 may be between 1 and 10, or 2 and 7, or at least 3.3, at least 3.5, at least 4 and less than or equal to 7, where R1 is the radius of the primary fan and R2 is the radius of the mid-fan.

It should be appreciated that various embodiments of the engine, such as the single unducted rotor engine depicted and described herein, may allow for normal subsonic aircraft cruise altitude operation at or above Mach 0.5. In certain embodiments, the engine allows for normal aircraft operation between Mach 0.55 and Mach 0.85 at cruise altitude. In still particular embodiments, the engine allows for normal aircraft operation between Mach 0.75 and Mach 0.85. In certain embodiments, the engine allows for rotor blade tip speeds at or less than 750 feet per second (fps). In other embodiments, the rotor blade tip speed at a cruise flight condition can be 650 to 900 fps, or 700 to 800 fps. Alternatively, in certain suitable embodiments, the engine allows for normal aircraft operation of at least Mach 0.3, such as with turboprop engines.

A fan pressure ratio (FPR) for the primary fan of the fan assembly can be 1.04 to 2.20, or in some embodiments 1.05 to 1.2, or in some embodiments less than 1.08, as measured across the fan blades of the primary fan at a cruise flight condition.

In order for the gas turbine engine to operate with a fan having the above characteristics to define the above FPR, a gear assembly may be provided to reduce a rotational speed of the fan assembly relative to a driving shaft (such as a low pressure shaft coupled to a low pressure turbine). In some embodiments, a gear ratio of the input rotational speed to the output rotational speed is between 3.0 and 4.0, between 3.2 and 3.5, or between 3.5 and 4.5. In some embodiments, a gear ratio of the input rotational speed to the output rotational speed is greater than 4.1. For example, in particular embodiments, the gear ratio is within a range of 4.0 to 4.5, within a range of 4.1 to 14.0, within a range of 4.5 to 14.0, or within a range of 6.0 to 14.0. In certain embodiments, the gear ratio is within a range of 4.5 to 12 or within a range of 6.0 to 11.0.

With respect to a turbomachine of the gas turbine engine, the compressors and/or turbines can include various stage counts. As disclosed herein, the stage count includes the number of rotors or blade stages in a particular component (e.g., a compressor or turbine). For example, in some embodiments, a low pressure compressor may include 1 to 8 stages, a high-pressure compressor may include 4 to 15 stages, a high-pressure turbine may include 1 to 2 stages, and/or a low pressure turbine (LPT) may include 1 to 7 stages. In particular, the LPT may have 4 stages, or between 4 and 7 stages. For example, in certain embodiments, an engine may include a one stage low pressure compressor, an 11 stage high pressure compressor, a two stage high pressure turbine, and 4 stages, or between 4 and 7 stages for the LPT. As another example, an engine can include a three stage low-pressure compressor, a 10 stage high pressure compressor, a two stage high pressure turbine, and a 7 stage low pressure turbine.

A core engine is generally encased in an outer casing defining one half of a core diameter (Dcore), which may be thought of as the maximum extent from a centerline axis (datum for R). In certain embodiments, the engine includes a length (L) from a longitudinally (or axial) forward end to a longitudinally aft end. In various embodiments, the engine defines a ratio of L/Dcore that provides for reduced installed drag. In one embodiment, L/Dcore is at least 2. In another embodiment, L/Dcore is at least 2.5. In some embodiments, the L/Dcore is less than 5, less than 4, and less than 3. In various embodiments, it should be appreciated that the L/Dcore is for a single unducted rotor engine.

The reduced installed drag may further provide for improved efficiency, such as improved specific fuel consumption. Additionally, or alternatively, the reduced installed drag may provide for cruise altitude engine and aircraft operation at the above describe Mach numbers at cruise altitude. Still particular embodiments may provide such benefits with reduced interaction noise between the blade assembly and the vane assembly and/or decreased overall noise generated by the engine by virtue of structures located in an annular duct of the engine.

Additionally, it should be appreciated that ranges of power loading and/or rotor blade tip speed may correspond to certain structures, core sizes, thrust outputs, etc., or other structures of the core engine. However, as previously stated, to the extent one or more structures provided herein may be known in the art, it should be appreciated that the present disclosure may include combinations of structures not previously known to combine, at least for reasons based in part on conflicting benefits versus losses, desired modes of operation, or other forms of teaching away in the art.

Although depicted above as an unshrouded or open rotor engine in the embodiments depicted above, it should be appreciated that aspects of the disclosure provided herein may be applied to aft-fan engines, or other gas turbine engine configurations, including those for marine, industrial, or aero-propulsion systems. Certain aspects of the disclosure may be applicable to turboprop or turboshaft engines. It should be appreciated that certain aspects of the disclosure may address issues that may be particular to unshrouded or open rotor engines, such as, but not limited to, issues related to gear ratios, fan diameter, fan speed, length (L) of the engine, maximum diameter of the core engine (Dcore) of the engine, L/Dcore of the engine, desired cruise altitude, and/or desired operating cruise speed, or combinations thereof.

In an extension of the concepts disclosed hereinabove, also provided herein is a gas turbine engine having a turbomachine, a primary fan driven by the turbomachine, a secondary fan downstream of the primary fan within an inlet duct of the turbomachine, and a booster. The booster is located downstream of the secondary fan and includes a booster rotor blade and booster cowl. The booster cowl is located outward of the booster rotor blade and at least partially within a fan duct of the turbomachine at a fan duct inlet. The booster cowl separates an upstream portion of the fan duct into an upper fan duct having an upper fan duct inlet and a lower fan duct having a lower fan duct inlet. The upper fan duct inlet and lower fan duct inlet collectively form the fan duct inlet.

Such a configuration may allow for a desirable range of airflow through the fan duct in a variety of operating conditions of the gas turbine engine. In particular, it is desirable to have the upper fan duct inlet and lower fan duct inlet (collectively forming the fan duct inlet) sized to provide a thrust to power airflow ratio (TPAR) and a core bypass ratio (CBR) within the ranges set forth above to achieve a gas turbine engine maintaining or even improving upon a desired propulsive efficiency, while also taking into account the gas turbine engine's packaging concerns and weight concerns, and also providing desired thermal management capabilities for, e.g., a heat exchanger in the fan duct. Notably, inclusion of the booster having the booster cowl with the booster rotor blade located inward of the booster cowl (and upstream of the lower fan duct inlet) may allow for the fan duct to provide additional thermal management benefits and thrust benefits by virtue of an increase in a total pressure of the airflow through the fan duct. For example, with a higher total pressure, the airflow through the fan duct may accommodate a heat exchanger designed to have a higher pressure drop (and thus increased heat transfer capabilities), may provide increased thrust, etc.

The inventors of the present disclosure found that inclusion of the booster as set forth herein and bounding the relationships defined by the TPAR and CBR can result in a gas turbine engine maintaining or even improving upon a desired propulsive efficiency, while also taking into account the gas turbine engine's packaging concerns and weight concerns, and also providing desired thermal management and/or thrust capabilities.

Moreover, the inventors discovered, unexpectedly, in the course of designing the gas turbine engine having the booster with the booster cowl separating the upstream portion of the fan duct into the upper fan duct having the upper fan duct inlet and the lower fan duct having the lower fan duct inlet, that an operability of the core and efficiency of the fan duct operations can be improved through the design of upper fan duct inlet, the lower fan duct inlet, and a core inlet. In particular, the inventors discovered during the course of designing several gas turbine engines having such a booster and booster cowl (including the configurations illustrated and described in detail herein), a relationship exists among the TPAR, an airflow through the lower fan duct inlet, A_{3S_Lower}, and an airflow through the core, A_{C}, of the gas turbine engine while the engine is operated at the rated speed during standard day operating conditions, such that including a booter and booster cowl in accordance with one or more of the exemplary aspects described herein results in a net benefit to the overall engine design.

With a goal of arriving at an improved gas turbine engine capable of providing an improved operability of the core and efficiency of the fan duct operations, the inventors proceeded in the manner of designing gas turbine engines having a booster with various TPAR, A_{3S_Lower}, and A_{C}; checking an operability and efficiency of the fan duct operations of the designed gas turbine engines; redesigning the gas turbine engines to vary the noted parameters based on the impact on other aspects of the gas turbine engines; and rechecking the operability and efficiency of the fan duct operations of the redesigned gas turbine engines; etc., which are described below in greater detail.

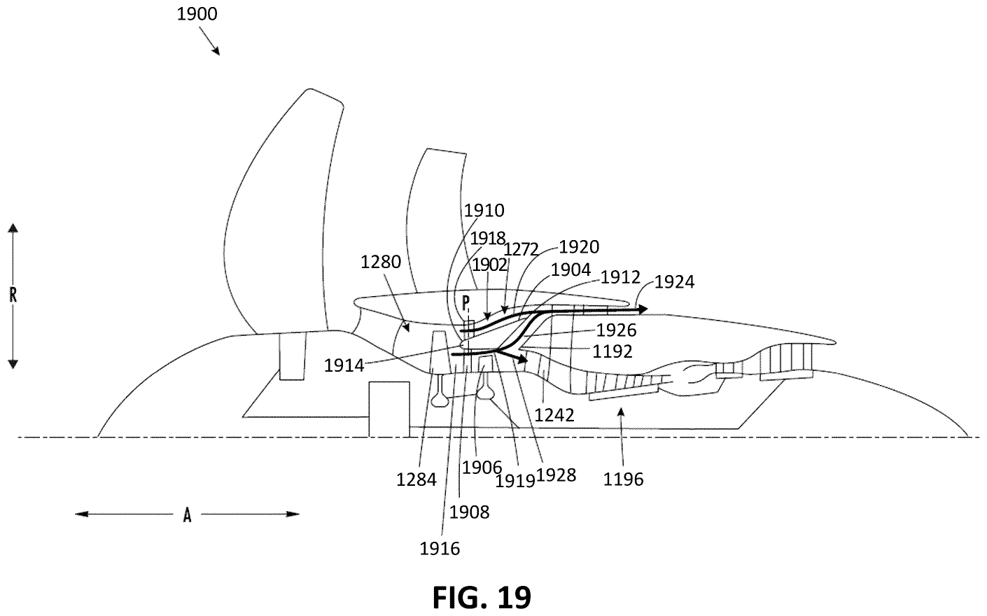

As will be appreciated from the embodiments of FIGS. 19 through 35, various embodiments can include a booster to further control flow in the fan duct and the core duct. A typical multi-stage booster may provide an excessive pressure ratio for lower thrust requirements. Space constraints within the envelope of the engine further limit operation of such a multi-stage booster.

For high bypass turbofan configurations, a single stage booster (sometimes referred to as a “quarter-stage booster”) may be useful for these lower thrust requirements. In particular, a single row booster stage with a portion of air bypassing the core and exiting into the fan stream allows the use of a high pressure core at different thrust class levels. This single stage booster allows the flow to self-correct at different engine operating conditions, reducing or eliminating the need for other active operability control systems, such as variable bleed valves. The booster can be integrally attached to a vaned fan frame, reducing the need for additional structure and fitting within the envelope with minimal change to common core hardware.

In particular, air flow in the fan duct may be split by the booster into an outer stream and an inner stream. The outer stream flows into the fan duct as a first fan stream, and the core cowl splits the inner stream into a second fan stream flowing into the fan duct and a core stream flowing into the core duct. Because the booster can control the amount of air of the second fan stream and the core stream, the booster controls the amount of air flowing in the fan duct and flowing in the core duct. Because the TPAR and the CBR depend on the relative amounts of the air flowing in the fan duct and into the core duct, the booster can play a role in adjusting these ratios.

Now referring to FIG. 19, a cross-sectional view of a gas turbine engine 1900 is shown. As described above, the gas turbine engine 1900 includes an inlet duct 1280, a fan duct 1272, and a core duct 1242. The inlet duct 1280 houses a ducted fan 1284 that provides a stream of air to the fan duct 1272 and the core duct 1242. The inlet duct 1280 extends in the radial direction R inward from a fan cowl 1270. The core duct 1242 is directs a portion of the stream to a compressor, such as the LP compressor 1226 described above; the portion intended for the core duct 1242 is a “core stream.” The remaining portion of the stream flows into the fan duct 1272, and this portion is a “fan stream.”

The gas turbine engine 1900 includes a booster 1902 disposed in the inlet duct 1280 and the fan duct 1272. The booster 1902 includes a booster cowl 1904, a booster rotor blade 1906, and an inlet guide vane 1908. The booster cowl 1904 supports the other components of the booster 1902. Specifically, the booster cowl 1904 is integrally attached to the fan cowl 1270, a core cowl 1222, or both, with a suitable attachment such as a strut. The booster cowl 1904 extends from leading edge 1910 to a trailing edge 1912, and the booster cowl 1904 may include a flow splitter 1914 at the leading edge 1910. The leading edge 1910 of the booster cowl 1904 is disposed in the inlet duct 1280 upstream of the core cowl 1222, and the trailing edge 1912 of the booster cowl 1904 is disposed the fan duct 1272.

The booster rotor blade 1906 is disposed upstream of the core cowl 1222 and inward in the radial direction R from the booster cowl 1904. More specifically, the booster cowl 1904 defines a booster passage 1916, and the booster rotor blade 1906 is disposed in the booster passage 1916. The booster rotor blade 1906 provides additional power to air in the booster passage 1916, increasing a temperature, a pressure, or both, of the air. The air is thus “boosted” by the booster rotor blade 1906.

The inlet guide vane 1908 is disposed in the booster passage 1916 upstream of the booster rotor blade 1906 and the core cowl 1222 and downstream of the leading edge 1910 of the booster cowl 1904. Specifically, the inlet guide vane 1908 extends inward in the radial direction R from the booster cowl 1904. The inlet guide vane 1908 directs air to the booster rotor blade 1906. As described above with respect to the inlet guide vanes 1286, the inlet guide vane 1908 may be rotatable about a pitch axis P to a specified pitch angle, i.e., an angle defined between the longitudinal axis 1212 and a chord extending from a leading edge of the inlet guide vane 1908 to a trailing edge of the inlet guide vane 1908. That is, the booster 1902 may include an actuator 1918 supported by the fan cowl 1270 that is configured to rotate the inlet guide vane 1908 to the specified pitch angle. Alternatively, the inlet guide vane 1908 may be fixed to a specified pitch angle.

During operation, the booster 1902 is configured to separate the stream of air between an outer stream 1920 and an inner stream 1922. Specifically, the flow splitter 1914 at the leading edge 1910 of the booster cowl 1904 separates the stream such that the outer stream 1920 flows outward of the booster cowl 1904 in the radial direction R and the inner stream 1922 flows inward of the booster cowl 1904 in the radial direction R. The outer stream 1920 flows into a fan duct inlet 1276, and the outer stream 1920 may become a first fan stream 1924.

The inner stream 1922 flows in the booster passage 1916, boosted by the booster rotor blade 1906, toward a core inlet 1224 of the core duct 1242. The core cowl 1222 is arranged to separate the inner stream 1922 into a second fan stream 1926 flowing into the fan duct inlet 1276 and the core stream 1928 flowing into the core inlet 1224. Specifically, the core cowl 1222 may include a core flow splitter 1930 that is arranged to separate the inner stream 1922 into the second fan stream 1926 and the core stream 1928. As described above, the core stream 1928 flows through the core duct 1242 to a compressor, such as the LP compressor 1226.

The first fan stream 1924 and the second fan stream 1926 may merge at a merging zone 1932 downstream of the booster in the fan duct 1272 to form a unified fan stream 1934. Because the second fan stream 1926 has a higher temperature, air pressure, or both than the first fan stream 1924, merging the first fan stream 1924 and the second fan stream 1926 provides the unified fan stream 1934 with more power than an unboosted stream while maintaining substantially uniform properties for the unified fan stream 1934.

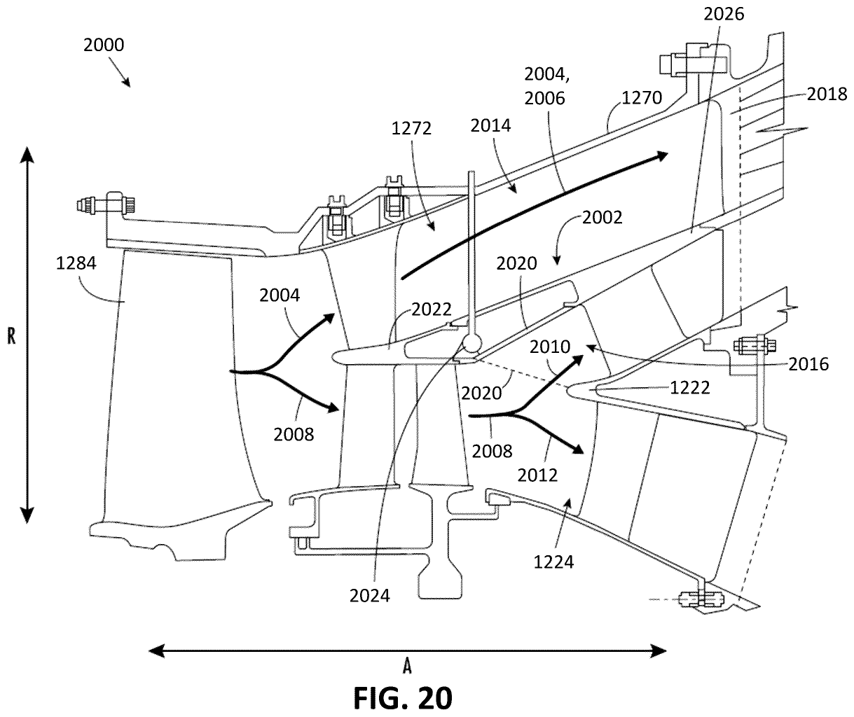

Now referring to FIG. 20, a cross-sectional view of a gas turbine engine 2000 with a booster 2002 is shown. As described above, the booster 2002 separates a stream of air between an outer stream 2004 (that becomes a first fan stream 2006) and an inner stream 2008, and the inner stream 2008 is separated by a core cowl 1222 between a second fan stream 2010 and a core stream 2012. The fan duct inlet 1276 of the fan duct 1272 may include an upper fan duct 2014 through which the first fan stream 2006 flows and a lower fan duct 2016 through which the second fan stream 2010 flows. The booster 2002 may extend to a wall 2018 in the fan duct 1272 to separate the upper fan duct 2014 from the lower fan duct 2016, reducing or inhibiting merging of the first fan stream 2006 and the second fan stream 2010.

Alternatively, not shown in FIG. 20, the booster 2002 may end prior to reaching the wall 2018. In such a form, the fan duct 1272 may include a merging zone in which the first fan stream 2006 merges with the second fan stream 2010.

In certain operations, the second fan stream 2010 may be unnecessary, and the entire inner stream 2008 should flow into the core inlet 1224 as the core stream 2012. To redirect the inner stream 2008 entirely into the core inlet 1224, the gas turbine engine 2000 may include a flow blocker 2020 that blocks at least a portion of the second fan stream 2010, directing the air into the core inlet 1224. The flow blocker 2020 is movable from an open position that allows the second fan stream 2010 to enter the fan duct 1272 at the lower fan duct 2016 and a closed position that blocks the lower fan duct 2016. In FIG. 20, the flow blocker 2020 in the open position is shown in a solid outline and the flow blocker 2020 in the closed position is shown in a dashed outline. The flow blocker 2020 extends from a booster cowl 2022 of the booster 2002 across the lower fan duct 2016 to the core cowl 1222 in the closed position. More specifically, the flow blocker 2020 is a door hingedly supported by the booster cowl 2022 that rotates to the core cowl 1222. The flow blocker 2020 may include a plurality of overlapping panels forming an annular door that extends across the lower fan duct 2016.

An actuator 2024 rotates the flow blocker 2020 between the open position and the closed position. The actuator 2024 may be supported by a fan cowl 1270 and may extend inward in the radial direction R to the flow blocker 2020. The actuator 2024 may be any suitable type, such as a cam actuator.

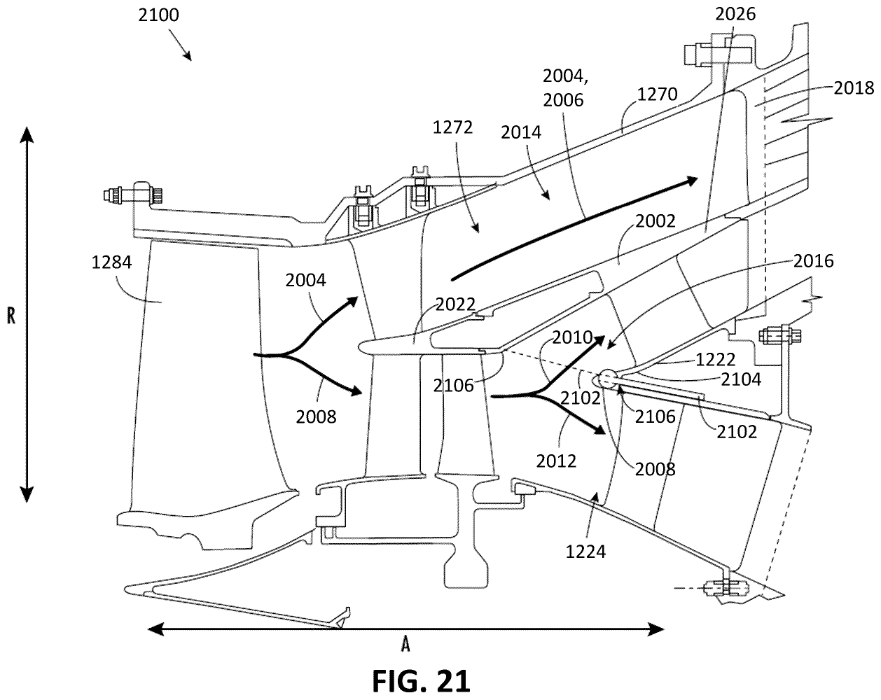

With reference to FIG. 21, a cross-sectional view of a gas turbine engine 2100 with another flow blocker 2102 is shown. It will be appreciated that components in FIG. 21 that are similar in structure or function to those of FIG. 20 will share a same numeral.

The flow blocker 2102 of FIG. 21 is a door that is slidably supported by the core cowl 1222. That is, the core cowl 1222 defines a slot 2104, and the flow blocker 2102 is slidable out of the slot 2104 to the booster cowl 2022, blocking the lower fan duct 2016. When the door is in the open position, shown in a solid outline, the flow blocker 2102 is entirely within the core cowl 1222 such that a forward end 2106 of the door is disposed in the slot 2104. An actuator 2108, supported by the core cowl 1222, slides the flow blocker 2102 out of the slot 2104 to the closed position, shown in a dashed outline, to block the second fan stream 2010. The door may include a plurality of overlapping panels forming an annular door that extends across the lower fan duct 2016.

Alternatively, not shown in the FIGS., the flow blocker 2102 may be slidably supported by the booster cowl 2022. An actuator (not shown) supported by the booster cowl 2022 may extend the flow blocker 2102 across the lower fan duct 2016 to block the second fan stream 2010.

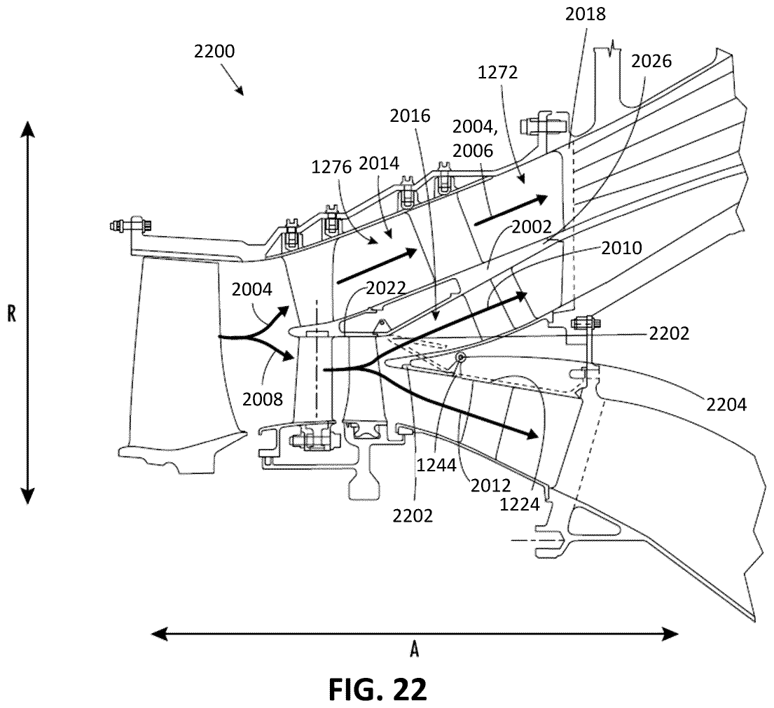

Now referring to FIG. 22, a cross-sectional view of a gas turbine engine 2200 with a flow blocker 2202 is shown. It will be appreciated that components in FIG. 22 that are similar in structure or function to those of FIGS. 20-21 will share a same numeral.

The flow blocker 2202 is a core flow splitter disposed at a leading edge 1244 of the core cowl 1222. When the flow blocker 2202 is in the open position, shown in a solid outline, the second fan stream 2010 flows through the lower fan duct 2016 into the fan duct 1272. When the flow blocker 2202 is in the closed position, the flow blocker 2202 extends across the lower fan duct 2016 from the leading edge 1244 to a booster cowl 2022 of a booster 2002, closing the lower fan duct 2016 and blocking the second fan stream 2010. More specifically, the flow blocker 2202 is rotatable such that a forward end of the flow blocker 2202 contacts the booster cowl 2022, closing the lower fan duct 2016 of the fan duct inlet 1276. An actuator 2204, supported by the core cowl 1222, may rotate the flow blocker 2202 between the open position and the closed position.

Still referring to FIGS. 20-22, the booster cowl 2022 includes an extension 2026 arranged to maintain separation of the first fan stream 2006 from the second fan stream 2010 in the fan duct 1272. In such a form, the first fan stream 2006 and the second fan stream 2010 remain separated through the fan duct 1272, and the second fan stream 2010 acts as a fourth stream. To maintain the separation, the fan duct 1272 includes the wall 2018 disposed downstream from the fan duct inlet 1276 and extending in the radial direction R through the fan duct 1272. The extension 2026 of the booster cowl 2022 extends to the wall 2018 to maintain the separation of the first fan stream 2006 and the second fan stream 2010 in the fan duct 1272. Because the second fan stream 2010 is boosted and the first fan stream 2006 is unboosted, maintaining separation of the first fan stream 2006 and the second fan stream 2010 allows for specific use of either the unboosted first fan stream 2006 or the boosted second fan stream 2010 for operation downstream of the booster 2002. That is, in certain operating conditions, the higher pressure, temperature, or both of the boosted second fan stream 2010 may be useful for specific operations, and the lower pressure, temperature, or both of the unboosted first fan stream 2006 may be useful for other operations.

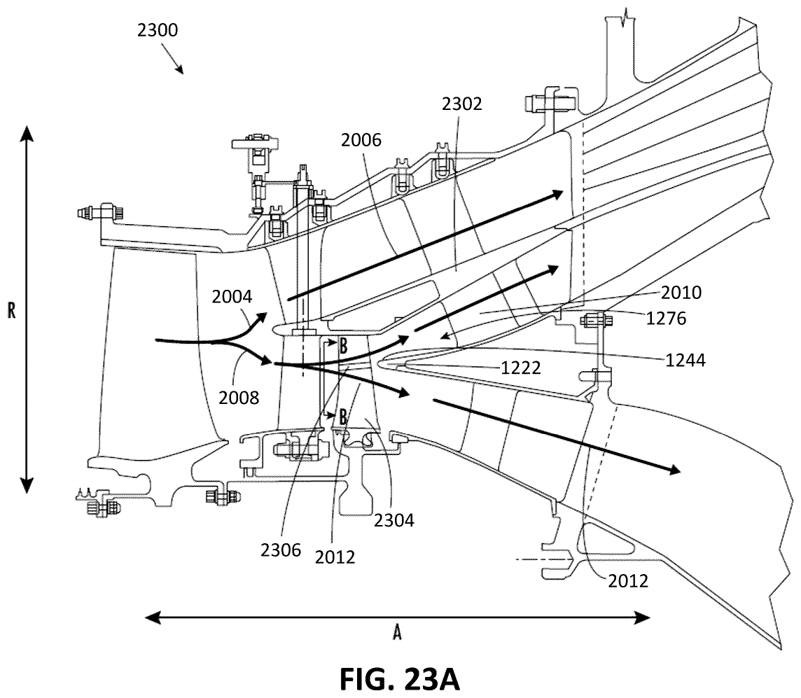

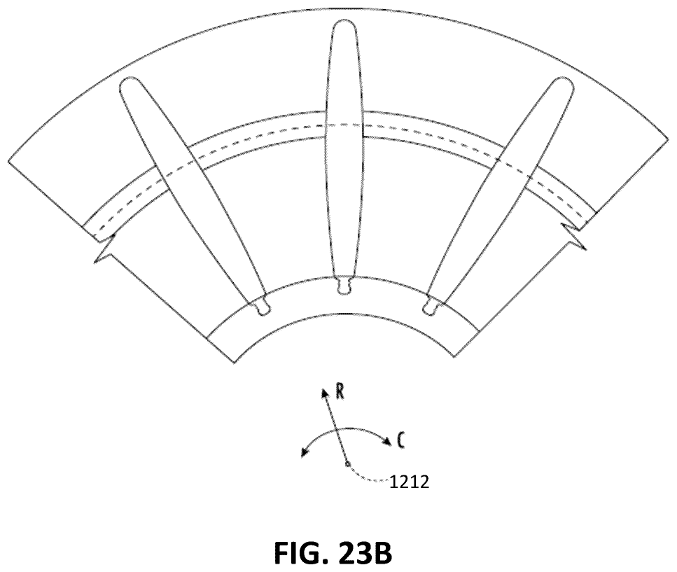

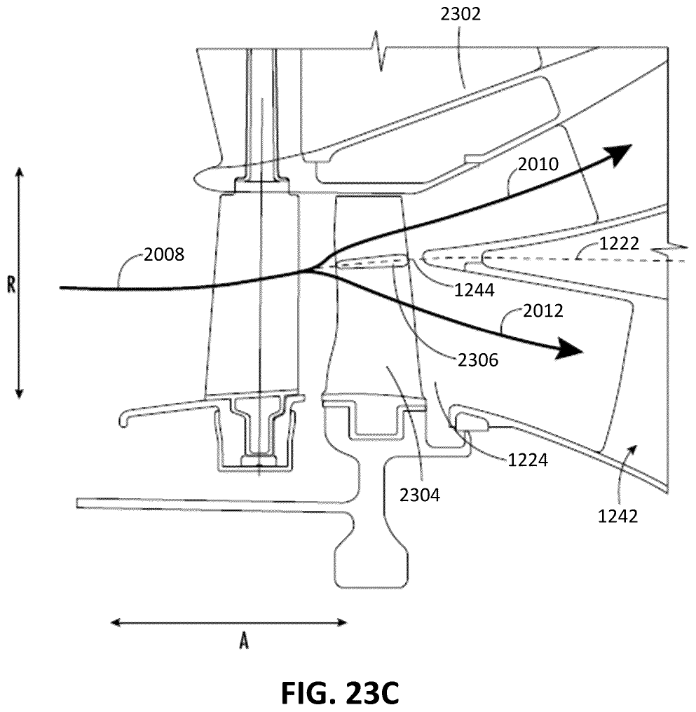

Referring to FIGS. 23A-23C, a cross-sectional view of a gas turbine engine 2300 is shown. FIG. 23A is a side cross-sectional view of the gas turbine engine 2300. FIG. 23B is a cross-sectional view along the line B-B in FIG. 23A. FIG. 23C is a magnified view of a booster of the gas turbine engine 2300.

As with FIGS. 20-22, a booster 2302 separates a stream of air into an outer stream 2004 (which becomes a first fan stream 2006) and an inner stream 2008, and the inner stream 2008 is separated into a second fan stream 2010 and a core stream 2012.

To separate the inner stream 2008 into the second fan stream 2010 and the core stream 2012, a booster rotor blade 2304 of the booster 2302 includes a midspan shroud 2306. In this context, a “midspan” shroud 2306 is a shroud that is coupled to the booster rotor blade 2304 at a location greater than or equal to 20% of a span of the booster rotor blade 2304 and less than or equal to 80% of the span.

The midspan shroud 2306 is a shroud arranged substantially at a same position in the radial direction R as a leading edge 1244 of the core cowl 1222 to separate the inner stream 2008 into the second fan stream 2010 and the core stream 2012. Because the midspan shroud 2306 and the leading edge 1244 of the core cowl 1222 are at the same radial position, the second fan stream 2010 flows outward of the midspan shroud 2306 and the core cowl 1222 into the fan duct inlet 1276, and the core stream 2012 flows inward of the midspan shroud 2306 and the core cowl 1222 into a core inlet 1224. The midspan shroud 2306 thus provides the second fan stream 2010 as the fourth stream of the gas turbine engine 2300.

As shown in FIG. 23B, the midspan shrouds 2306 of adjacent booster rotor blades 2304 abut each other to form a substantially continuous shroud in the circumferential direction C. By forming the substantially continuous shroud, the inner stream 2008 is separated continuously when flowing toward the core duct 1242.

When the core cowl 1222 includes the core flow splitter (FIG. 22), the core flow splitter is arranged to maintain separation of the second fan stream 2010 and the core stream 2012 downstream of the midspan shroud 2306 when the core flow splitter is in the open position. Specifically, as shown in FIG. 23C, the core flow splitter is at substantially a same position in the radial direction R as the midspan shroud 2306 to assist in providing the second fan stream 2010 as the fourth stream for the gas turbine engine 2300. For example, the core cowl defines a leading edge having a leading edge radius, and the midspan shroud includes a trailing edge defining a trailing edge radius that may be within 10% of the leading edge radius of the leading edge of the core cowl.

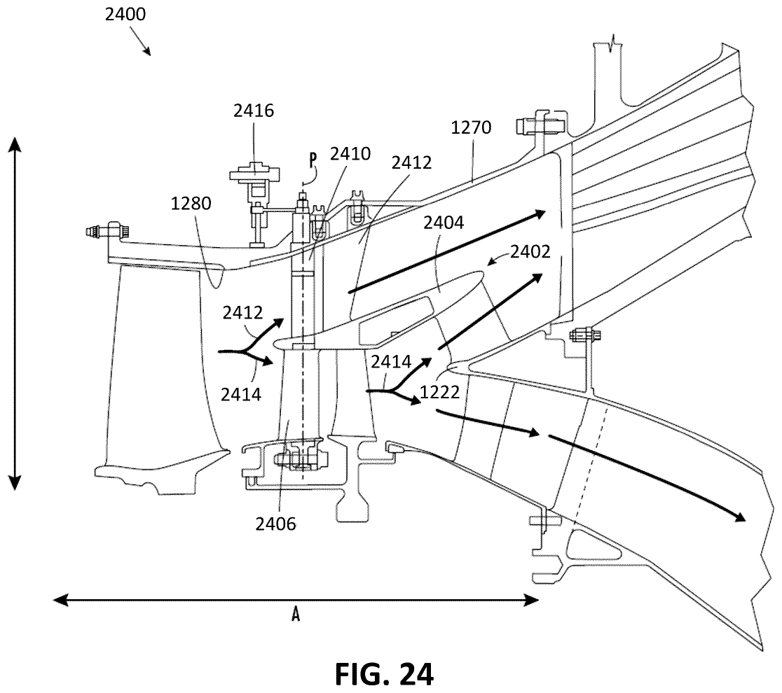

Now referring to FIG. 24, a cross-sectional view of a gas turbine engine 2400 is shown. A booster 2402 includes a booster cowl 2404, an inlet guide vane 2406, a stem 2408, and a strut 2410. The booster 2402 separates a stream of air between an outer stream 2412 and an inner stream 2414, and the inlet guide vane 2406 guides the inner stream 2414 to a core cowl 1222. The strut 2410 secures the booster cowl 2404 to a structure in an engine inlet 1282, such as a fan cowl 1270. The stem 2408 extends through the booster cowl 2404 to the fan cowl 1270.

The stem 2408 is rotatable about a pitch axis P, and the inlet guide 2406 is rotatably fixed to the stem 2408 such that rotation of the stem 2408 rotates the inlet guide vane 2406. More specifically, the gas turbine engine 2400 further includes an actuator 2416 disposed in the fan cowl 1270 that is configured to rotate the stem 2408, which rotates the inlet guide vane 2406 to a specified pitch angle. In FIG. 24, the stem 2408 is spaced upstream from the strut 2410 such that the strut 2410 and the stem 2408 are separate components.

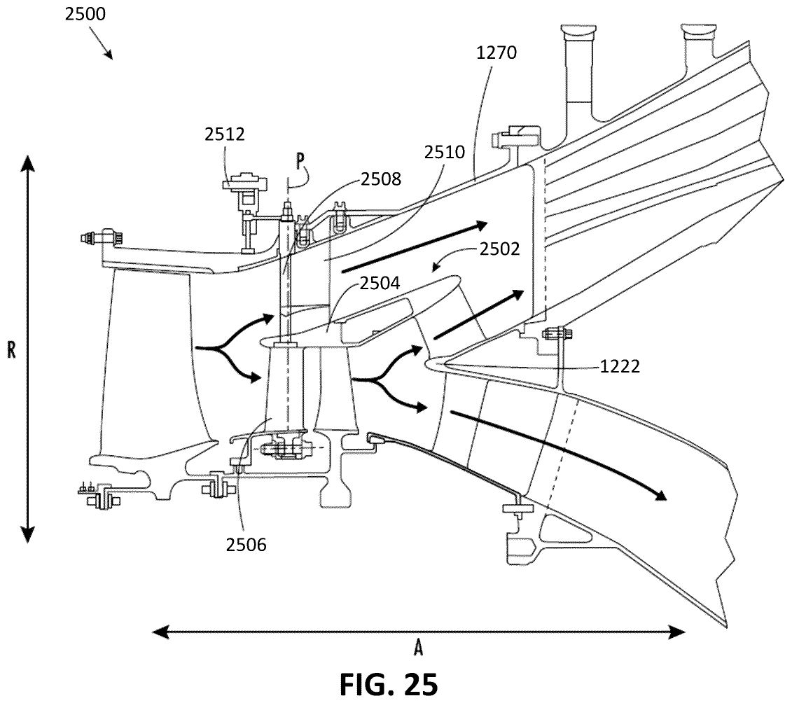

Now referring to FIG. 25, a cross-sectional view of a gas turbine engine 2500 is shown. The gas turbine engine 2500 includes a booster 2502 including a booster cowl 2504, an inlet guide vane 2506, a stem 2508, and a strut 2510.

In FIG. 25, the stem 2508 is integral with the strut 2510, i.e., a unitary construction. The strut 2510 fixes the booster cowl 2504 to the fan cowl 1270, and the stem 2508 is rotatable about a pitch axis P. As with the stem 2408 of FIG. 24, an actuator 2512 disposed in a fan cowl 1270 rotates the stem 2508, and the stem 2508 rotates the inlet guide vane 2506 to a specified pitch angle.

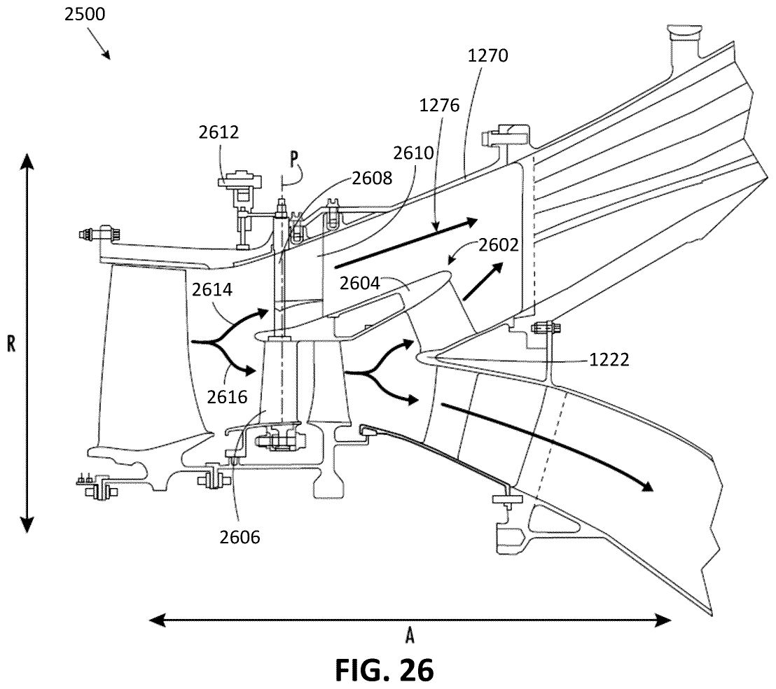

Now referring to FIG. 26, a cross-sectional view of a gas turbine engine 2600 is shown. The gas turbine engine 2600 includes a booster 2602 including a booster cowl 2604, an inlet guide vane 2606, a stem 2608, a strut 2610, and an actuator 2612.

In FIG. 26, the stem 2608 is disposed inside the strut 2610. In such a form, the strut 2610 may be shaped to guide an outer stream 2614 to a fan duct inlet 1276 while the inlet guide vane 2606 guides an inner stream 2616 to a core cowl 1222. The stem 2608 is rotatable within the strut 2610 about a pitch axis P. As with the stems 2408, 2508 of FIGS. 24-25, the actuator 2612 rotates the stem 2608, and the stem 2608 rotates the inlet guide vane 2606 to a specified pitch angle.

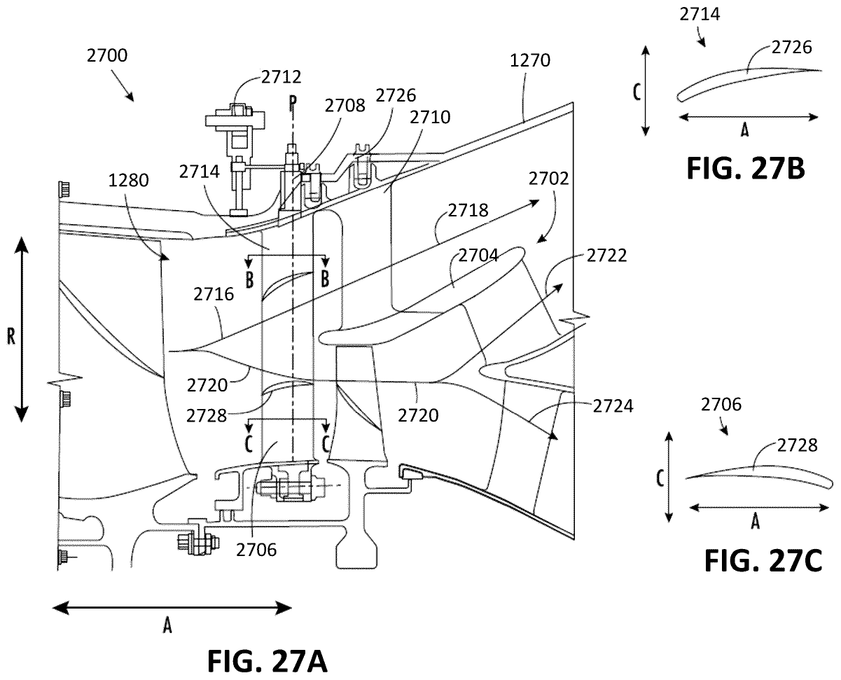

Now referring to FIGS. 27A-27C, a cross-sectional view of a gas turbine engine 2700 is shown. FIG. 27A is a side cross-sectional view of the gas turbine engine 2700. FIG. 27B is a cross-sectional view of an outlet guide vane along the line B-B. FIG. 27C is a cross sectional view of an inlet guide vane along the line C-C.

The gas turbine engine 2700 includes a booster 2702 including a booster cowl 2704, an inlet guide vane 2706, a stem 2708, a strut 2710, an actuator 2712, and an outlet guide vane 2714. The outlet guide vane 2714 and the inlet guide vane 2706 are disposed upstream of the booster 2702.

In FIG. 27A, the outlet guide vane 2714 and the inlet guide vane 2706 are integral and rotatably fixed to the stem 2708. By integrating the outlet guide vane 2714 and the inlet guide vane 2706 together, the stem 2708 rotates both the outlet guide vane 2711 and the inlet guide vane 2706 about a pitch axis P to a same specified pitch angle. The outlet guide vane 2714 extends from a fan cowl 1270 through an engine inlet 1282, and the inlet guide vane 2706 extends from the booster cowl 2704 such that the outlet guide vane 2714 and the inlet guide vane 2706 extend entirely through the engine inlet 1282 in the radial direction R.

The booster 2702 is configured to separate a stream of air into an outer stream 2716 (which becomes a first fan stream 2718) and an inner stream 2720. The outlet guide vane 2714 has a first cross-sectional area 2726 (FIG. 27B) configured to guide the first fan stream 2718, and the inlet guide vane 2706 has a second cross-sectional area 2728 (FIG. 27C) configured to guide the inner stream 2720 to a core cowl 1222. The core cowl 1222 separates the inner stream 2720 into a second fan stream 2722 and a core stream 2724. In the exemplary embodiment of FIGS. 27A-27C, the first cross-sectional area 2526 differs from the second cross-sectional area 2528, providing specific guiding of the first fan stream 2718 and the inner stream 2720. Alternatively, not shown in the FIGS., the first cross-sectional area may be the same as the second cross-sectional area.

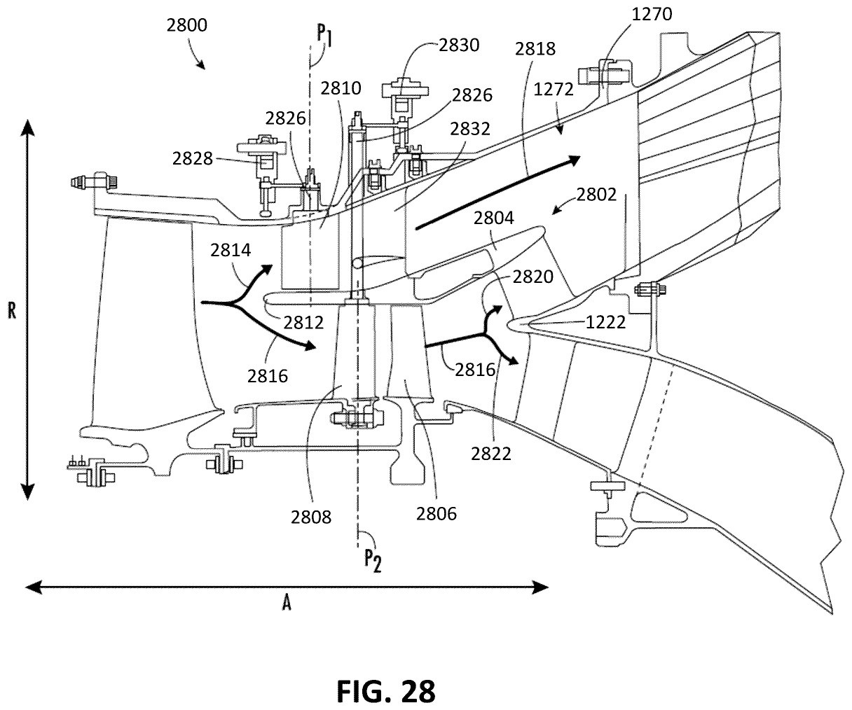

Now referring to FIG. 28, a cross-sectional view of a gas turbine engine 2800 including a booster 2802 is shown. The booster 2802 includes a booster cowl 2804, a booster rotor blade 2806, an inlet guide vane 2808 extending inward in a radial direction R from the booster cowl 2804, and an outlet guide vane 2810 extending outward in the radial direction R from the booster cowl 2804. The outlet guide vane 2810 and the inlet guide vane 2808 are both downstream of a leading edge 2812 of the booster cowl 2804. The leading edge 2812 of the booster cowl 2804 is arranged to separate a stream of air into an outer stream 2814 flowing toward the outlet guide vane 2810 and an inner stream 2816 flowing toward the inlet guide vane 2808. As described above, the outer stream 2814 becomes a first fan stream 2818, and the inner stream 2816 separates into a second fan stream 2820 and a core stream 2822 at a core cowl 1222. The outlet guide vane 2810 is arranged to direct the first fan stream 2818 to a fan duct 1272, and the inlet guide vane 2808 is arranged to direct the inner stream 2816 to the core cowl 1222.

The outlet guide vane 2810 and the inlet guide vane 2808 are each rotatable about respective pitch axes to respective pitch angles. More specifically, the booster 2802 includes a first stem 2824 extending through the outlet guide vane 2810 and a second stem 2826 extending through the inlet guide vane 2808. The first stem 2824 extends outward in the radial direction R from the booster cowl 2804, and the second stem 2826 extends through the booster cowl 2804 in the radial direction R. The first stem 2824 and the second stem 2826 are spaced from each other in the axial direction A such that the outlet guide vane 2810 and the inlet guide vane 2808 are at different axial positions. In the exemplary embodiment of FIG. 28, the first stem 2824 is upstream of the second stem 2826. Alternatively, not shown in the FIGS., the first stem 2824 may be downstream of the second stem 2826.

The outlet guide vane 2810 and the inlet guide vane 2808 are rotatable to specified pitch angles. Specifically, a first actuator 2828 disposed in a fan cowl 1270 is rotatably coupled to the first stem 2824 to rotate the outlet guide vane 2810, and a second actuator 2830 disposed in the fan cowl 1270 is rotatably coupled to the second stem 2826 to rotate the inlet guide vane 2808. The first stem 2824 is rotatable about a first pitch axis P₁ to rotate the outlet guide vane 2810 to a first specified pitch angle, and the second stem 2826 is rotatable about a second pitch axis P₂ to rotate the inlet guide vane 2808 to a second specified pitch angle. The first specified pitch angle and the second specified pitch angle may differ or may be the same, as specified to guide the inner stream 2816 and the outer stream 2814.

The booster may include a strut 2832, similar to the strut 2510 shown in FIG. 25, that is integral with the second stem 2826. In such a form, the strut 2832 secures the booster cowl 2804 to the fan cowl 1270, and the second stem 2826 rotates within the strut 2832. The strut 2832 may have a cross-sectional area that provides further guiding for the first fan stream 2818.

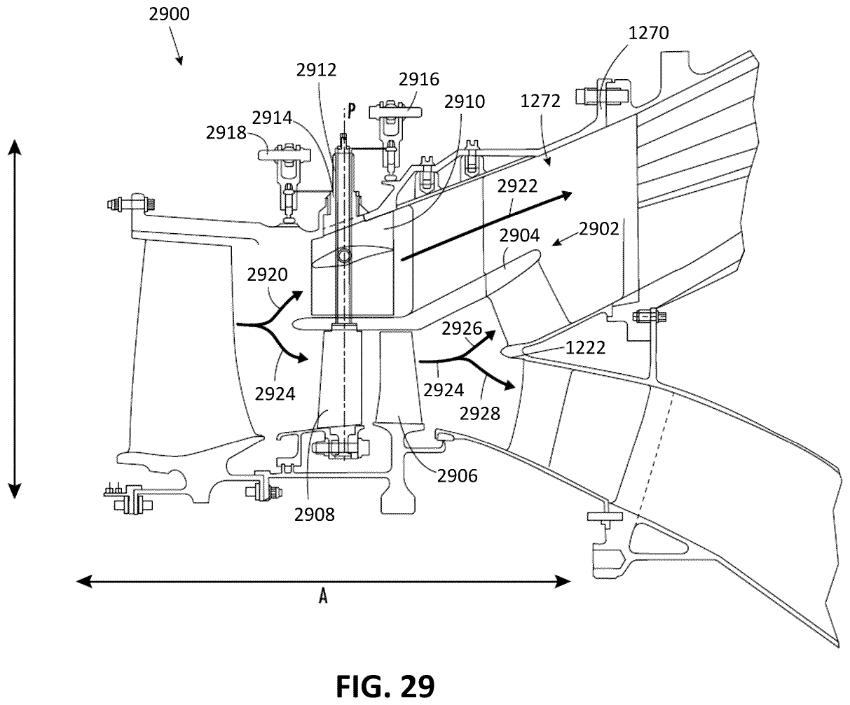

With reference to FIG. 29, a cross-sectional view of a gas turbine engine 2900 is shown. A booster 2902 includes a booster cowl 2904, a booster rotor blade 2906, an inlet guide vane 2908 extending inward in a radial direction R from the booster cowl 2904, and an outlet guide vane 2910 extending outward in the radial direction R from the booster cowl 2904. The booster 2902 includes a first stem 2912 extending through the inlet guide vane 2908 and through the outlet guide vane 2910 and a second stem 2914 disposed around the first stem 2912.

The first stem 2912 is rotatable about a pitch axis P by a first actuator 2916 to rotate the inlet guide vane 2908 to a first pitch angle, and the second stem 2914 is separately rotatable about the pitch axis P by a second actuator 2918 to rotate the outlet guide vane 2910 to respective pitch angles. That is, in FIG. 29, the outlet guide vane 2910 and the inlet guide vane 2908 are coaxial, i.e., having a same position in the axial direction A. As with the inlet guide vane 2808 and the outlet guide vane 2810 of FIG. 28, the outlet guide vane 2810 directs an outer stream 2920 toward a fan duct 1272 to become a first fan stream 2922, and the inlet guide vane 2908 directs an inner stream 2924 toward a core cowl 1222, which separates the inner stream 2924 into a second fan stream 2926 and a core stream 2928.

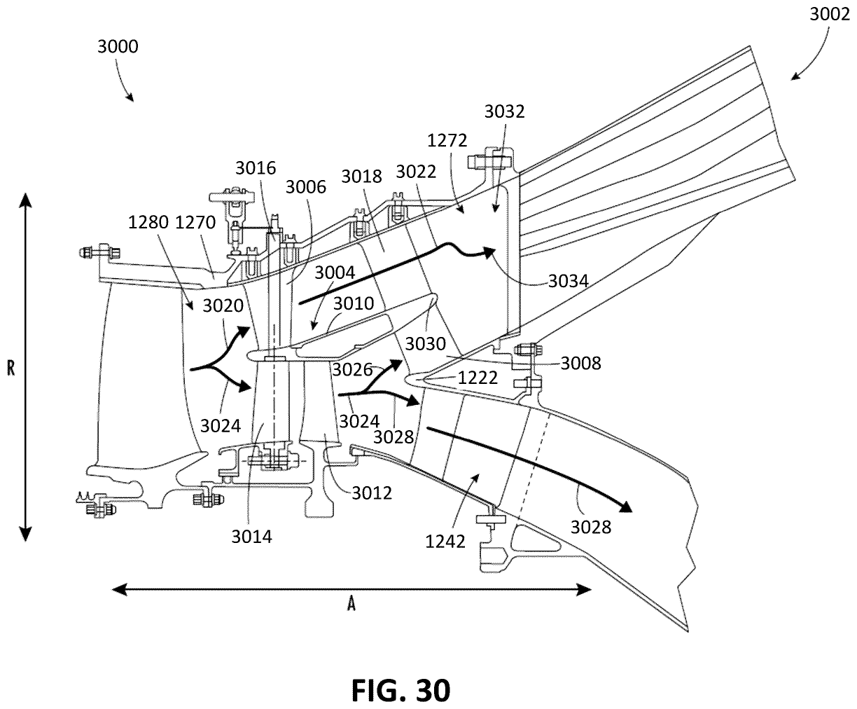

Now referring to FIG. 30, a cross-sectional view of a gas turbine engine 3000 is shown. The gas turbine engine includes a heat exchanger 3002 disposed in a fan duct 1272, a booster 3004 disposed upstream of the heat exchanger 3002, a strut 3006 securing the booster 3004 to a fan cowl 1270, and a second strut 3008 disposed in the fan duct 1272 securing the booster 3004 to a core cowl 1222. The booster 3004 includes a booster cowl 3010, a booster rotor blade 3012, and an inlet guide vane 3014. As with the strut 1210 of FIG. 25, the strut 3006 may be integral with a stem 3016 that rotates the inlet guide vane 3014 to a specified pitch angle. The gas turbine engine 3000 may include a third strut 3018 that secures the booster 3004 to the fan cowl 1270 in the fan duct 1272.

As described above, the booster 3004 separates a stream of air in an inlet duct 1280 into an outlet stream 3020 flowing toward the fan duct 1272 that becomes a first fan stream 3022 and an inner stream 3024 flowing toward a core cowl 1222. The inlet guide vane 3014 directs the inner stream 3024 toward the booster rotor blade 3012 and the core cowl 1222, which separates the inner stream 3024 into a second fan stream 3026 flowing into the fan duct 1272 and a core stream 3028 flowing into a core duct 1242.

The first fan stream 3022 and the second fan stream 3026 may merge in the fan duct 1272 upstream of the heat exchanger 3002. More specifically, the booster cowl 3010 has a trailing edge 3030 disposed in the fan duct 1272 that is upstream of the heat exchanger 3002. The trailing edge 3030 defines a merging zone 3032 with the heat exchanger 3002, and the first fan stream 3022 and the second fan stream 3026 merge into a unified fan stream 3034 in the merging zone 3032. By merging the unboosted first fan stream 3022 and the boosted second fan stream 3026, the unified fan stream 3034 provides uniform heat transfer to or from a working fluid of the heat exchanger 3002.

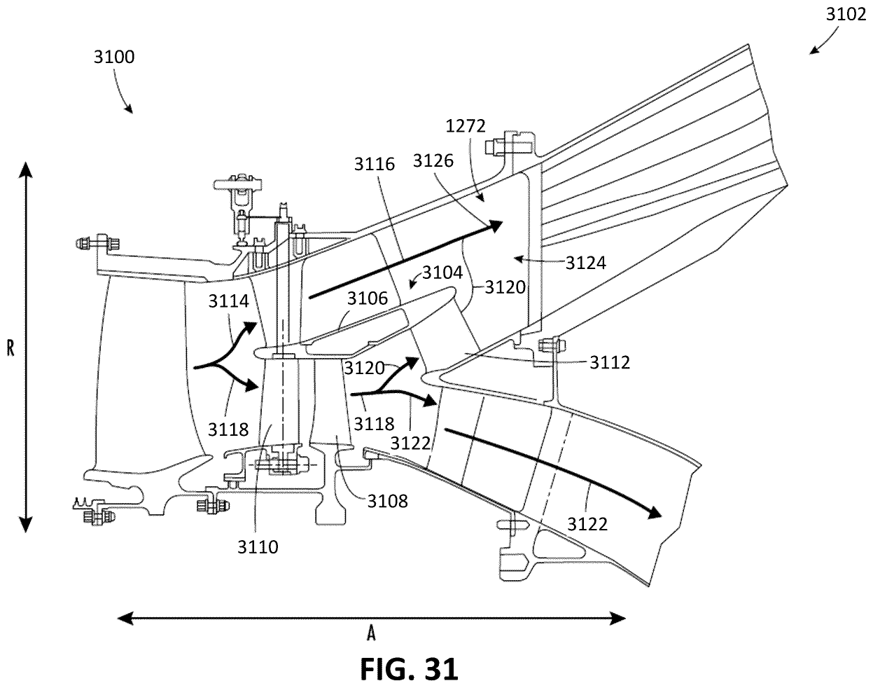

With reference to FIG. 31, a cross-sectional view of a gas turbine engine 3100 is shown. A heat exchanger 3102 disposed in a fan duct 1272, and a booster 3104 is disposed upstream of the heat exchanger 3102. The booster 3104 includes a booster cowl 3106, a booster rotor blade 3108, an inlet guide vane 3110, and an outlet guide vane 3112 extending between the booster cowl 3106 and a core cowl 1222. The booster 3104 separates a stream of air into an outer stream 3114 (which becomes a first fan stream 3116) and an inner stream 3118. The booster rotor blade 3108 boosts the inner stream 3118, and the core cowl 1222 separates the inner stream 3118 into a second fan stream 3120 and a core stream 3122 flowing into a core duct 1242.

The outlet guide vane 3112 is disposed in the fan duct 1272 to direct the second fan stream 3120 into a merging zone 3124 in the fan duct 1272 where the first fan stream 3116 and the second fan stream 3120 merge into a unified fan stream 3126. More specifically, the outlet guide vane 3112 is fixed to a specified pitch angle to guide the boosted second fan stream 3120 into the fan duct 1272 to the merging zone 3124. The unified fan stream 3126 then flows into the heat exchanger 3102.

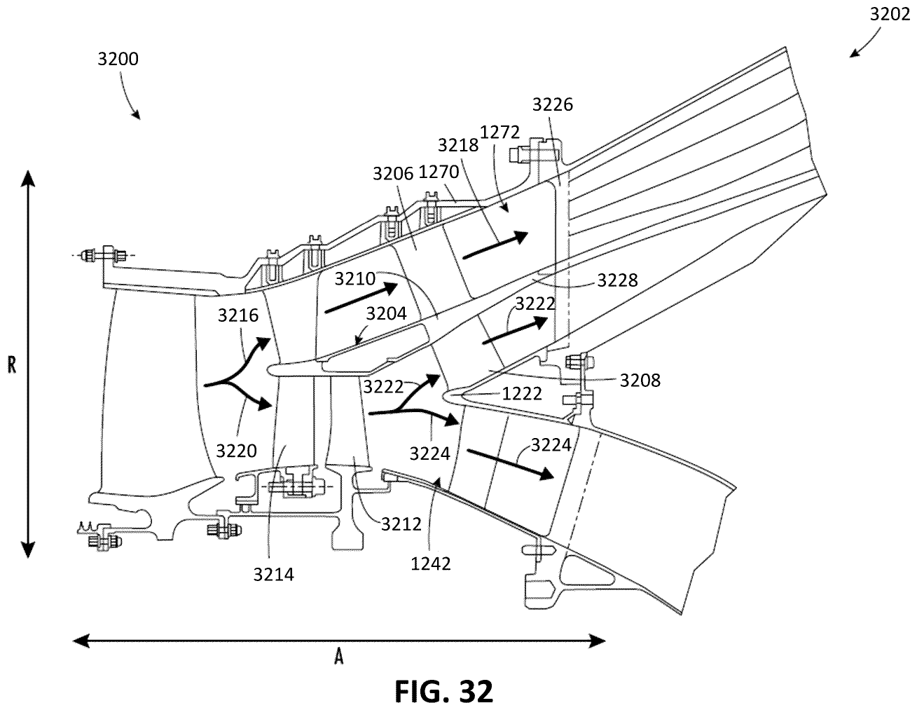

Now referring to FIG. 32, a cross-sectional view of a gas turbine engine 3200 is shown. The gas turbine engine 3200 includes a heat exchanger 3202 disposed in a fan duct 1272, a booster 3204 disposed upstream of the heat exchanger 3202, a strut 3206 securing the booster 3204 to a fan cowl 1270, and a second strut 3208 disposed in the fan duct 1272 securing the booster 3204 to a core cowl 1222. The booster 3204 includes a booster cowl 3210, a booster rotor blade 3212, and an inlet guide vane 3214. In FIG. 32, the inlet guide vane 3214 is fixed to a specified pitch angle.

The booster cowl 3210 separates a stream of air into an outer stream 3216 (which becomes a first fan stream 3218) from an inner stream 3220. The booster rotor blade 3212 boosts the inner stream 3220, and the core cowl 1222 separates the inner stream 3220 into a second fan stream 3222 and a core stream 3224 flowing into a core duct 1242. The booster cowl 3210 is arranged such that the first fan stream 3218 and the second fan stream 3222 remain separated upon reaching the heat exchanger 3202. More specifically, the heat exchanger 3202 includes an inlet 3226 extending in the radial direction R through the fan duct 1272, and the booster cowl 3210 includes an extension 3228 that extends to the inlet. The extension 3228 maintains separation of the unboosted first fan stream 3218 and the boosted second fan stream 3222 in the fan duct 1272 at the inlet 3226.

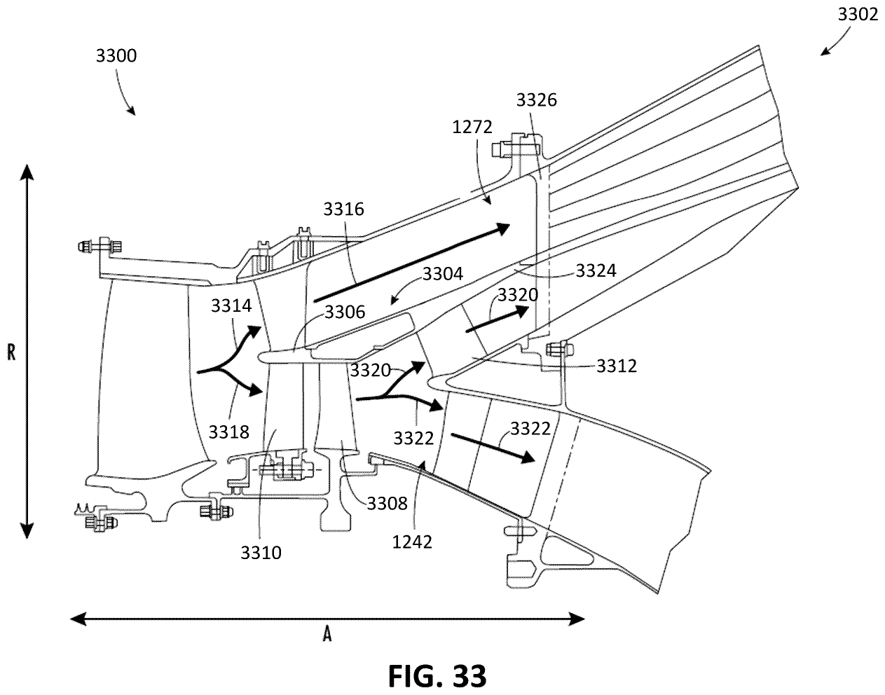

With reference to FIG. 33, a cross-sectional view of a gas turbine engine 3300 is shown. A heat exchanger 3302 is disposed in a fan duct 1272, and a booster 3304 is disposed upstream of the heat exchanger 3302. The booster 3304 includes a booster cowl 3306, a booster rotor blade 3308, an inlet guide vane 3310, and an outlet guide vane 3312 extending between the booster cowl 3306 and a core cowl 1222. The booster cowl 3306 separates a stream of air into an outer stream 3314 (which becomes a first fan stream 3316) from an inner stream 3318. The inlet guide vane 3310 guides the inner stream 3318 to the booster rotor blade 3308, which boosts the inner stream 3318, and the core cowl 1222 separates the inner stream 3318 into a second fan stream 3320 and a core stream 3322 flowing into a core duct 1242.

The outlet guide vane 3312 is disposed in the fan duct 1272 to direct the second fan stream 3320 toward the heat exchanger 3302. More specifically, the outlet guide vane 3312 is fixed to a specified pitch angle to guide the boosted second fan stream 3320 into the fan duct 1272. As with the booster 3204 of FIG. 32, the booster cowl 3306 includes an extension 3324 that extends to an inlet 3326 of the heat exchanger 3302 to maintain separation of the unboosted first fan stream 3316 and the boosted second fan stream 3320.

It will be appreciated that the exemplary gas turbine engines of FIGS. 30-33 may include additional struts or outlet guide vanes as needed to secure the booster and to direct the streams to the fan duct and the core duct. For example, instead of the outlet guide vane 3112, the gas turbine engine 3100 of FIG. 31 may include a strut extending from the booster cowl 3106 to the core cowl 1222.

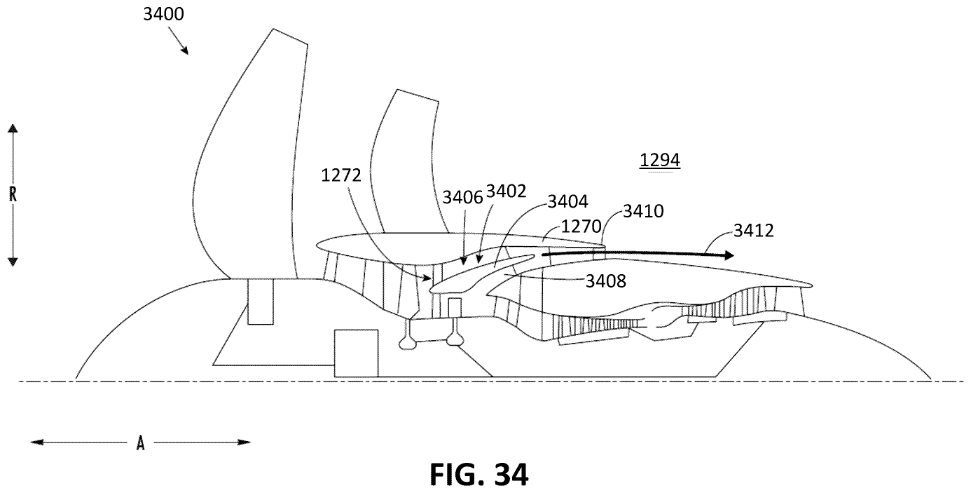

With reference to FIG. 34, a cross-sectional view of a gas turbine engine 3400 is shown. The gas turbine engine 3400 includes a booster 3402 including a booster cowl 3404. The booster cowl 3404 separates a fan duct 1272 into an upper fan duct 3406 and a lower fan duct 3408. The booster cowl 3404 terminates upstream of a trailing edge 3410 of a fan cowl 1270 such that the booster cowl 3404 is entirely disposed inward of the fan cowl 1270 in the radial direction R. In such a form, the upper fan duct 3406 merges with the lower fan duct 3408 such that a unified fan stream 3412, formed downstream of the booster 3402 but upstream of the trailing edge 3410 of the fan cowl 1270, exhausts to a bypass region 1294.

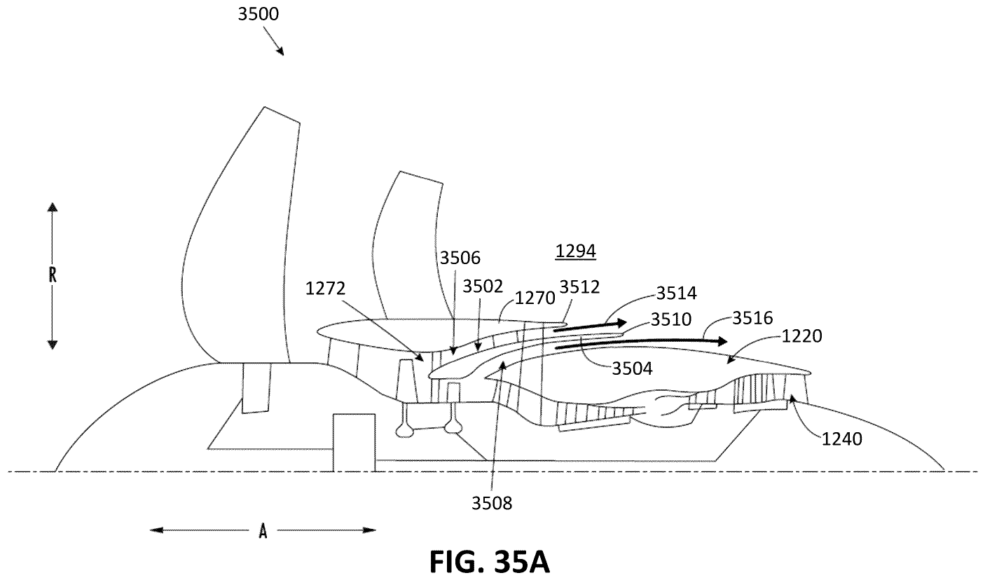

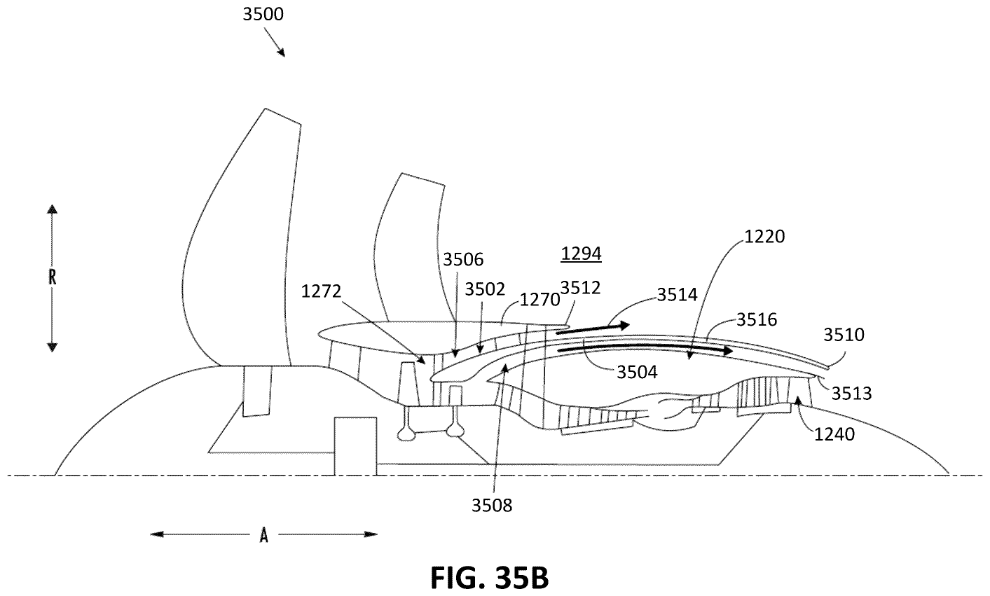

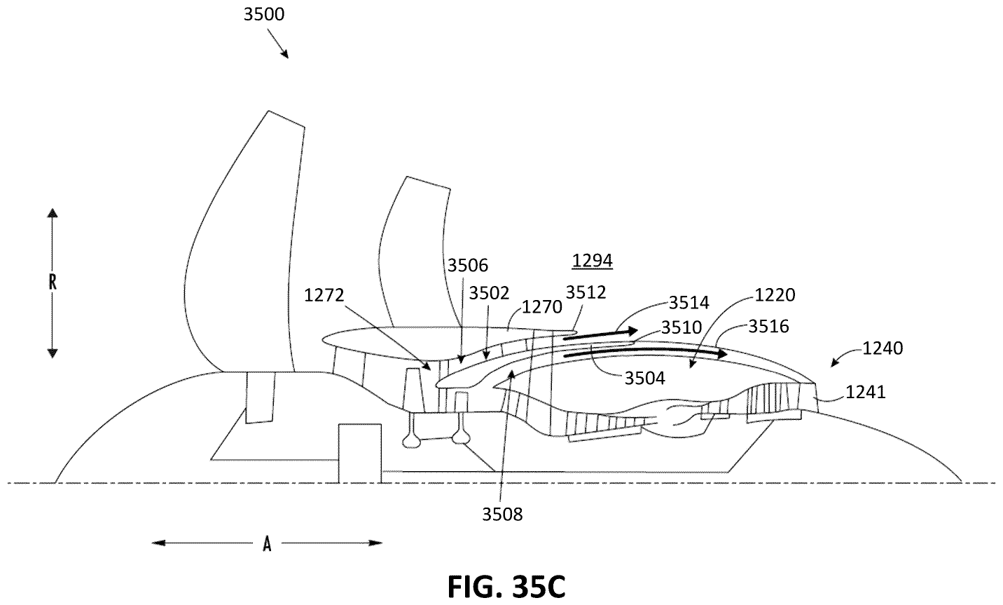

Now referring to FIGS. 35A, 35B, and 35C cross-sectional views of additional embodiments of a gas turbine engine 3500 are shown. The gas turbine engines 3500 each include a booster 3502 including a booster cowl 3504. The booster cowls 3504 separate a fan duct 1272 of each gas turbine engine 3500 into an upper fan duct 3506 and a lower fan duct 3508. Each booster cowl 3504 terminates downstream of a trailing edge 3512 of a fan cowl 1270. In such a form, the booster cowl 3504 maintains separation between a first fan stream 3514 in the upper fan duct 3506 and a second fan stream 3516 in the lower fan duct 3508.

Referring particularly to FIG. 35A, a trailing edge 3510 of the booster cowl 3504 terminates downstream of the trailing edge 3512 of the fan cowl 1270, and upstream of an exhaust nozzle 1240 of the turbomachine 1220. In such a manner, the upper fan duct 3506 exhausts to a bypass region 1294, and the lower fan duct 3508 exhausts to the bypass region 1294 separately from the upper fan duct 3506. The second fan stream 3516 thus acts as a fourth stream for the gas turbine engine 3500.

Referring particularly to FIG. 35B, a trailing edge 3510 of the booster cowl 3504 terminates downstream of the trailing edge 3512 of the fan cowl 1270, at or downstream of an exhaust nozzle 1240 of the turbomachine 1220. In such a manner, the upper fan duct 3506 exhausts to a bypass region 1294, and the lower fan duct 3508 merges with an exhaust of the turbomachine 1220. A mixer 3513 is depicted schematically to assist with the mixing of the two flows. The second fan stream 3516 thus again acts as a fourth stream for the gas turbine engine 3500.

Referring particularly to FIG. 35C, the booster cowl 3504 terminates downstream of the trailing edge 3512 of the fan cowl 1270. More specifically, for the embodiment of FIG. 35C, the upper fan duct 3506 exhausts to a bypass passage 1294, and the lower fan duct 3508 merges with an exhaust of the turbomachine 1220 through a turbine rear frame 1241 located at a turbomachine exhaust nozzle 1240. In such a manner, the second fan stream 3516 in the lower fan duct 3508 is reincorporated with the exhaust of the turbomachine 120 through the turbine rear frame 1241.

However, as will be appreciated from the discussion herein, for the embodiments of FIGS. 35A and 35B, the lower fan duct inlet and upper fan duct inlet are considered collectively for the purposes of determining the TPAR and CBR, as discussed elsewhere herein, despite the lower fan duct 3508 acting as a fourth stream.

Notably, in certain exemplary embodiments the lower fan duct 3508 of FIGS. 35A, 35B may be an annular passage extending continuously from the lower fan duct inlet to the trailing edge 3510. Alternatively, at least a portion of the lower fan duct 3508 may be configured as one or more discrete ducts or passages. If a plurality of ducts or passages are provided, they may be spaced along a circumferential direction of the gas turbine engine.

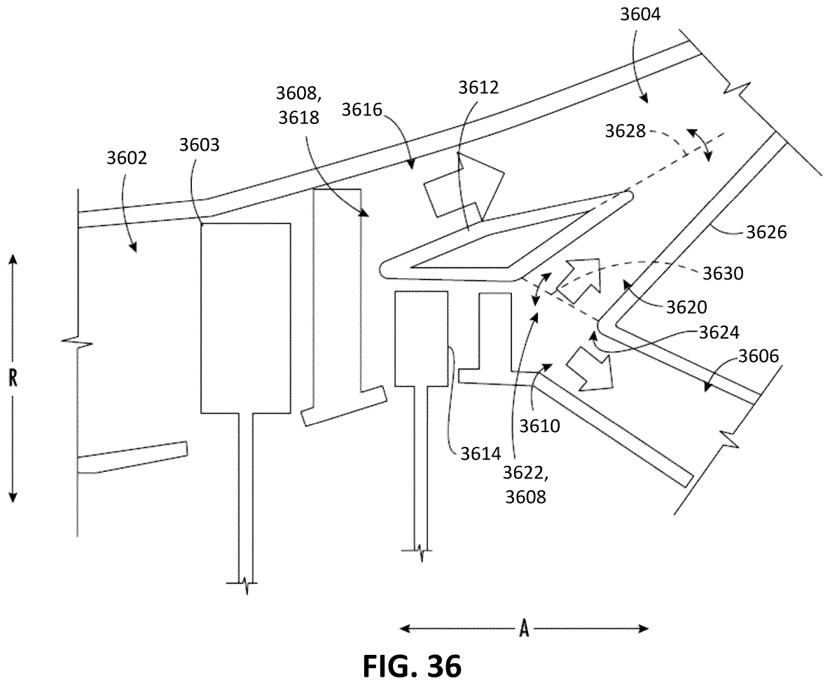

Referring now to FIG. 36, a simplified, schematic view is provided of a section of a gas turbine engine 3600 in accordance with an exemplary aspect of the present disclosure. In particular, FIG. 36 provides a close-up, schematic view of a section of an inlet duct 3602, a fan duct 3604, and a core duct 3606 of the gas turbine engine 3600. The exemplary gas turbine engine 3600 of FIG. 36 may be configured in a similar manner as one or more of the exemplary gas turbine engines of the present disclosure described hereinabove, such as one or more of the exemplary gas turbine engines of FIGS. 19 through 35.

For example, the gas turbine engine 3600 includes the inlet duct 3602, a ducted fan 3603 (also referred to herein as a secondary fan) positioned at least partially within the inlet duct 3602, the fan duct 3604, and the core duct 3606; and defines a fan duct inlet 3608 to the fan duct 3604 and a core duct inlet 3610 to the core duct 3606. Moreover, the exemplary gas turbine engine 3600 of FIG. 36 includes a booster having a booster cowl 3612 and a booster rotor blade 3614. The booster cowl 3612 is positioned at least partially in the fan duct 3604 and separates an upstream portion of the fan duct 3604 into an upper fan duct 3616 having an upper fan duct inlet 3618 and a lower fan duct 3620 having a lower fan duct inlet 3622. The upper fan duct inlet 3618 and lower fan duct inlet 3622 collectively form the fan duct inlet 3608.

In such a manner, it will be appreciated that the upper fan duct inlet 3618 defines an upper fan duct inlet area, A_{FDI_Upper}, and a lower fan duct inlet area, A_{FDI_Lower}. The upper fan duct inlet area, A_{FDI_Upper}, and lower fan duct inlet area, A_{FDI_Lower}, collectively form a secondary fan outer fan area, A_{S_Out}. The secondary fan outer fan area, A_{S_Out}, as noted above with respect to the earlier embodiments, refers to an area representing a portion of an airflow from the ducted fan 3603 that is provided to the fan duct 3604. The upper fan duct inlet area, A_{FDI_Upper}, and lower fan duct inlet area, A_{FDI_Lower}, can each individually be calculated in the same manner as the secondary fan outer fan area, A_{S_Out}, as described above with reference to, e.g., FIG. 14 (i.e., an area defined by the formula:

$$\frac{π ( {R}_{OUT}^{2} - {R}_{IN}^{2} )}{cos ( θ )} ,$$

where R_{OUT} is an effective duct inlet outer radius along a radial direction R, R_{IN} is a leading edge radius of the booster cowl 3612 or of a core cowl 3626, and 0 is defined by a mean flow direction through a forward 10% of the upper fan duct 3616 or lower fan duct 3620; see FIG. 14).

Referring still to FIG. 36, the gas turbine engine 3600 further defines a secondary fan inner fan area, A_{S_In}. The secondary fan inner fan area, A_{S_In}, refers to an area defined by an annulus representing a portion of the ducted fan 3603 located inward of a leading edge 3624 of the core cowl 3626 (see, e.g., FIG. 13).

Moreover, while not depicted in FIG. 36, it will be appreciated that the gas turbine engine 3600 further defines a primary fan outer fan area, A_{P_Out} and a primary fan inner fan area, A_{P_In}. Each of these measurements, and the secondary fan outer fan area, A_{S_Out}, which again is a sum of the upper fan duct inlet area, A_{FDI_Upper}, and lower fan duct inlet area, A_{FDI_Lower}, may be used in defining various airflow ratios for the engine 3600. In particular, it will be appreciated that the exemplary engine 3600 of FIG. 36 further defines a thrust to power airflow ratio (TPAR) and a core bypass ratio (CBR), which as discussed herein are used to define an engine 3600 in accordance with the present disclosure. The thrust to power airflow ratio is a ratio of an airflow through a bypass passage of the engine 3600 (see, e.g., bypass passage of earlier embodiments) and through the fan duct 3604 to an airflow through the core duct 3606. Further, the core bypass ratio is a ratio of an airflow through the fan duct 3604 to the airflow through the core duct 3606. These ratios are calculated while the engine 3600 is operating at a rated speed during standard day operating conditions, and the amounts of airflow used to calculate these ratios are each expressed as a mass flowrate in the same units (mass per unit time).

More specifically, the preferential amount of the airflow through the bypass passage is determined using a fan pressure ratio for the primary fan (see, e.g., fan 1252 of earlier embodiments) while operating at the rated speed during standard day operating conditions, and the primary fan outer fan area, A_{P_Out}. The amount of airflow through the inlet duct 3602 is determined using the fan pressure ratio for the primary fan while operating at the rated speed during standard day operating conditions, and the primary fan inner fan area, A_{P_In}. The amount of airflow through the fan duct 3604 and the amount of airflow through the core duct 3606 is determined based on the amount of airflow through the inlet duct 3602 and the secondary fan outer fan area, A_{S_Out}, and the secondary fan inner fan area, A_{S_In}. Further, the amount of airflow through the lower fan duct inlet 3622 is determined based on the amount of airflow through the inlet duct 3602 and the upper fan duct inlet area, A_{FDI_Upper}, the lower fan duct inlet area, A_{FDI_Lower}, and the secondary fan inner fan area, A_{S_In}.

Notably, in certain exemplary embodiments, the lower fan duct 3620 is a fixed flowpath lower fan duct 3620. With such an exemplary embodiment, the gas turbine engine 3600 may not include, e.g., one or more variable structures 3628, 3630 to optimize losses and modify airflow characteristics through the lower fan duct 3620 during operations of the present disclosure, e.g., to prevent flow separations over a wide range of flow ratios (see, e.g., embodiments of FIGS. 32 and 33).

Alternatively, in other exemplary embodiments, such as the exemplary embodiment of FIG. 36, the lower fan duct 3620 may be a variable flowpath lower fan duct 3620 having one or more variable structures 3628, 3630 to optimize losses and modify airflow characteristics through the lower fan duct 3620 during operations of the present disclosure, e.g., to prevent flow separations over a wide range of flow ratios. For example, as is represented by a line in phantom in FIG. 36, a first variable structure 3628 may be a flow blocker operable with the variable flowpath lower fan duct 3620 for affecting an amount of airflow through the variable flowpath lower fan duct 3620 during operation of the gas turbine engine 3600. In the embodiment shown, the flow blocker is coupled to the booster cowl 3612, at least partially integrated into the booster cowl 3612, or both. Additionally, or alternatively, as is represented by another line in phantom in FIG. 36, a second variable structure 3630 may be a blocker door coupled to a core cowl of the engine. The blocker door may be pivotably coupled to the core cowl, slidably coupled to the core cowl, etc.

It will be appreciated, however, that in other exemplary embodiments, the one or more variable structures 3628, 3630 may be configured differently. For example, in other embodiments the one or more variable structures 3628, 3630 may include an inlet guide vane positioned in the variable flowpath lower fan duct 3620, a variable guide vane located upstream of the ducted fan 3603, a variable guide vane located downstream of the ducted fan 3603, a variable guide vane located downstream of the booster rotor blade 3614 and upstream of the lower fan duct 3620, an actuator configured to rotate the inlet guide vane about a pitch axis, or a combination thereof.

As alluded to earlier, the inventors of the present disclosure found, unexpectedly during the course of designing a gas turbine engine having a booster and booster cowl, with the booster cowl separating an upstream portion of a fan duct into an upper fan duct having an upper fan duct inlet and a lower fan duct having a lower fan duct inlet, a significant relationship exists between a thrust to power airflow ratio (TPAR), an airflow through the lower fan duct inlet, A₃S_L_{ower}, and an airflow through the core, A_{C}, of the gas turbine engine while the engine is operated at the rated speed during standard day operating conditions. The relationship can be thought of as an indicator of the ability of a gas turbine having said booster cowl to be able to provide an operability benefit to the gas turbine engine.

In particular, the inventor discovered that when operating a gas turbine engine having a fan duct, and in particular when operating a gas turbine engine having a booster and a booster cowl (with the booster cowl in the upstream portion of the fan duct), in order to achieve a desired operability, the amount of airflow needed to be provided through the lower fan duct relative to the core duct to achieve a desired operability varies with a size of the primary fan (and thus a bypass ratio and TPAR) and an operating condition of the gas turbine engine.

For example, with a larger primary fan and TPAR, an amount of heat rejection required may be increased due at least in part to a size of a reduction gearbox needed to rotate the primary fan at a desired rotational speed. In such a manner, it may be beneficial to provide an increased amount of airflow through the lower fan duct, as such airflow has been increased in pressure by the booster, and may allow for an increased pressure drop across a heat exchanger in the fan duct.

Further, with a larger primary fan and TPAR, it becomes increasingly important to match an airflow into the core of the turbomachine of the gas turbine engine at the various operating conditions. At takeoff, for example, the operability goals are generally to create as much thrust as possible. To achieve this goal, the engine wants to rotate the primary fan faster relative to a desired rotational speed of the secondary fan in the inlet duct. More specifically, the desired rotational speed of the primary fan is set by the desired thrust output, while the desired rotational speed of the secondary fan may be set by an operability line of the compressor section. By increasing an amount of airflow through the lower fan duct inlet relative to the amount of airflow into the core, the engine may allow the primary fan to rotate faster (and thus also allow the secondary fan to rotate faster) without, e.g., stalling the compressor section.

By contrast, at an operating condition more focused on efficiency, such as cruise, the engine wants to operate the primary fan at a slower rotational speed to increase efficiency. Such an operating mode correspondingly slows down the rotational speed of the secondary fan, such that less airflow is needed to be provided through the lower fan duct inlet relative to the amount of airflow into the core.

The relationship discovered, infra, can therefore identify a gas turbine engine having a booster and booster cowl, capable of achieving a desired thrust output and thermal management capacity, while avoiding a prohibitive operability penalty, and suited for a particular mission requirement, one that takes into account efficiency, weight, thermal capacity needs, complexity, reliability, and other factors influencing the optimal choice for a gas turbine engine with the booster and booster cowl.

The desired relationship providing for the improved gas turbine engine, discovered by the inventors, is a booster bleed ratio (BBR), wherein the BBR is a ratio of an airflow through the lower fan duct inlet, A_{3S_Lower}, to the airflow through the core duct, A_{C}. In aspects of the present disclosure, for a gas turbine engine defining a TPAR between 3.5 and 100 and a core bypass ratio (CBR) between 0.1 and 10, designing the gas turbine engine to have a BBR less than or equal to an upper range of 0.005625×TPAR+0.2375, and greater than or equal to a lower range of 0.001125×TPAR+0.00977, allows for the gas turbine engine to provide the desired benefits discussed herein. Notably, in these relationships all measures of airflow are in the same mass per unit time measurement.

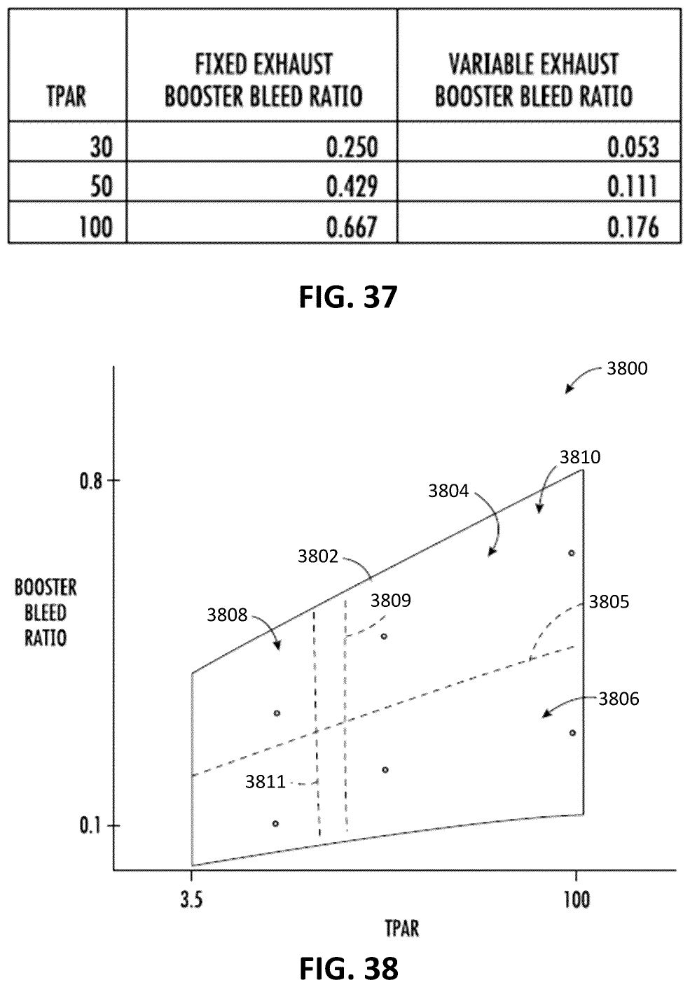

Referring now to FIGS. 37 and 38, the relationships between the various parameters of the BBR of the exemplary gas turbine engines are illustrated in accordance with one or more exemplary embodiments of the present disclosure. In particular, FIG. 37 provides a table including numerical values corresponding to several of the plotted gas turbine engines in FIG. 38. FIG. 38 is a plot 3800 of gas turbine engines in accordance with one or more exemplary embodiments of the present disclosure, showing the TPAR (Y-Axis) and the BBR (X-axis). The plot 3800 depicts a range 3802 of gas turbine engines of the present disclosure, falling within the range of BBR described above.

Moreover, the plot 3800 in FIG. 38 further shows an upper subrange 3804 and a lower subrange 3806. The upper subrange 3804 corresponds to embodiments where the lower fan duct is a fixed flowpath lower fan duct. For this upper subrange 3804, BBR is closer to an upper range of the plot 3802 (and more specifically of the range 3802) than a lower range of the plot 3804 along the X-axis (i.e., above phantom line 3805). By contrast, the lower subrange corresponds to embodiments where the lower fan duct is a variable flowpath lower fan duct. For this lower subrange 3806, BBR is closer to the lower range of the plot 3802 than the upper range of the plot 3802 along the X-axis (i.e., below phantom line 3805).

As will be appreciated, inclusion of a variable flowpath lower fan duct may not require as much airflow to the be provided through the variable flowpath lower fan duct during operation at a rated speed, as compared to during other operating conditions, as the airflow may be modulated to match a specific need to achieve a desired operability of the gas turbine engine.

Referring still to FIG. 38, the plot 3800 further shows a ducted primary fan subrange 3808 and an unducted primary fan subrange 3810. For the ducted primary fan subrange 3808, a primary fan of the gas turbine engines is ducted (i.e., surrounded at least in part by an outer nacelle), and TPAR is greater less than or equal to 40 (i.e., to the left of phantom line 3809). For the unducted primary fan subrange 3810, a primary fan of the gas turbine engines is unducted, and TPAR is greater than or equal to 30 (i.e., to the right of phantom line 3811).

Further aspects of the disclosure are provided by the subject matter of the following clauses:

Clause 1: An aircraft is provided that includes a fuselage; an airfoil extending from the fuselage, the airfoil having an airfoil section with a leading edge (LE) and a trailing edge (TE), a chord extending between the LE and TE, and an effective quarter chord point (QC) along the chord measured from the LE; an unducted fan propulsor mounted relative to the airfoil section on a high pressure side thereof, the unducted fan propulsor having a centerline (CL) and a plurality of blades arranged in one or more arrays, each of the blades having a root and the plurality of blades defining a maximum outer diameter (D), the unducted fan propulsor having a point (P) defined as one of: (a) wherein the plurality of blades is arranged in a single array, the point P is located at an intersection of the CL and a line perpendicular to the CL that passes through a midpoint between edges at the root of one of the plurality of blades, and (b) wherein the plurality of blades is arranged in a forward array and a rearward array, the point P is located at an intersection of the CL and midpoint between a rearward trailing edge (TE) of the rearward array and leading edge (LE) of the forward array when a blade of the forward and rearward arrays are aligned with each other; and an ellipse origin positioning line (EOR) having a length (EORL) extending from the QC to an ellipse origin (OR) and at an angle θ as measured from a vector from the QC to the TE of the airfoil section to the line EOR, where, when viewed with the LE to the left of TE, a positive θ (1) increases in a counter-clockwise direction when the high pressure side of the airfoil section is below the airfoil section, and (2) increases in a clockwise direction when the high pressure side of the airfoil section is above the airfoil section, and wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7.

In the preceding clause, the P of the unducted fan propulsor is located in a second ellipse having a second major axis length (2MajAL) and a second minor axis length (2MinAL) with a second ellipse origin defined by EORL/D of 1.051 and θ of 248.8°, and where 2MajAL/D is 1.86 and 2MinAL/D is 1.56.

In any of the preceding clauses, the P of the unducted fan propulsor is located in a third ellipse having a third major axis length (3MajAL) and a third minor axis length (3MinAL) with a third ellipse origin defined by EORL/D of 0.870 and θ of 239.6°, where 3MajAL/D is 1.4 and 3MinAL/D is 0.9.

In any of the preceding clauses, the P of the unducted fan propulsor is located in a fourth ellipse having a fourth major axis length (4MajAL) and a fourth minor axis length (4MinAL) with a fourth ellipse origin defined by EORL/D of 0.763 and θ of 235.7°, and where 4MajAL/D is 0.94 and 4MinAL/D is 0.44.

In any of the preceding clauses, the unducted fan propulsor is undermounted to the airfoil, such as a wing, with one or more intermediate structures.

In any of the preceding clauses, the unducted fan propulsor has a cruise flight Mach M₀ of between 0.70 and 0.85, between 0.5 and 0.9, between 0.7 and 0.9, or between 0.75 and 0.9.

In any of the preceding clauses, the rotating blades diameter is between 8 to 16 feet or between 12 to 16 feet. In any of the preceding clauses, the aircraft having a wing defining the airfoil and one or two unducted fan propulsors are mounted to the wing.

In any of the preceding clauses, wherein the aircraft are aircraft types A, B, C or G as defined in Tables 1 and 2.

Clause 2: An aircraft is provided including a fuselage; an airfoil extending from the fuselage, the airfoil having an airfoil section with a leading edge (LE) and a trailing edge (TE), a chord extending between the LE and TE, and an effective quarter chord point (QC) along the chord measured from the LE; an unducted fan propulsor mounted relative to the airfoil section on a high pressure side thereof, the unducted fan propulsor having a centerline (CL) and a plurality of blades arranged in one or more arrays, each of the blades having a root and the plurality of blades defining a maximum outer diameter (D), the unducted fan propulsor having a point (P) defined as one of: (a) wherein the plurality of blades is arranged in a single array, the point P is located at an intersection of the CL and a line perpendicular to the CL that passes through a midpoint between edges at the root of one of the plurality of blades, and (b) wherein the plurality of blades is arranged in a forward array and a rearward array, the point P is located at an intersection of the CL and midpoint between a rearward trailing edge (TE) of the rearward array and leading edge (LE) of the forward array when a blade of the forward and rearward arrays are aligned with each other; and a positioning line (R) having a length (RL) and extending from the QC to the point P of the unducted fan propulsor and at an angle θ as measured from a vector from the QC to the TE of the airfoil section to the line R, where, when viewed with the LE to the left of TE, a positive θ (1) increases in a counter-clockwise direction when the high pressure side of the airfoil section is below the airfoil section, and (2) increases in a clockwise direction when the high pressure side of the airfoil section is above the airfoil section, and wherein 0.065<RL/D<1.98 and θ is between 187° and 340°, and wherein RL/D and θ of the P of the unducted fan propulsor adhere to the following expressions:

$$\frac{RL}{D} + \frac{( \begin{matrix}\sqrt{\begin{matrix}1.4161 * [ 1.88978 * {sin}^{2} ( θ ) - 0.0875 * {cos}^{2} ( θ ) + \\ 0.477 * sin ( θ ) * cos ( θ ) ]\end{matrix}} \\ 1.764 * sin ( θ ) + 0.19146 * cos ( θ )\end{matrix} )}{1.96 * {sin}^{2} ( θ ) + 0.7225 * {cos}^{2} ( θ )} > 0$$

$$and$$

$$\frac{RL}{D} + \frac{( \begin{matrix}- \sqrt{\begin{matrix}1.4161 * [ 1.88978 * {sin}^{2} ( θ ) - 0.0875 * {cos}^{2} ( θ ) + \\ 0.477 * sin ( θ ) * cos ( θ ) ]\end{matrix}} \\ 1.764 * sin ( θ ) + 0.19146 * cos ( θ )\end{matrix} )}{1.96 * {sin}^{2} ( θ ) + 0.7225 * {cos}^{2} ( θ )} < 0.$$

In the preceding clause, 0.254<RL/D<1.86 and θ is between 199° and 306°, and the P of the unducted fan propulsor is defined by the following expressions:

$$\frac{R L}{D} + \frac{( - \sqrt{0.52 621 * [ 0.7205 * {sin}^{2} ( θ ) - 0.352 * {cos}^{2} ( θ ) + 0.7448 * sin ( θ ) * cos ( θ ) ]} + 0.8476 * sin ( θ ) + 0.23119 * cos ( θ ) )}{0.8649 * {sin}^{2} ( θ ) + 0.6084 * {cos}^{2} ( θ )} > 0$$

$$and$$

$$\frac{R L}{D} + \frac{( - \sqrt{0.52 621 * [ 0.7205 * {sin}^{2} ( θ ) - 0.352 * {cos}^{2} ( θ ) + 0.7448 * sin ( θ ) * cos ( θ ) ]} + 0.8476 * sin ( θ ) + 023119 * cos ( θ ) )}{0.8649 * {sin}^{2} ( θ ) + 0.6084 * {cos}^{2} ( θ )} < 0.$$

In any of the two preceding clauses, 0.369<RL/D<1.43 and θ is between 2040 and 291°, and the P of the unducted fan propulsor is defined by the following expressions:

$$\frac{R L}{D} + \frac{( - \sqrt{0.52 621 * [ 0.7205 * {sin}^{2} ( θ ) - 0.352 * {cos}^{2} ( θ ) + 0.7448 * sin ( θ ) * cos ( θ ) ]} + 0.8476 * sin ( θ ) + 0.23119 * cos ( θ ) )}{0.8649 * {sin}^{2} ( θ ) + 0.6084 * {cos}^{2} ( θ )} > 0$$

$$and$$

$$\frac{R L}{D} + \frac{( - \sqrt{0.52 621 * [ 0.7205 * {sin}^{2} ( θ ) - 0.352 * {cos}^{2} ( θ ) + 0.7448 * sin ( θ ) * cos ( θ ) ]} + 0.8476 * sin ( θ ) + 023119 * cos ( θ ) )}{0.8649 * {sin}^{2} ( θ ) + 0.6084 * {cos}^{2} ( θ )} < 0.$$

In any of the three-preceding clauses: 0.47<RL/D<0.9455 and is between 211° and 274°, and the P of the unducted fan propulsor is defined by the following expressions:

$$\frac{R L}{D} + \frac{( \sqrt{0.01069156 * [ 0.036 * {sin}^{2} ( θ ) - 0.3485 * {cos}^{2} ( θ ) + 0.5418 * sin ( θ ) * cos ( θ ) ]} + 0.139167 * sin ( θ ) + 0.020812 * cos ( θ ) )}{0.2209 * {sin}^{2} ( θ ) + 0.0484 * {cos}^{2} ( θ )} > 0$$

$$and$$

$$\frac{R L}{D} + \frac{( - \sqrt{0.01069156 * [ 0.036 * {sin}^{2} ( θ ) - 0.3485 * {cos}^{2} ( θ ) + 0.5418 * sin ( θ ) * cos ( θ ) ]} + 0.139167 * sin ( θ ) + 0.020812 * cos ( θ ) )}{0.2209 * {sin}^{2} ( θ ) + 0.0484 * {cos}^{2} ( θ )} < 0.$$

In any of the four preceding clauses, the unducted fan propulsor is undermounted to the airfoil, such as a wing, with one or more intermediate structures.

In any of the preceding clauses, the unducted fan propulsor has a cruise flight Mach M₀ of between 0.70 and 0.85, between 0.5 and 0.9, between 0.7 and 0.9, or between 0.75 and 0.9.

Clause 3: An aircraft is provided that includes a fuselage; an airfoil extending from the fuselage, the airfoil having an airfoil section with a leading edge (LE) and a trailing edge (TE), a chord extending between the LE and TE, and an effective quarter chord point (QC) along the chord measured from the LE; an unducted fan propulsor mounted relative to the airfoil section on a high pressure side thereof, the unducted fan propulsor having a centerline (CL) and a plurality of blades arranged in one or more arrays, each of the blades having a root and the plurality of blades defining a maximum outer diameter (D), the unducted fan propulsor having a point (P) defined as one of: (a) wherein the plurality of blades is arranged in a single array, the point P is located at an intersection of the CL and a line perpendicular to the CL that passes through a midpoint between edges at the root of one of the plurality of blades, and (b) wherein the plurality of blades is arranged in a forward array and a rearward array, the point P is located at an intersection of the CL and midpoint between a rearward trailing edge (TE) of the rearward array and leading edge (LE) of the forward array when a blade of the forward and rearward arrays are aligned with each other; and a positioning line (R) having a length (RL) and extending from the QC to the point P of the unducted fan propulsor and at an angle θ as measured from a vector from the QC to the TE of the airfoil section to the line R, where, when viewed with the LE to the left of TE, a positive θ (1) increases in a counter-clockwise direction when the high pressure side of the airfoil section is below the airfoil section, and (2) increases in a clockwise direction when the high pressure side of the airfoil section is above the airfoil section, and wherein RL/D≤2 and θ is between 187° and 342°.

In any of the preceding clauses, 0.15≤RL/D.

In any of the preceding clauses, 0.35≤RL/D, and preferably RL/D is about 0.72.

In any of the preceding clauses, wherein θ is between 198° and 310°, and preferably between 205° and 285°.

In any of the preceding clauses, the unducted fan propulsor operates at a cruise flight Mach M₀ of between 0.5 and 0.9, preferably between 0.7 and 0.9, and more preferably between 0.75 and 0.9.

In any of the preceding clauses, the unducted fan propulsor has a dimensionless cruise fan net thrust parameter expressed as follows:

$$0.15 > \frac{{F}_{n e t}}{{ρ}_{0} {A}_{a n} {V}_{0}^{2}} > 0.06 ,$$

wherein Fₙₑₜ is cruise fan net thrust, ρ₀ is ambient air density, Vₒ is cruise flight velocity, and Aₐₙ is annular cross-sectional area perpendicular to an axis of rotation of a rotor axis of rotation.

In any of the preceding clauses, the unducted fan propulsor is undermounted to the airfoil with one or more intermediate structures.

In any of the foregoing clauses, the P of the unducted fan propulsor is variable to accommodate different operating conditions.

In any of the preceding clauses, the aircraft includes a plurality of the unducted fan propulsors.

In the preceding clause, the plurality of the unducted fan propulsors may be each mounted to the same airfoil, such as a wing or horizontal stabilizer; or the plurality of the unducted fan propulsors may be each mounted to different airfoils, such as a wing or horizontal stabilizer; or combinations thereof.

In any of the preceding clauses, wherein the unducted propulsor has two arrays of blades and only one of the array of blades is rotating.

Clause 4: An aircraft is provided that includes a fuselage; an airfoil extending from the fuselage, the airfoil having an airfoil section defining an effective quarter chord point (QC); an unducted fan propulsor mounted relative to the airfoil section on a high pressure side thereof, the unducted fan propulsor having a centerline (CL), a plurality of counterclockwise rotating blades arranged in a forward array and a plurality clockwise rotating blades arranged in a rearward array, wherein one of the forward and rearward array of blades define a maximum outer diameter (D); a point (P) located at the intersection of the CL and a midpoint (TRL) between a rearward trailing edge nearest a root of a blade of the rearward array and a leading edge nearest a root of a blade of the forward array when the forward leading edge and rearward trailing edge of the respective blades are aligned with each other; and an ellipse origin positioning line (EOR) having a length (EORL) extending from the QC to an ellipse origin (OR) at an angle θ measured positive in a counter-clockwise direction when the high pressure side of the airfoil section is below the airfoil section, and measured positive in a clockwise direction when the high pressure side of the airfoil section is above the airfoil section; wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7.

Clause 5: An aircraft is provided that includes a fuselage; an airfoil extending from the fuselage, the airfoil having an airfoil section and the airfoil section having an effective quarter chord point (QC), and a plurality of rotating blades defining a maximum outer diameter (D); a point (P) located at an intersection of the CL and a line perpendicular to the CL that passes through a midpoint between leading and trailing edges nearest the root of one of the plurality of blades, and an ellipse origin positioning line (EOR) having a length (EORL) extending from the QC to an ellipse origin (OR) and at an angle θ measured positive in a counter-clockwise direction when the high pressure side of the airfoil section is below the airfoil section, and measured positive in a clockwise direction when the high pressure side of the airfoil section is above the airfoil section, and wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7.

Clause 6: An aircraft is provided that includes a fuselage; an airfoil extending from the fuselage, the airfoil having an airfoil section defining an effective quarter chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at the intersection of the CL and a midpoint (TRL) between a rearward trailing edge nearest a root of a blade of the rearward array and a leading edge nearest a root of a blade of the forward array when the forward leading edge and rearward trailing edge of the respective blades are aligned with each other; and a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section; wherein 0.065<RL/D<1.98 and θ is between 187° and 340°; and wherein RL/D and θ of the P of the unducted fan propulsor adhere to the following expressions:

$$\frac{R L}{D} + \frac{( \sqrt{1.4161 * [ 1.88978 * {sin}^{2} ( θ ) - 0.0875 * {cos}^{2} ( θ ) + 0.477 * sin ( θ ) * cos ( θ ) ]} + 1.764 * sin ( θ ) + 0.19146 * cos ( θ ) )}{1.96 * {sin}^{2} ( θ ) + 0.7225 * {cos}^{2} ( θ )} > 0$$

$$and$$

$$\frac{R L}{D} + \frac{( - \sqrt{1.4161 * [ 1.88978 * {sin}^{2} ( θ ) - 0.0875 * {cos}^{2} ( θ ) + 0.477 * sin ( θ ) * cos ( θ ) ]} + 1.764 * sin ( θ ) + 0.19146 * cos ( θ ) )}{1.96 * {sin}^{2} ( θ ) + 0.7225 * {cos}^{2} ( θ )} < 0.$$

The aircraft of Clause 6, wherein:
0.254<RL/D<1.86 and θ is between 199° and 306°, and
the P of the unducted fan propulsor is defined by the following expressions:

$$\frac{R L}{D} + \frac{( \sqrt{0.52 621 * [ 0.7205 * {sin}^{2} ( θ ) - 0.352 * {cos}^{2} ( θ ) + 0.7448 * sin ( θ ) * cos ( θ ) ]} + 0.8476 * sin ( θ ) + 0.23119 * cos ( θ ) )}{0.8649 * {sin}^{2} ( θ ) + 0.6084 * {cos}^{2} ( θ )} > 0$$

$$and$$

$$\frac{R L}{D} + \frac{( - \sqrt{0.52 621 * [ 0.7205 * {sin}^{2} ( θ ) - 0.352 * {cos}^{2} ( θ ) + 0.7448 * sin ( θ ) * cos ( θ ) ]} + 0.8476 * sin ( θ ) + 0.23119 * cos ( θ ) )}{0.8649 * {sin}^{2} ( θ ) + 0.6084 * {cos}^{2} ( θ )} < 0$$

The aircraft of Clause 6, wherein:
0.369<RL/D<1.43 and θ is between 204° and 291°, and
the P of the unducted fan propulsor is defined by the following expressions:

$$\frac{R L}{D} + \frac{( \sqrt{0.09923 * [ 0.2964 * {sin}^{2} ( θ ) - 0.36 * {cos}^{2} ( θ ) + 0.66 * sin ( θ ) * cos ( θ ) ]} + 0.3675 * sin ( θ ) + 0.0891 * cos ( θ ) )}{0.49 * {sin}^{2} ( θ ) + 0.2025 * {cos}^{2} ( θ )} > 0$$

$$and$$

$$\frac{R L}{D} + \frac{( \sqrt{0.09923 * [ 0.2964 * {sin}^{2} ( θ ) - 0.36 * {cos}^{2} ( θ ) + 0.66 * sin ( θ ) * cos ( θ ) ]} + 0.3675 * sin ( θ ) + 0.0891 * cos ( θ ) )}{0.49 * {sin}^{2} ( θ ) + 0.2025 * {cos}^{2} ( θ )} < 0$$

The aircraft of Clause 6, wherein:
0.477<RL/D<0.9455 and θ is between 211° and 274°, and
the P of the unducted fan propulsor is defined by the following expressions:

$$\frac{R L}{D} + \frac{( \sqrt{0.01069156 * [ 0.036 * {sin}^{2} ( θ ) - 0.3485 * {cos}^{2} ( θ ) + 0.5418 * sin ( θ ) * cos ( θ ) ]} + 0.139167 * sin ( θ ) + 0.020812 * cos ( θ ) )}{0.2209 * {sin}^{2} ( θ ) + 0.0484 * {cos}^{2} ( θ )} > 0$$

$$and$$

$$\frac{R L}{D} + \frac{( - \sqrt{0.01069156 * [ 0.036 * {sin}^{2} ( θ ) - 0.3485 * {cos}^{2} ( θ ) + 0.5418 * sin ( θ ) * cos ( θ ) ]} + 0.139167 * sin ( θ ) + 0.020812 * cos ( θ ) )}{0.2209 * {sin}^{2} ( θ ) + 0.0484 * {cos}^{2} ( θ )} < 0.$$

The aircraft of Clause 6, wherein the unducted fan propulsor is undermounted to the airfoil with one or more intermediate structures.

The aircraft of Clause 6, wherein the P of the unducted fan propulsor is variable to accommodate different operating conditions.

Clause 7: An aircraft is provided that includes a fuselage; an airfoil extending from the fuselage, the airfoil having an airfoil section defining an effective quarter chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at the intersection of the CL and a midpoint (TRL) between a rearward trailing edge nearest a root of a blade of the rearward array and a leading edge nearest a root of a blade of the forward array when the forward leading edge and rearward trailing edge of the respective blades are aligned with each other; and a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section; wherein RL/D≤2 and θ is between 187° and 342°.

The aircraft of Clause 7, wherein 0.15≤RL/D.

The aircraft of Clause 7, wherein 0.35≤RL/D, and preferably RL/D is about 0.72.

The aircraft of Clause 7, wherein θ is between 198° and 310°, and preferably between 205° and 285°.

The aircraft of Clause 7, wherein the unducted fan propulsor operates at a cruise flight Mach M₀ of between 0.5 and 0.9, preferably between 0.7 and 0.9, and more preferably between 0.75 and 0.9.

The aircraft of Clause 7, wherein the unducted fan propulsor has a dimensionless cruise fan net thrust parameter expressed as follows:

$$0.15 > \frac{{F}_{n e t}}{{ρ}_{0} {A}_{a n} {V}_{0}^{2}} > 0.06 ,$$

wherein Fₙₑₜ is cruise fan net thrust, ρ₀ is ambient air density, Vₒ is cruise flight velocity, and Aₐₙ is annular cross-sectional area perpendicular to an axis of rotation of a rotor axis of rotation.

The aircraft of Clause 7, wherein the unducted fan propulsor is undermounted to the airfoil with one or more intermediate structures.

The aircraft of Clause 7, wherein the P of the unducted fan propulsor is variable to accommodate different operating conditions.

Clause 8: A method of assembly, comprising: using an aircraft body comprising a fuselage and an airfoil extending from the fuselage, wherein the airfoil has an airfoil section defining an effective quarter chord point (QC); and attaching an unducted fan propulsor to the aircraft body relative to the airfoil section on a high pressure side thereof; the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at the intersection of the CL and a line HP perpendicular to the axial centerline CL that passes through the axial midpoint between a rearward trailing edge at a root of a blade of the rearward array and a forward leading edge at a root of a blade of the forward array when the forward leading edge and rearward trailing edge of the respective blades are aligned with each other; and a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section, when viewed looking from an outboard position towards an inboard position; wherein 0.07≤RL/D≤2.0 and θ is between 1870 and 342.°.

The method of Clause 8, wherein 0.15≤RL/D.

The method of Clause 8, wherein 0.35≤RL/D, and preferably RL/D is about 0.72.

The method of Clause 8, wherein θ is between 198° and 310°, and preferably between 205° and 285°.

The method of Clause 8, wherein the unducted fan propulsor operates at a cruise flight Mach M₀ of between 0.5 and 0.9, preferably between 0.7 and 0.9, and more preferably between 0.75 and 0.9.

The method of Clause 8, wherein the unducted fan propulsor has a dimensionless cruise fan net thrust parameter expressed as follows:

$$0.15 > \frac{{F}_{n e t}}{{ρ}_{0} {A}_{a n} {V}_{0}^{2}} > 0.06 ,$$

wherein Fₙₑₜ is cruise fan net thrust, ρ₀ is ambient air density, Vₒ is cruise flight velocity, and Aₐₙ is annular cross-sectional area perpendicular to an axis of rotation of a rotor axis of rotation.

The method of Clause 8, wherein the unducted fan propulsor is undermounted to the airfoil with one or more intermediate structures.

The method of Clause 8, wherein the P of the unducted fan propulsor is variable to accommodate different operating conditions.

Clause 9: A method of assembly, comprising: using an aircraft body comprising a fuselage and an airfoil extending from the fuselage, the airfoil having an airfoil section with a leading edge (LE) and a trailing edge (TE), a chord extending between the LE and TE, and an effective quarter chord point (QC) along the chord measured from the LE, wherein the airfoil has an airfoil section defining an effective quarter chord point (QC); and attaching an unducted fan propulsor to the aircraft body relative to the airfoil section on a high pressure side thereof, the unducted fan propulsor having a centerline (CL) and a plurality of blades arranged in one or more arrays, each of the blades having a root and the plurality of blades defining a maximum outer diameter (D), the unducted fan propulsor having a point (P) defined as one of: (a) wherein the plurality of blades is arranged in a single array, the point P is located at an intersection of the CL and a line perpendicular to the CL that passes through a midpoint between edges at the root of one of the plurality of blades, and (b) wherein the plurality of blades is arranged in a forward array and a rearward array, the point P is located at an intersection of the CL and midpoint between a rearward trailing edge (TE) of the rearward array and leading edge (LE) of the forward array when a blade of the forward and rearward arrays are aligned with each other; and an ellipse origin positioning line (EOR) having a length (EORL) extending from the QC to an ellipse origin (OR) and at an angle θ as measured from a vector from the QC to the TE of the airfoil section to the line EOR, where, when viewed with the LE to the left of TE, a positive θ (1) increases in a counter-clockwise direction when the high pressure side of the airfoil section is below the airfoil section, and (2) increases in a clockwise direction when the high pressure side of the airfoil section is above the airfoil section, and wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7.

The method of Clause 9, wherein the P of the unducted fan propulsor is located in a second ellipse having a second major axis length (2MajAL) and a second minor axis length (2MinAL) with a second ellipse origin defined by EORL/D of 1.051 and θ of 248.8°, and where 2MajAL/D is 1.86 and 2MinAL/D is 1.56.

The method of Clause 9, wherein the P of the unducted fan propulsor is located in a third ellipse having a third major axis length (3MajAL) and a third minor axis length (3MinAL) with a third ellipse origin defined by EORL/D of 0.870 and θ of 239.6°, where 3MajAL/D is 1.4 and 3MinAL/D is 0.9.

The method of Clause 9, wherein the P of the unducted fan propulsor is located in a fourth ellipse having a fourth major axis length (4MajAL) and a fourth minor axis length (4MinAL) with a fourth ellipse origin defined by EORL/D of 0.763 and θ of 235.7°, and where 4MajAL/D is 0.94 and 4MinAL/D is 0.44.

Clause 10: An aircraft comprising: a fuselage; a pair of wings extending from the fuselage, two or more unducted fan propulsors, each of the unducted fan propulsors is mounted relative to one of the wings on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and an airfoil section having an effective quarter chord point QC; a positioning line (R) having a length (RL) and extending from the QC to the point P of the unducted fan propulsor at an angle θ measured positive in a counter-clockwise direction when the high pressure side of the airfoil section is below the airfoil section when viewed looking from an outboard position towards an inboard position of the wing; wherein 0.07≤RL/D≤2.0 and θ is between 187° and 342°.

Clause 11: An aircraft comprising: a fuselage; a pair of horizontal stabilizers extending relative to the fuselage, two or more unducted fan propulsors, each of the unducted fan propulsors is mounted relative to one of the horizontal stabilizers on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and an airfoil section having an effective quarter chord point QC; a positioning line (R) having a length (RL) and extending from the QC to the point P of the unducted fan propulsor at an angle θ measured positive in a clockwise direction when the high pressure side of the airfoil section is above the airfoil section when viewed looking from an outboard position towards an inboard position of the wing; wherein 0.07≤RL/D≤2.0 and θ is between 187° and 342°.

In any of the preceding clauses, the unducted fan propulsor is undermounted to the airfoil, such as a wing, with one or more intermediate structures.

In any of the preceding clauses, the P of the unducted fan propulsor is variable to accommodate different operating conditions.

In any of the preceding clauses the drive mechanism may be a gas turbine engine and associated transmission to delivers torque from the drive mechanism to the propeller assembly.

In any of the preceding clauses, the unducted fan propulsor is incorporated into an airplane or other aircraft having a cruise flight Mach M₀ of between 0.70 and 0.85, between 0.75 and 0.85, between 0.75 and 0.79, between 0.5 and 0.9, between 0.7 and 0.9, or between 0.75 and 0.9.

In any of the preceding clauses, the unducted fan propulsors is connected to the wing (or horizontal stabilizer) through a pylon.

In any of the preceding clauses, the rotating blades diameter (D) may be between 8 to 16 feet or 12 to 16 feet.

In any of the preceding clauses, each of the propulsors including a drive mechanism comprising a gas turbine engine assembly comprising in serial order a compressor, combustor, high pressure turbine and power turbine.

In any of the preceding clauses, the propulsor having a pitch angle between −5 and +5 degrees, or −3 and 0 degrees.

In any of the preceding clauses, the propulsor having an inward toe angle of between 0 and 5 degrees, or 1 and 3 degrees.

In any of the preceding clauses, the rotating blades diameter is between 8 to 16 feet or between 12 to 16 feet.

In any of the preceding clauses, the aircraft having a wing defining the airfoil and one or two unducted fan propulsors are mounted to the wing.

In any of the preceding clauses, wherein the aircraft are aircraft types A, B, C or G as defined in Tables 1 and 2.

A gas turbine engine includes a turbomachine including a compressor section, a combustion section, and a turbine section arranged in serial flow order, the turbomachine defining an engine inlet to an inlet duct, a fan duct inlet to a fan duct, and a core inlet to a core duct, a primary fan driven by the turbomachine, a secondary fan located downstream of the primary fan within the inlet duct, the gas turbine engine defining a thrust to power airflow ratio between 3.5 and 100 and a core bypass ratio between 0.1 and 10, wherein the thrust to power airflow ratio is a ratio of an airflow through a bypass passage over the turbomachine plus an airflow through the fan duct to an airflow through the core duct, and wherein the core bypass ratio is a ratio of the airflow through the fan duct to the airflow through the core duct, and a booster located downstream of the secondary fan and including a booster rotor blade, an inlet guide vane, a booster cowl, a strut, and a stem extending through the booster cowl, the booster cowl separating an upstream portion of the fan duct into an upper fan duct having an upper fan duct inlet and a lower fan duct having a lower fan duct inlet, the upper fan duct inlet and lower fan duct inlet collectively forming the fan duct inlet, the inlet guide vane located forward of the booster rotor blade, wherein the strut secures the booster cowl to the engine inlet.

The gas turbine engine of any of the preceding clauses, wherein the stem is spaced upstream from the strut.

The gas turbine engine of any of the preceding clauses, wherein the stem is integral with the strut.

The gas turbine engine of any of the preceding clauses, wherein the stem is disposed inside the strut.

The gas turbine engine of any of the preceding clauses, further including a fan cowl, wherein the stem extends from the booster cowl to the fan cowl.

The gas turbine engine of any of the preceding clauses, wherein the inlet guide vane is rotatable about a pitch axis to a specified pitch angle.

The gas turbine engine of any of the preceding clauses, further including an outlet guide vane disposed upstream of the booster, wherein the outlet guide vane is rotatable about a pitch axis to a specified pitch angle.

The gas turbine engine of any of the preceding clauses, wherein the outlet guide vane and the inlet guide vane are integral.

The gas turbine engine of any of the preceding clauses, wherein the outlet guide vane has a first cross-sectional area, the inlet guide vane has a second cross-sectional area, and the first cross-sectional area differs from the second cross-sectional area.

The gas turbine engine of any of the preceding clauses, further including a fan cowl, wherein the outlet guide vane extends from the fan cowl.

The gas turbine engine of any of the preceding clauses, further including an actuator configured to rotate the inlet guide vane about a pitch axis.

The gas turbine engine of any of the preceding clauses, wherein the inlet guide vane is rotatably fixed to the stem, the pitch axis extends through the stem, and the actuator is configured to rotate the stem.

The gas turbine engine of any of the preceding clauses, wherein the inlet guide vane extends radially inward from the booster cowl through the engine inlet.

The gas turbine engine of any of the preceding clauses, wherein the inlet guide vane is disposed inward of the booster cowl and extends inwardly from the booster cowl.

The gas turbine engine of any of the preceding clauses, wherein the booster includes a trailing edge disposed in the fan duct.

A method of operating a gas turbine engine includes operating the gas turbine engine at a rated speed, wherein operating the gas turbine engine at the rated speed includes operating the gas turbine engine to define a thrust to power airflow ratio between 3.5 and 100 and a core bypass ratio between 0.1 and 5, wherein the thrust to power airflow ratio is a ratio of an airflow through a bypass passage over a turbomachine of the gas turbine engine plus an airflow through a fan duct to an airflow through a core duct, and wherein the core bypass ratio is a ratio of the airflow through the fan duct to the airflow through the core duct, rotating an inlet guide vane of a booster to direct an inner stream of air to a core cowl, and splitting the inner stream of air at the core cowl into a fan stream flowing into the fan duct and a core stream flowing into the core duct.

The method of any of the preceding clauses, further including actuating an actuator to rotate a stem that is rotatably fixed to the inlet guide vane.

The method of any of the preceding clauses, further including rotating an outlet guide vane disposed upstream of the booster to direct a stream of air to the booster.

The method of any of the preceding clauses, further including splitting the stream of air at the booster into the inner stream of air flowing toward the core duct and an outer stream of air flowing toward the fan duct.

A gas turbine engine includes a turbomachine including a compressor section, a combustion section, and a turbine section arranged in serial flow order, the turbomachine defining an engine inlet to an inlet duct, a fan duct inlet to a fan duct, and a core inlet to a core duct, a primary fan driven by the turbomachine, a secondary fan located downstream of the primary fan within the inlet duct, and a booster located downstream of the secondary fan and including a booster rotor blade, an inlet guide vane, and booster cowl, the booster cowl separating an upstream portion of the fan duct into an upper fan duct having an upper fan duct inlet and a lower fan duct having a lower fan duct inlet, the upper fan duct inlet and lower fan duct inlet collectively forming the fan duct inlet, the inlet guide vane located forward of the booster rotor blade.

The gas turbine engine of any preceding clause, wherein the primary fan, the secondary fan, the compressor section, the combustion section, and the turbine section are arranged in serial flow order.

A gas turbine engine comprising: a turbomachine comprising a compressor section, a combustion section, and a turbine section arranged in serial flow order, the turbomachine defining an engine inlet to an inlet duct, a fan duct inlet to a fan duct, and a core inlet to a core duct; a primary fan driven by the turbomachine; a secondary fan located downstream of the primary fan within the inlet duct, the gas turbine engine defining a thrust to power airflow ratio (TPAR) between 3.5 and 100 and a core bypass ratio (CBR) between 0.1 and 10, wherein the TPAR is a ratio of an airflow through a bypass passage over the turbomachine plus an airflow through the fan duct to an airflow through the core duct, and wherein the CBR is a ratio of the airflow through the fan duct to the airflow through the core duct; and a booster located downstream of the secondary fan and comprising a booster rotor blade and a booster cowl, the booster cowl separating an upstream portion of the fan duct into an upper fan duct having an upper fan duct inlet and a lower fan duct having a lower fan duct inlet, the upper fan duct inlet and lower fan duct inlet collectively forming the fan duct inlet, the gas turbine engine defining a booster bleed ratio (BBR), wherein the BBR is a ratio of an airflow through the lower fan duct inlet to the airflow through the core duct, and wherein BBR is less than or equal to an upper range of 0.005625×TPAR+0.2375, and greater than or equal to a lower range of 0.001125×TPAR+0.00977.

The gas turbine engine of any of the preceding clauses, wherein the primary fan is an unducted fan, and wherein TPAR is greater than or equal to 30.

The gas turbine engine of any of the preceding clauses, wherein the thrust to power airflow ratio is between 35 and 50.

The gas turbine engine of any of the preceding clauses, wherein TPAR is less than or equal to 20.

The gas turbine engine of any of the preceding clauses, wherein the lower fan duct is a fixed flowpath lower fan duct, and wherein BBR is closer to the upper range than the lower range.

The gas turbine engine of any of the preceding clauses, wherein BBR is greater than 0.20 and less than 0.7.

The gas turbine engine of any of the preceding clauses, wherein the lower fan duct is a variable flowpath lower fan duct, and wherein BBR is closer to the lower range than the upper range.

The gas turbine engine of any of the preceding clauses, wherein BBR is greater than 0.05 and less than 0.2.

The gas turbine engine of any of the preceding clauses, further comprising: a flow blocker operable with the variable flowpath lower fan duct for affecting an amount of airflow through the variable flowpath lower fan duct during operation of the gas turbine engine.

The gas turbine engine of any of the preceding clauses, wherein the flow blocker is coupled to the booster cowl, at least partially integrated into the booster cowl, or both.

The gas turbine engine of any of the preceding clauses, further comprising: an inlet guide vane positioned in the variable flowpath lower fan duct, upstream of the secondary fan, or downstream of the booster rotor blade and upstream of the variable flowpath lower fan duct; and an actuator configured to rotate the inlet guide vane about a pitch axis.

The gas turbine engine of any of the preceding clauses, wherein the core bypass ratio is between 0.3 and 5.

The gas turbine engine of any of the preceding clauses, wherein the secondary fan is a single stage secondary fan.

The gas turbine engine of any of the preceding clauses, wherein the secondary fan is a multi-stage secondary fan.

The gas turbine engine of any of the preceding clauses, wherein the multi-stage secondary fan is a two stage secondary fan.

A method of operating a gas turbine engine, the method comprising: operating the gas turbine engine at a rated speed, wherein operating the gas turbine engine at the rated speed comprises operating the gas turbine engine to define a thrust to power airflow ratio between 3.5 and 100 and a core bypass ratio between 0.1 and 5, wherein the thrust to power airflow ratio is a ratio of an airflow through a bypass passage over a turbomachine of the gas turbine engine plus an airflow through a fan duct to an airflow through a core duct, and wherein the core bypass ratio is a ratio of the airflow through the fan duct to the airflow through the core duct, wherein operating the gas turbine engine at the rated speed further comprises operating the gas turbine engine to define a booster bleed ratio (BBR), wherein the BBR is a ratio of an airflow through a lower fan duct inlet to the airflow through the core duct, wherein the gas turbine engine comprises a booster located downstream of a secondary fan and comprising a booster rotor blade and a booster cowl, the booster cowl separating an upstream portion of the fan duct into an upper fan duct having an upper fan duct inlet and a lower fan duct having the lower fan duct inlet, the upper fan duct inlet and lower fan duct inlet collectively forming a fan duct inlet of the fan duct, and wherein BBR is less than or equal to an upper range of 0.005625×TPAR+0.2375, and greater than or equal to a lower range of 0.001125×TPAR+0.00977.

The method of any of the preceding clauses, wherein the primary fan is an unducted fan, and wherein TPAR is greater than or equal to 30.

The method of any of the preceding clauses, wherein the lower fan duct is a fixed flowpath lower fan duct, and wherein BBR is closer to the upper range than the lower range.

An aircraft comprising: a fuselage; a pair of wings extending from the fuselage, two or more unducted fan propulsors, each of the unducted fan propulsors is mounted relative to one of the wings on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; an airfoil section having an effective quarter chord point QC; a positioning line (R) having a length (RL) and extending from the QC to the point P of the unducted fan propulsor at an angle θ measured positive in a counter-clockwise direction when the high pressure side of the airfoil section is below the airfoil section when viewed looking from an outboard position towards an inboard position of the wing; wherein 0.07≤RL/D≤2.0 and θ is between 187° and 342°; and wherein at least one of the unducted fan propulsors includes: a turbomachine comprising a compressor section, a combustion section, and a turbine section arranged in serial flow order, the turbomachine defining an engine inlet to an inlet duct, a fan duct inlet to a fan duct, and a core inlet to a core duct; a primary fan driven by the turbomachine, wherein the primary fan includes the rotating blades; a secondary fan located downstream of the primary fan within the inlet duct, the gas turbine engine defining a thrust to power airflow ratio (TPAR) between 3.5 and 100 and a core bypass ratio (CBR) between 0.1 and 10, wherein the TPAR is a ratio of an airflow through a bypass passage over the turbomachine plus an airflow through the fan duct to an airflow through the core duct, and wherein the CBR is a ratio of the airflow through the fan duct to the airflow through the core duct; and a booster located downstream of the secondary fan and comprising a booster rotor blade and a booster cowl, the booster cowl separating an upstream portion of the fan duct into an upper fan duct having an upper fan duct inlet and a lower fan duct having a lower fan duct inlet, the upper fan duct inlet and lower fan duct inlet collectively forming the fan duct inlet, the gas turbine engine defining a booster bleed ratio (BBR), wherein the BBR is a ratio of an airflow through the lower fan duct inlet to the airflow through the core duct, and wherein BBR is less than or equal to an upper range of 0.005625×TPAR+0.2375, and greater than or equal to a lower range of 0.001125×TPAR+0.00977.

The aircraft of the preceding clause, wherein 0.15≤RL/D.

The aircraft of any of the two the preceding clauses, wherein 0.35≤RL/D, and preferably RL/D is about 0.72.

The aircraft of any of the three the preceding clauses, wherein θ is between 198° and 310°, and preferably between 205° and 285°.

The aircraft of any of the four the preceding clauses, wherein the two or more unducted fan propulsors are configured to operate at a cruise flight Mach M₀ of between 0.7 and 0.9, and more preferably between 0.75 and 0.9; or the two or more unducted fan propulsors are configured to propel the aircraft at a cruise flight Mach M₀ of between 0.7 and 0.9, and more preferably between 0.75 and 0.85.

The aircraft of any of the five the preceding clauses, wherein the unducted fan propulsor has a dimensionless cruise fan net thrust parameter expressed as follows:

$$0.15 > \frac{{F}_{n e t}}{{ρ}_{0} {A}_{a n} {V}_{0}^{2}} > 0.06 ,$$

wherein Fₙₑₜ is cruise fan net thrust, ρ₀ is ambient air density, Vₒ is cruise flight velocity, and Aₐₙ is annular cross-sectional area perpendicular to an axis of rotation of a rotor axis of rotation.

The aircraft of any of the six the preceding clauses, wherein the unducted fan propulsor is undermounted to the airfoil with one or more intermediate structures.

The aircraft of any of the seven the preceding clauses, wherein the P of the unducted fan propulsor is variable to accommodate different operating conditions.

The aircraft of any of the eight preceding clauses, wherein the aircraft is configured to operate with a variable bleed valve at least partially opened during a takeoff operating condition, wherein a power gearbox coupling a low pressure shaft to the primary fan has a gear ratio of greater than 6:1; wherein the variable bleed valve is opened to cause from 1-5%, 5-10%, 10-20%, or greater than 30% of the airflow passing through the booster to be diverted from a core stream and sent through a third stream or a fourth stream, and wherein there is reduced introduction of airborne solids into the core stream as compared to if the variable bleed valve were closed during the takeoff operating condition.

An aircraft, comprising: a fuselage; an airfoil extending from the fuselage, the airfoil having an airfoil section defining an effective quarter chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; an ellipse origin positioning line (EOR) having a length (EORL) extending from the QC to an ellipse origin (OR) at an angle θ measured positive in a counter-clockwise direction when the high pressure side of the airfoil section is below the airfoil section, and measured positive in a clockwise direction when the high pressure side of the airfoil section is above the airfoil section, when viewed looking for an outboard position towards an inboard position; wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7; and wherein the unducted fan propulsor includes: a turbomachine comprising a compressor section, a combustion section, and a turbine section arranged in serial flow order, the turbomachine defining an engine inlet to an inlet duct, a fan duct inlet to a fan duct, and a core inlet to a core duct; a primary fan driven by the turbomachine, wherein the primary fan includes the rotating blades; a secondary fan located downstream of the primary fan within the inlet duct, the gas turbine engine defining a thrust to power airflow ratio (TPAR) between 3.5 and 100 and a core bypass ratio (CBR) between 0.1 and 10, wherein the TPAR is a ratio of an airflow through a bypass passage over the turbomachine plus an airflow through the fan duct to an airflow through the core duct, and wherein the CBR is a ratio of the airflow through the fan duct to the airflow through the core duct; and a booster located downstream of the secondary fan and comprising a booster rotor blade and a booster cowl, the booster cowl separating an upstream portion of the fan duct into an upper fan duct having an upper fan duct inlet and a lower fan duct having a lower fan duct inlet, the upper fan duct inlet and lower fan duct inlet collectively forming the fan duct inlet, the gas turbine engine defining a booster bleed ratio (BBR), wherein the BBR is a ratio of an airflow through the lower fan duct inlet to the airflow through the core duct, and wherein BBR is less than or equal to an upper range of 0.005625×TPAR+0.2375, and greater than or equal to a lower range of 0.001125×TPAR+0.00977.

The aircraft of the preceding clause, wherein the P of the unducted fan propulsor is located in a second ellipse having a second major axis length (2MajAL) and a second minor axis length (2MinAL) with a second ellipse origin defined by EORL/D of 1.051 and θ of 248.8°, and where 2MajAL/D is 1.86 and 2MinAL/D is 1.56.

The aircraft of any of the two the preceding clauses, wherein the P of the unducted fan propulsor is located in a third ellipse having a third major axis length (3MajAL) and a third minor axis length (3MinAL) with a third ellipse origin defined by EORL/D of 0.870 and θ of 239.6°, where 3MajAL/D is 1.4 and 3MinAL/D is 0.9.

The aircraft of any of the three the preceding clauses, wherein the P of the unducted fan propulsor is located in a fourth ellipse having a fourth major axis length (4MajAL) and a fourth minor axis length (4MinAL) with a fourth ellipse origin defined by EORL/D of 0.763 and θ of 235.7°, and where 4MajAL/D is 0.94 and 4MinAL/D is 0.44.

An aircraft, comprising: a fuselage; an airfoil extending from the fuselage, the airfoil having an airfoil section defining an effective quarter-chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section, when viewed looking from an outboard position towards an inboard position (e.g. the fuselage) OR when viewed with the LE to the left of the TE; wherein 0.065<RL/D<1.98 and θ is between 187° and 340°; and wherein RL/D and θ of the P of the unducted fan propulsor adhere to the following expressions:

$$\frac{R L}{D} + \frac{( \sqrt{1.4161 * [ 1.88978 * {sin}^{2} ( θ ) - 0.0875 * {cos}^{2} ( θ ) + 0.477 * sin ( θ ) * cos ( θ ) ]} + 1.764 * sin ( θ ) + 0.19146 * cos ( θ ) )}{1.96 * {sin}^{2} ( θ ) + 0.7225 * {cos}^{2} ( θ )} > 0$$

$$and$$

$$\frac{R L}{D} + \frac{( \sqrt{1.4161 * [ 1.88978 * {sin}^{2} ( θ ) - 0.0875 * {cos}^{2} ( θ ) + 0.477 * sin ( θ ) * cos ( θ ) ]} + 1.764 * sin ( θ ) + 0.19146 * cos ( θ ) )}{1.96 * {sin}^{2} ( θ ) + 0.7225 * {cos}^{2} ( θ )} < 0 ;$$

and wherein the unducted fan propulsor includes: a turbomachine comprising a compressor section, a combustion section, and a turbine section arranged in serial flow order, the turbomachine defining an engine inlet to an inlet duct, a fan duct inlet to a fan duct, and a core inlet to a core duct; a primary fan driven by the turbomachine, wherein the primary fan includes the rotating blades; a secondary fan located downstream of the primary fan within the inlet duct, the gas turbine engine defining a thrust to power airflow ratio (TPAR) between 3.5 and 100 and a core bypass ratio (CBR) between 0.1 and 10, wherein the TPAR is a ratio of an airflow through a bypass passage over the turbomachine plus an airflow through the fan duct to an airflow through the core duct, and wherein the CBR is a ratio of the airflow through the fan duct to the airflow through the core duct; and a booster located downstream of the secondary fan and comprising a booster rotor blade and a booster cowl, the booster cowl separating an upstream portion of the fan duct into an upper fan duct having an upper fan duct inlet and a lower fan duct having a lower fan duct inlet, the upper fan duct inlet and lower fan duct inlet collectively forming the fan duct inlet, the gas turbine engine defining a booster bleed ratio (BBR), wherein the BBR is a ratio of an airflow through the lower fan duct inlet to the airflow through the core duct, and wherein BBR is less than or equal to an upper range of 0.005625×TPAR+0.2375, and greater than or equal to a lower range of 0.001125×TPAR+0.00977.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. An aircraft comprising:
a fuselage;
a pair of wings extending from the fuselage,
two or more unducted fan propulsors, each of the unducted fan propulsors is mounted relative to one of the wings on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D);
a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other;
an airfoil section having an effective quarter chord point QC;
a positioning line (R) having a length (RL) and extending from the QC to the point P of the unducted fan propulsor at an angle θ measured positive in a counter-clockwise direction when the high pressure side of the airfoil section is below the airfoil section when viewed looking from an outboard position towards an inboard position of the wing; wherein 0.07≤RL/D≤2.0 and θ is between 187° and 342°; and
wherein at least one of the unducted fan propulsors includes:
a turbomachine comprising a compressor section, a combustion section, and a turbine section arranged in serial flow order, the turbomachine defining an engine inlet to an inlet duct, a fan duct inlet to a fan duct, and a core inlet to a core duct;
a primary fan driven by the turbomachine, wherein the primary fan includes the rotating blades;
a secondary fan located downstream of the primary fan within the inlet duct, the gas turbine engine defining a thrust to power airflow ratio (TPAR) between 3.5 and 100 and a core bypass ratio (CBR) between 0.1 and 10, wherein the TPAR is a ratio of an airflow through a bypass passage over the turbomachine plus an airflow through the fan duct to an airflow through the core duct, and wherein the CBR is a ratio of the airflow through the fan duct to the airflow through the core duct; and
a booster located downstream of the secondary fan and comprising a booster rotor blade and a booster cowl, the booster cowl separating an upstream portion of the fan duct into an upper fan duct having an upper fan duct inlet and a lower fan duct having a lower fan duct inlet, the upper fan duct inlet and lower fan duct inlet collectively forming the fan duct inlet, the gas turbine engine defining a booster bleed ratio (BBR), wherein the BBR is a ratio of an airflow through the lower fan duct inlet to the airflow through the core duct, and
wherein BBR is less than or equal to an upper range of 0.005625×TPAR+0.2375, and greater than or equal to a lower range of 0.001125×TPAR+0.00977.

2. The aircraft of claim 1, wherein 0.15≤RL/D.

3. The aircraft of claim 1, wherein 0.35≤RL/D, and preferably RL/D is about 0.72.

4. The aircraft of claim 1, wherein θ is between 198° and 310°, and preferably between 205° and 285°.

5. The aircraft of claim 1, wherein the two or more unducted fan propulsors are configured to operate at a cruise flight Mach M₀ of between 0.7 and 0.9, and more preferably between 0.75 and 0.9; or the two or more unducted fan propulsors are configured to propel the aircraft at a cruise flight Mach M₀ of between 0.7 and 0.9, and more preferably between 0.75 and 0.85.

6. The aircraft of claim 1, wherein the unducted fan propulsor has a dimensionless cruise fan net thrust parameter expressed as follows:
$$0.15 > \frac{{F}_{n e t}}{{ρ}_{0} {A}_{a n} {V}_{0}^{2}} > 0.06 ,$$
wherein Fₙₑₜ is cruise fan net thrust, ρ₀ is ambient air density, Vₒ is cruise flight velocity, and Aₐₙ is annular cross-sectional area perpendicular to an axis of rotation of a rotor axis of rotation.

7. The aircraft of claim 1, wherein the unducted fan propulsor is undermounted to the airfoil with one or more intermediate structures.

8. The aircraft of claim 1, wherein the P of the unducted fan propulsor is variable to accommodate different operating conditions.

9. An aircraft, comprising:
a fuselage;
an airfoil extending from the fuselage, the airfoil having an airfoil section defining an effective quarter chord point (QC);
an unducted fan propulsor mounted relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D);
a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other;
an ellipse origin positioning line (EOR) having a length (EORL) extending from the QC to an ellipse origin (OR) at an angle θ measured positive in a counter-clockwise direction when the high pressure side of the airfoil section is below the airfoil section, and measured positive in a clockwise direction when the high pressure side of the airfoil section is above the airfoil section, when viewed looking for an outboard position towards an inboard position; wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7°; and
wherein the unducted fan propulsor includes:
a turbomachine comprising a compressor section, a combustion section, and a turbine section arranged in serial flow order, the turbomachine defining an engine inlet to an inlet duct, a fan duct inlet to a fan duct, and a core inlet to a core duct;
a primary fan driven by the turbomachine, wherein the primary fan includes the rotating blades;
a secondary fan located downstream of the primary fan within the inlet duct, the gas turbine engine defining a thrust to power airflow ratio (TPAR) between 3.5 and 100 and a core bypass ratio (CBR) between 0.1 and 10, wherein the TPAR is a ratio of an airflow through a bypass passage over the turbomachine plus an airflow through the fan duct to an airflow through the core duct, and wherein the CBR is a ratio of the airflow through the fan duct to the airflow through the core duct; and
a booster located downstream of the secondary fan and comprising a booster rotor blade and a booster cowl, the booster cowl separating an upstream portion of the fan duct into an upper fan duct having an upper fan duct inlet and a lower fan duct having a lower fan duct inlet, the upper fan duct inlet and lower fan duct inlet collectively forming the fan duct inlet, the gas turbine engine defining a booster bleed ratio (BBR), wherein the BBR is a ratio of an airflow through the lower fan duct inlet to the airflow through the core duct, and
wherein BBR is less than or equal to an upper range of 0.005625×TPAR+0.2375, and greater than or equal to a lower range of 0.001125×TPAR+0.00977.

10. The aircraft of claim 9, wherein the P of the unducted fan propulsor is located in a second ellipse having a second major axis length (2MajAL) and a second minor axis length (2MinAL) with a second ellipse origin defined by EORL/D of 1.051 and θ of 248.8°, and where 2MajAL/D is 1.86 and 2MinAL/D is 1.56.

11. The aircraft of claim 9, wherein the P of the unducted fan propulsor is located in a third ellipse having a third major axis length (3MajAL) and a third minor axis length (3MinAL) with a third ellipse origin defined by EORL/D of 0.870 and θ of 239.6°, where 3MajAL/D is 1.4 and 3MinAL/D is 0.9.

12. The aircraft of claim 9, wherein the P of the unducted fan propulsor is located in a fourth ellipse having a fourth major axis length (4MajAL) and a fourth minor axis length (4MinAL) with a fourth ellipse origin defined by EORL/D of 0.763 and θ of 235.7°, and where 4MajAL/D is 0.94 and 4MinAL/D is 0.44.

13. An aircraft, comprising:
a fuselage;
an airfoil extending from the fuselage, the airfoil having an airfoil section defining an effective quarter-chord point (QC);
an unducted fan propulsor mounted relative to the airfoil section on a high pressure side thereof, the unducted fan propulsor having a centerline (CL), a plurality of blades arranged in a forward array and a plurality of blades arranged in a rearward array, wherein one of the forward and rearward array of blades are rotating blades and the rotating blades define a maximum outer diameter (D);
a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other;
a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section, when viewed looking from an outboard position towards an inboard position (e.g. the fuselage) OR when viewed with the LE to the left of the TE; wherein 0.065<RL/D<1.98 and θ is between 187° and 340°; and wherein RL/D and θ of the P of the unducted fan propulsor adhere to the following expressions:
$$\frac{R L}{D} + \frac{( \sqrt{1.4161 * [ 1.88978 * {sin}^{2} ( θ ) - 0.0875 * {cos}^{2} ( θ ) + 0.477 * sin ( θ ) * cos ( θ ) ]} + 1.764 * sin ( θ ) + 0.19146 * cos ( θ ) )}{1.96 * {sin}^{2} ( θ ) + 0.7225 * {cos}^{2} ( θ )} > 0$$
$$and$$
$$\frac{R L}{D} + \frac{( - \sqrt{1.4161 * [ 1.88978 * {sin}^{2} ( θ ) - 0.0875 * {cos}^{2} ( θ ) + 0.477 * sin ( θ ) * cos ( θ ) ]} + 1.764 * sin ( θ ) + 0.19146 * cos ( θ ) )}{1.96 * {sin}^{2} ( θ ) + 0.7225 * {cos}^{2} ( θ )} < 0 ;$$
and
wherein the unducted fan propulsor includes:
a turbomachine comprising a compressor section, a combustion section, and a turbine section arranged in serial flow order, the turbomachine defining an engine inlet to an inlet duct, a fan duct inlet to a fan duct, and a core inlet to a core duct;
a primary fan driven by the turbomachine, wherein the primary fan includes the rotating blades;
a secondary fan located downstream of the primary fan within the inlet duct, the gas turbine engine defining a thrust to power airflow ratio (TPAR) between 3.5 and 100 and a core bypass ratio (CBR) between 0.1 and 10, wherein the TPAR is a ratio of an airflow through a bypass passage over the turbomachine plus an airflow through the fan duct to an airflow through the core duct, and wherein the CBR is a ratio of the airflow through the fan duct to the airflow through the core duct; and
a booster located downstream of the secondary fan and comprising a booster rotor blade and a booster cowl, the booster cowl separating an upstream portion of the fan duct into an upper fan duct having an upper fan duct inlet and a lower fan duct having a lower fan duct inlet, the upper fan duct inlet and lower fan duct inlet collectively forming the fan duct inlet, the gas turbine engine defining a booster bleed ratio (BBR), wherein the BBR is a ratio of an airflow through the lower fan duct inlet to the airflow through the core duct, and
wherein BBR is less than or equal to an upper range of 0.005625×TPAR+0.2375, and greater than or equal to a lower range of 0.001125×TPAR+0.00977.
